(19) United States
(12) Patent Application Publication
(10) Pub. No.: US 2014/0310243 A1
(43) Pub. Date: Oct. 16, 2014

(54) Heart beacon cycle

(71) Applicants: Steven James McGee, Oceanport, NJ (US); Tammy Lee McGee, Oceanport, NJ (US)

(72) Inventors: Steven James McGee, Oceanport, NJ (US); Tammy Lee McGee, Oceanport, NJ (US)

(73) Assignee: Mr. Steven James McGee, Oceanport, NJ (US)

(21) Appl. No.: 13/573,002

(22) Filed: Aug. 13, 2012

Related U.S. Application Data
(63) Continuation-in-part of application No. 12/856,715, filed on Aug. 16, 2010, now abandoned.

(51) Int. Cl. G06F 17/30

(52) U.S. Cl. CPC G06F 17/30575
USPC 707/639

(57) ABSTRACT

Systemic, adaptive procedural template comprised of common building blocks forming template frameworks i.e., self-organizing, mutually reinforcing service, system, process, procedure components derived situational understanding, state meta data signaling replication systems consisting of TCP/IP heartbeat, heartbeat messages signaling during micro-macro report cycles of state meta-data sync deltas <class> typed with <ORG_ID>, <URN> time stamped prior to data fusion-center insertion followed by reports aggregated, recalculated, relayed through synchronization, conversion gateways then merged into macro-cycle reports where metrics, metering are described by using Paul Revere meme linear, sequential hop count, water-drop in-pond meme geo-spatial temporal intensity measures, metrics recording sync deltas change across time/space viewed on appliqué displays using Russian Matryoshka doll techniques where each view adds to, changes the nature, meaning of composite views while retaining original appliqué views unique qualities as decision support aids in best effort, best practice by federated groups

### CROSS REFERENCE TO RELATED APPLICATIONS

Related applications by Applicant Steven J. McGee Customer number 37952: Ser. No. 13,573,002 The Heart Beacon Cycle filed Aug. 13, 2012 as a continuation to Ser. No. 12/856,715 Method/process/procedure to enable: The Heart Beacon Rainbow Force Tracking filed Sep. 7, 2012 as a continuation to Ser. No. 11,601,035 Method to enable the heartbeat beacon for homeland security and homeland defense interoperability filed Nov. 17, 2006 as a continuation to: Ser. No. 10/709,358 Method to enable Heartbeat e9-1-1 filed Apr. 29, 2004 as a continuation to: Ser. No. 10,708,000 Method to enable a Homeland Security Heartbeat filed Jan. 30, 2004 as a continuation to: Ser. No. 10/605/144 Method to commercialize structured military messaging filed Sep. 11, 2003

A systemic adaptive, iterative, procedural template framework used to form federated groups synchronized in time-space for common goals using equitable, consistent metrics and meters news-casted to geo-spatial temporal intensity appliqué overlays i.e., Dymaxion map world view

### REFERENCES

U.S. Pat. No. 8,442,891 B2 Intermarket analysis May 14, 2013 Inventors Louis B. Mendelsohn Assignee Predictive Technologies Group, LLC
U.S. Pat. No. 7,571,430 Trimbell, et al. Aug. 4, 2009 Adaptive dispatch table based on templates Original Assignee: LSI Logic Corporation Inventors: Forrest Trimbell,
US 20080208595 System and method for capturing steps of a procedure Inventors: Lloyd Elder Edmonton, Calif. Publication date: 2008 Aug. 28
U.S. Pat. No. 0,154,789 Method For Executing a single tranche synthetic ABS Derivative Transaction Lai; Jonathan; et al. Jun. 26, 2008
U.S. Pat. No. 7,310,751 Timeout event trigger generation Tayler et al., Hewlett Packard Dec. 18, 2007
U.S. Pat. No. 7,987,484, Jul. 26, 2011, Sloo Assignee: Microsoft Corporation: Managing media content with a self-organizing map
U.S. Pat. No. 0,222,777, May 29, 2002, Sweatt, Larry G: Emergency Warning Network
U.S. Pat. No. 7,272,148 Non-ALG approach for application layer session traversal of IPv6/IPv4 NAT-PT gateway Assignee: Hewlett-Packard Development Company, L.P. (Houston, Tex.)
U.S. Pat. No. 6,065,039: May 16, 2000: Noemi Paciorek: Dynamic Synchronous Collaboration Framework For Mobile Agents
U.S. Pat. No. 6,636,781 Shen et al. Oct. 21, 2003: Distributed control and coordination of autonomous agents in a dynamic, reconfigurable system
U.S. Pat. No. 6,226,655, Borman, et al. May 1, 2001: Method and apparatus for retrieving data from a network using linked location identifiers
U.S. Pat. No. 6,115,718, Huberman, et al. Sep. 5, 2000: Method and apparatus for predicting document access in collection of linked documents, probabilities, spreading activation
U.S. Pat. No. 7,461,130: Abdel Aziz, et al. Dec. 2, 2008: Method and apparatus for self-organizing node groups on a network
U.S. Pat. No. 6,553,423: Chen, Apr. 22, 2003: Method and apparatus for dynamic exchange of capabilities between adjacent/neighboring networks nodes Assignee Cisco Systems
U.S. Pat. No. 6,456,234, Sep. 24, 2002, Johnson, William J: System and method for proactive content delivery by situation and location
U.S. Pat. No. 6,470,384, Oct. 22, 2002, O'Brien et al Networks Associates, Inc.: Modular Framework for Configuring Action Sets for Use in Dynamically Processing Network Events
U.S. Pat. No. 0,217,138, Sep. 15, 2011 Larsen et al: Systems and methods for automatically determining 3-dimensional object information and for controlling a process based on automatically-determined 3-dimensional object information
U.S. Pat. No. 7,138,913, Apr. 28, 2004, Mackenzie: Selective reporting of events in asset tracking system
U.S. Pat. No. 7,525,425, Apr. 28, 2009, Per Diem Inc: System and method for defining an event based on relationship between object location and a user defined zone
U.S. Pat. No. 6,735,630 May 11, 2004, Gelvin et al: Method for collecting data using compact internetworked wireless integrated network sensors (WINS)
US-2006/0217076 Sep. 28, 2006, U.S. Pat. No. 0,217,138, Bishop, Donald M: Synchronized Beacon for Network having multiple radios
U.S. Pat. No. 7,266,395 Schnurr Sep. 4, 2007, System and method of wireless proximity awareness
U.S. Pat. No. 6,735,630, May 2004, Gelvin et al; System and methods of radio interference based localization in sensor networks
U.S. Pat. No. 7,353,259, Apr. 1, 2008, Gelvin and Bakke, Cisco Systems: Method and apparatus for exchanging configuration information between nodes operating in a master-slave configuration
U.S. Pat. No. 0,086,680, Apr. 1, 2009, Tantivy Inc: Multi-Detection of Heartbeat to reduce error
US Patent 2012/0045049 A1, Self-Organizing Directory Display, John H. Yoakum, Avaya
U.S. Pat. No. 7,797,391 Load balancing and admission scheduling in pull-based parallel video servers. Inventor: Yiu Bun Lee Original Assignee: The Chinese University of Hong Kong
U.S. Pat. No. 6,747,976 Distributed scheduling architecture with efficient reservation protocol. Brahim Bensaou Centre for Wireless Communications of The National University of Science

### OTHER PUBLICATIONS

ISO/ITU X.500: International Organization for Standards/Telecomm Directory Services
TCP/IP: Defense Advanced Research Project Administration DAPPA/Stanford University
Unified Modeling Language UML: Object Management Group/ISO/IEC 19501
Securities and Exchange Commission Release No. 34-58140; File SR-BSE-2008-40 7/10 2008
FiSMA FSM: ISO/IEC 29881:2008 20926:2009 COSMIC-FFP: 19761 Software and systems engineering Software measurement—IFPUG functional size measurement method
Mk II Function Point Analysis: ISO/IEC 20968:2002 Software engineering—Ml II Function Point Analysis—Counting Practices Manual
NESMA FPA Method: ISO/IEC 24570:2005 Software engineering—NESMA function size measurement method version 2.1—Definitions and counting guidelines for the application of Function Point Analysis
A Self-Organizing Map Approach for Clustering of XML Documents, F. Trentini and M. Hagenbuchner, and F. Scarselli, an A. C. Tsoi, Jul. 26, 2006 Joint Conference on Neural Networks
Cloud Federation by Tobias Kurze, Markus Klems, David Bermbach, Alexander Lenk, Stefan Tai† and Marcel Kunze, Steinbuch Centre for Computing (SCC) Karlsruhe Institute of Technology KIT, Germany Institute of Applied Informatics and Formal Description Methods
State Identity Credential and Access Management (SICAM) —Guidance and Roadmap September 2012 Version 1.0 National Association of State Chief Information Officers
Newscast Computing Internal report IR-CS-006 Vrije Universiteit Amsterdam Department of Computer Science November 2003 M'ark Jelasity, Wojtek Kowalczyk and Maarten van Steen
Project BISON: Bi-sociation Networks for Creative Information Discovery sponsored by Future and Emerging Technologies unit of the European Commission (IST-2001-38923)
Procedural Template: Stanford Linear Accelerator Laboratory SLAC Stanford University:
Middleware And Grid Interagency Coordination (MAGIC) dynamic response idea rapid-response federation among agencies NITRD Large Scale Networks MAGIC group Networking and Information Technology Research and Development (NITRD) National Science Foundation
Paper: Firefly-inspired Heartbeat Synchronization in Overlay Networks. Ozalp Babaoglu. Univ. Bologna, Italy First International Conference on Self-Adaptive and Self-Organizing Systems (SASO 2007) 0-7695-2906-2/07 IEEE © 2007
IETF Network Working Internet Draft Group State Refresh in Protocol Independent Multicast PIM-DM Data mining for telecommunications network log analysis by CISCO Systems University of Oregon Dino Farinacci I. Kouvelas K. Windisch Feb. 23, 1999
Presentation: Architectural Patterns for Self-Organizing Systems-of-Systems, Craig Nichols, L-3 Communications, Rick Dove, Stevens Institute of Technology In SSTC proceedings INCOSE

International Symposium, Denver, Colo., Jun. 20-22, 2011
Presentation: Long Term Durability with Seagull Hakim Weatherspoon, Jeremy Stribling OceanStore group) University of California, Berkeley, Lake Tahoe. Monday, Jan. 13, 2003
Open Identity Exchange (OIX) OpenID Connect Implementer's Drafts OAuth 2.0 protocol
USPTO Request for Information SS-PAPT1100005: Situational Awareness SA and Incident Response (SAIR), Chief Information Office Command Center
US Government Cloud Computing Technology Roadmap Volume I Release 1.0 (Draft) SP 500-293 High-NIST, Information Technology Laboratory
Defense Advanced Research Programs Administration DARPA Broad Agency Announcement 1155 Jun. 8, 2011:120 Mission Oriented Resilient Clouds MRC
Movie/book: Moneyball 2011 Columbia Pictures based on Michael Lewis's 2003 book
International Journal of Digital Earth, Vol. 4, No. 4, July 2011, Pgs 305-329 Spatial cloud computing: how can the geospatial sciences use and help shape cloud computing? Chaowei Yanga*, Department of Geography and Geo Information Science and Center for Intelligent Spatial Computing, George Mason University, Fairfax Va. 22030-4444, USA
Presentation: Automatic Message Classification Dr Arthur Griesser, Electronics Engineer Electronic Information Technologies Group Semiconductor Electronics Division Electronics and Electrical Engineering Lab NIST National Institute for Standards and Technology
A New Quartet Tree Heuristic for Hierarchical Clustering, EU-PASCAL Statistics and

Optimization of Clustering R. Cilibrasi, P. M. B. Vitanyi, Workshop, 5-6 Jul. 2005, London, UK
Information Distance, IEEE Trans. Inform. C. Bennett et al. M. Li et al.
The Similarity Metric, IEEE Trans. Inform. Th., 50:12 (2004), 3250-3264
Clustering by Compression, IEEE Trans. Inform R. Cilibrasi, Vitányi. 51:4 (2005), 1523-1545
Realizing and Refining Architectural Tactics: James Scott, Boeing Rick Kazman, Software Engineering Institute August 2009. CMU/SEI-2009-TR-006 ESC-TR-2009-006
Contextual Distance for Data Perception, by Deli Zhao, Zhouchen Lin, Xiaoou Tang Penn State University, CiteSeer page maintained by the National Science Foundation
Manifold regularization: A geometric framework for learning from examples (2004), by Mikhail Belkin, Partha Niyogi, Vikas Sindhwani, Peter Bartlett Journal of Machine Learning Research
Quality Threshold (QT) Heyer, L. J., et al. “Exploring Expression Data: Identification and ReST paper “Extending the REpresentational State Transfer (REST). Architectural Style for Decentralized Systems Rohit Khare and Richard N. Taylor University of California, Irvine
Securities Exchange Commission Release No. 34-58140; SR-BSE-2008-40 7/10 2008 Financial Information eXchange (“FIX”) Protocol Version 5.0
Process Mining Framework for Software Processes Vladimir Rubin, Eindhoven University of Technology, Eindhoven, The Netherlands, University of Paderborn, Paderborn, Germany.
Request for Comment RFC 2141 IETF Uniform Resource Name—naming conventions
Internet of Things Architecture IoT-A Project Deliverable D1.1-SOTA report on existing integration frameworks/architectures for WSN, RFD) and other emerging IoT related Technologies IoT-A Grant agreement number 257521 European Union funded
Towards modeling real-world aware business processes S. Meyer, K. Sperner, C. Magerkurth, and J. Pasquier, “Towards modeling real-world aware business processes” in Proceedings of Web of Things 2011, San Francisco, Calif., USA, 2011.
Towards Real-World Aware Enterprise Systems S. Meyer, K. Sperner, C. Magerkurth “Towards Real-World Aware Enterprise Systems”, IEEE MASS 2011, Valencia, Spain
Introducing Entity-based Concepts to Business Process Modeling K. Sperner, S. Meyer, C. Magerkurth “Introducing Entity-based Concepts to Business Process Modeling”, 3rd International Workshop and Practitioner Day on BPMN, Lucerne, Switzerland
Towards Context-Aware Retail Environments: An Infrastructure Perspective C. Magerkurth, K. Sperner, S. Meyer, M. Strohbach “Towards Context-Aware Retail Environments: An Infrastructure Perspective”, Mobile Interaction in Retail Environments (MIRE 2011
Combining Genetic Algorithms & Simulation to Search for Failure Scenarios in System Models NIST Research Team: Kevin Mills, Chris Dabrowski, Jim Filliben and Sandy Ressler
Basic Econometrics, Damodar N Gujarati, McGraw-Hill, New York, 1995, ISBN 0-07-025214-9
Efficient search for approximate nearest neighbor in high dimensional spaces—Kushilevitz, Ostrovsky, et al. —1998
TRANSCO PRODUCTS INC. V. PERFORMANCE CONTRACTING, INC. Court of Appeals for the Federal Circuit 38 F.3d 551 (1994)
Statement of federally sponsored research/development: this invention is not federally sponsored
Sequence Listing: paper application

TECHNICAL FIELD/BACKGROUND OF INVENTION

The interne net was sponsored by the United States Military Defense Advance Research and Project Administration DARPA and expanded from the military and a few key universities to the world. Network Centric Warfare/Network Centric Operations/Mission Aware Networking is follow on work which in the inventor's opinion, will also migrate to commercial domains. The military's procedure of sampling state meta data in micro-cycles to update operational macro-cycles to synchronize group operations, when enhanced by novel, unique methods of metering/measuring time/space is an extremely versatile method applicable to many use cases. The main embodiment of this application is written in a non-networked environment to focus on the process behind how groups may form organizations/federations in an adhoc, agile method where state changes gathered in short duration micro-cycles are aggregated into longer duration operation macro-cycles news-casting/broadcasting/beaconing state changes over a wide geo-spatial area to organize, synchronize group activities across a wide area among many federated groups reacting to events/alerts/opportunities and synchronize activities for common goals. Adding or removing selected technologies adds or removes functionalities to and from the main embodiment/environment where selected technologies enable additional embodiments that form the basis of claims involving variations of the main theme based on an iterative process template. Ser. No. 10/605/144 Method to commercialize structured military messaging filed Sep. 11, 2003 addressed the core assertion and idea that heartbeat messages as found in First Response, commercial and military domains as formed by heartbeat cycle data collections and data puts is essential to cross domain collective, collaborative activities in terms of synchronization and interoperability. A K00.99 structured military heartbeat message is introduced by this initial application which forms a core building block of Ser. No. 10/708,000 Method to enable a Homeland Security heartbeat filed Jan. 30, 2004 used a federal government embodiment to further develop the idea in context with a cited template's system ported to Department of Homeland Security system describing the idea. Ser. No. 10/709,358 Method to enable Heartbeat e9-1-1 filed Apr. 29, 2004 used an emergency response environment as a main embodiment as an attempt by the applicant to frame the idea. Ser. No. 11/601,035 Method to enable the heartbeat beacon for homeland security and homeland defense interoperability filed Nov. 17, 2006 focused on interoperability between the Department of Homeland Security, with its Department of Defense counterpart organizations. This amendment as a continuation application main embodiment is technology neutral based on a little league baseball tournament to describe conventions of military “mission-aware” networking with minimum use of military jargon. The main embodiment is non-networked addressing the majority of objections of prior applications. This idea has many applications as various embodiments as theme variations as application continuations. Embodiments as variations as continuations do not constitute “new” material—only theme variations described by reapplying a procedural template in specific use cases. The applicant asserts a definition of patent continuation applications as a venue to enumerate and elaborate on various applications of the base application theme such as the versatility of time stamping state meta data prior to data fusion center insertion using a heartbeat time stamp followed by heartbeat message/sync delta message/replication/beacon broadcast updates of changes in state of entities, resources, platforms and individuals typed as a group over a wide area network as a method and means to effect dynamic, mission aware change management. For example, the applicant's prior application titled “method to enable Heartbeat e9-1-1 focused on first response, medical triage in response to disasters. This application cites a similar method as applied to joining federated adhoc, agile groups in dynamic trade arbitrage enabled by search. Both Heartbeat e9-1-1 (previous application) and (a method to form) a Heart Beacon Cycle use similar methods albeit with different embodiments as best effort/best practice citing Church-Turin thesis cited in this application's related art section to assert that effectiveness is not necessarily proved. A continuation is a second application for the same invention claimed in a prior application as defined by 37 CFR 1.51(b). Continuations filed describe theme variations as embodiments.

The military rarely operates using individuals not belonging to or affiliated into a group. Therefore, this method describes establishing pre-conditions and pre-requisites supporting the adhoc repurposing of synchronized, orchestrated group activities towards shared goals synchronized in time and space—recalling John Wayne's famous “space for time” quote in his role in the 1965 movie “Battle of the Bulge”, military division commanders while undergoing evaluation at the National Training Center in the Mojave Desert would conceive their plans only to have their communications officer or S-6 (system administrator) tell them that their plans were not supportable in terms of network execution management/configuration management since the scheme of maneuver involved adjacent unit routers that they did not control. Commanders—unable to execute their envisioned schemes of maneuver, responded to their Signal Officer's S-6's (system administrators) to the effect “give us back our pork chops (radio handsets) and our Jon Madden/chalk/paper charts (instead of digital screens). Necessity being the mother of invention, the Communications Electronics Command CECOM “Greatest Invention” funded by the Defense Advance Research Project Administration DARPA was realized as Network Enabled Operations/Network Centric Warfare. Networks were now able to be “maneuvered” with units “spontaneously organizing”—adding, joining, moving, dropping from router subnets, to mimic operational schemes in networking terms. Units are mixed and matched based on the situation and spontaneously integrated to support the mission and commander's intentions e.g., adding additional field artillery units as one example. Depicting organizations as appliqué geo-spatial temporal intelligence overlays fosters situational understanding as snapshots in time of an organizations activities, locations and events typed as classes by XML markup in documents called Unit Task Orders or UTO (s) in previous continuations and Team Task Order in this one. The Army, needing to convert leader intent, decisions and schemes of maneuver into network configuration management supportable plans in terms of router database changes, focused on the optional intervals in time left unassigned to gather state meta data by Vinton Cerf's DARPA TCP/IP team. The heartbeat sub-protocol as a mini subnet publish-subscribe function was used to gather data from target devices participating in group operations. Then, the international American Registry Internet Numbers ARIN Organization Identification ORG ID was used to support military operations given the military usually moves as groups/units rather than as individuals. The Army then adopted the Uniform Reference Name (URN) to uniquely identify platforms, individual (sensor) devices grouped to serve a purpose (e.g., mine field, intelligence sensor boundaries). Organizations may sign up for more than 1 <Org_ID> for business continuity/plan B, plan C to adjust for changes in leader's intent or tactical, strategic situation An Organization Identifier (Org ID) represents a business, nonprofit corporation, or government entity in the ARIN database. An Organization Identifier (Org ID) represents a business, nonprofit corporation, or government entity in the ARM database. The Org ID is defined by a legal name, postal address, and points of contact. IP addresses and AS numbers directly assigned or allocated by ARIN must be associated with an Org ID. Internet Service Providers and other direct allocation holders may also reassign or reallocate IP addresses to an Org ID. Instructions explain how to create, recover, modify, execute a name change and delete Org IDs.

A Heart Beacon Cycle is formed using procedural templates as guides akin to a book's table of contents where entries in a table of contents link or point to more detailed treatises on A Heart Beacon Cycle's supporting technologies and building block components are enumerated by a procedural template and include example technology TCP/IP, X.400, X.500, and Unified Modeling Language UML. The term referential means containing a reference; pointing to something out of itself; as, notes for referential use. A Heart Beacon Cycle, likewise, is referential in nature relying on a priori knowledge of the internet. Since the initial patent application was filed, the term and concept of self organizing maps, directory services, reporting, networks, and systems have appeared. Federal vernacular in 2011, and now includes mission-aware networking and Mission Oriented Resilient Clouds MRC, a DARPA RFI released in 2011.

The Heart Beacon Cycles invention is based on well known, operational and therefore effective situational awareness system described in prior art and in prior continuation-in-part applications. A Heart Beacon Cycle is not a system by itself, it is rather, a systemic idea that uses an effective working system as a model/template/framework to derive a minimum set of common components on which to base a procedural template framework useful across many systems participating in a systems of systems, network of networks wide area shared group environment. Procedural templates are comprised of policies, procedures with supporting processes as preconditions/prerequisites in forming nested, self organizing, mutually reinforcing systems of systems frameworks as a template/guide in forming agile, adhoc. federated groups collaborating in cooperative activities and events synchronized, time—space then filtered and displayed in shared, cross system appliqué geo-spatial views known as the common operational picture.

A Heart Beacon Cycles involves forming high level guidelines for individuals to join agile, adhoc groups and groups to federate in achieving common goals. Procedural templates are the main artifact used as a guide and reference to more detailed treatises comprised of self organizing structures maps, directories, reports, system of systems and networks. Data aggregated and sorted into reports is synchronized by applying temporal micro/macro cycles which mutually support other components (maps, networks, directories) form into self organizing systems of systems frameworks. Geo-spatial intensity location boundaries are described by time and space conventions i.e., a concentric, spherical water drop in pond meme and a linear, sequential Paul Revere meme used to describe metrics and metering. Achieving a common purpose in time involves group collaboration achieved when organizations and their leaders are aware of each other's state and status in light of the organization's status described by Size, Activity, Location, Unit, Time, Equipment—Resource: SALUTE-R. Updating <classes> requires a method to gather, measure and meter then update the status/state of these categories in terms of thresholds—fully mission capable, non-mission capable, impaired so leaders can make decisions based on the availability of participating organizations in context with being a required size/threshold of readiness, activity=accept or not accept mission based on mission readiness or full mission capability or the lack thereof. If an organization is not in an approximate location to take action then the unit should not be included in the mission whether it is available in the pick list or not. Location from a target location objective involves time in context with ability to act within a given interval, The type of unit such as a foam fire unit instead of a water fire fighting unit will determine whether the unit is vectored towards the event or away from it as would medical teams in context with triage. Uniform Resource Name or URN is a convention to uniquely and unambiguously describe types of equipment such as RFID equipped sensors. Hop count techniques are useful in determining how soon a unit will be near an event to take action in context with what the military calls a “unit of action”. Gathering and updating state meta data describing how many of a given type of unit or sensor is in a given radius/area determines if a sufficient amount of the resource needed is available to conduct a mission or meet a group goal i.e., type of fuel in the necessary quantity. The military's sync delta message heartbeat message as a state meta-data snapshot is a key artifact in processing this condition of forming a Heart Beacon Cycle as a method and means

The internees heartbeat is based on the TCP/IP protocol developed by the Defense Advanced Project Administration DARPA that is a meme for an opportunity in time to perform or not perform computational tasks. The term beacon is often interchanged with the term heartbeat and sometimes, the terms are combined. In context with this invention, a heartbeat is the TCP/IP sub-protocol process where time slots are assigned to perform computational tasks e.g., time stamp and type data collected from platforms and devices with an Organizational Identifier or ORG ID and/or a Uniform Resource Name URN prior to data fusion center insertion. The military moves (jumps) from point a to point b to point n. The applicant's intent is to re-use taxpayer funded research in DARPA net operational techniques into commercial equivalent embodiments such as disaster relief and equitable arbitrage where military best practice of military procedures are compared with commercial counterpart self organizing structures forming a system of systems supported by a network of networks where group events and activities are synchronized in time/space for common goals

Mission aware networking/Mission Oriented Resilient Clouds (DARPA): enable networks to be aware of, and rapidly adapt to mission needs using methods to monitor and measure the networks activities and thresholds. A Heart Beacon Cycle extends and improves what was originally DARPA initiatives for example, Blue Force Tracker by adding novel, original temporal, linear-sequential Paul Revere hop count and area, water drop in pond intensity, duration, threshold beacon memes where resources are allocated in a priority driven manner providing higher priority tasks in the mission with qualities of service resource levels and thresholds are metered to determine using metrics gathered to calculate mission readiness for group activities by type and by precedence. This will improve leaders ability to make informed decisions consulting overlay common picture appliqué decision support views

U.S. Pat. No. 7,571,430 Trimbell, et al Adaptive dispatch table based on templates: Claim 1. A method for creating an adaptive procedure table based on templates, comprising: retrieving a list of procedure templates; building the adaptive procedure table based on the list of procedure templates, the adaptive procedure table including a procedure; providing a reference in the adaptive procedure table to a default behavior for the procedure, said default behavior being defined in the list of procedure templates; checking whether the procedure in the adaptive procedure table has a specific definition made by a feature, wherein the feature is built into a compiled program; and when the feature makes a specific definition for the procedure, updating the reference by associating the feature with the procedure via the updated reference in the adaptive table, when the procedure is removed from the compiled program, re-updating the updated reference of the procedure in the adaptive procedure table by associating the removed procedure with the default behavior, wherein the adaptive procedure table is implemented by a compiler and a linker, the adaptive procedure table including a special handling flag for each of the plurality of procedures for indicating whether special handling by a server is required for a corresponding procedure included in the plurality of procedures. Relevance to a Heart Beacon Cycle is that a Heart Beacon Cycles relies on this patent as the departure point adding unique conventions to extend and improve this model while preserving this invention's use of templates to avoid needing to describe every nuance and particular of every component/standard cited. Trimbell's template patent award cites the following: “in the exemplary embodiments, the methods disclosed may be implemented as sets of instructions or software readable by a device. It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented. It is believed that the adaptive dispatch table of the present invention and many of its attendant advantages will be understood by the forgoing description. It is also our opinion that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes”. End Trimbell quote. A Heart Beacon Cycle is also based on using templates as references to more detailed treatises, The applicant, like Trimbell, will not attempt to describe every possible arrangement or sequence of the components, the order in which the components are used and cites Trimbell U.S. Pat. No. 7,571,430 approach in “encompassing and including such changes”—without compromising the scope of a procedural template seeks to describe the form, construction and a best practice arrangement of the components as to not depart from the scope and spirit of the invention.

United States District Court, N.D. Illinois, Eastern Division. TRANSCO PRODUCTS INC., a Delaware Corporation, Plaintiff. v. PERFORMANCE CONTRACTING, INC., a Kansas Corporation, and Performance Contracting Group, Inc., a Delaware Corporation, Defendants. Apr. 1, 1996. The applicant's understanding and opinion of the United States Patent And Trademark Office citation of Transco Vs Performance in context with this applicants series of continuation applications is that the applicants have been deemed by the USPTO to have described a patent worthy idea given the USPTO paid a third party independent internet archiving firm to screen scrape and obtain the pictures and contents of the applicants corporate web page SAW Concepts LLC circa 1996 cited during formal patent examination of U.S. patent application Ser. No. 12/856,715 Method/process/procedure to enable: The Heart Beacon Rainbow Force Tracking filed Sep. 7, 2012. The USPTO in it's ruling taught that given Transco Vs Performance, SAW Concepts LLC had pre-published it's idea more than one year prior to formal application to the USPTO and that the sources of the material, i.e., web pages, a letter to the Department of Energy which the USPTO has in it's possession and cited as part of it's examination of Ser. No. 12/856,715 constituted the condition of pre-publishing a patentable idea. The USPTO further taught that Transco Vs Performance entitled the idea belonging to SAW Concepts LLC be awarded to another entity of which the identity or identities are unknown to SAW Concepts LLC as this time. The points of order that SAW Concepts LLC wishes to bring forth at this time is that the USPTO ruled that SAW Concepts LLC has formed a patentable idea. Sources e.g., web pages, letters to other government agencies are sufficient to award a patent—a condition that the USPTO has yet to do to the best of our knowledge. It is possible that the individual claims of SAW Concepts LLC's idea will be awarded in part to many other entities. While it may be against USPTO procedure to discuss past cases in a current application, we the applicants would like to remind USPTO examiners that this application is a continuation of the applications wherein Transco Vs Performance was cited by the USPTO and requests that the USPTO honor the conventions and spirit of a continuation application. Further, we wish to articulate our understanding that a legal body may not take a position opposite of a previous ruling i.e., acknowledging that SAW Concepts LLC has formed a patent worthy idea after the fact of citing Transco Vs Performance and teaching that source and type of content are moot.

Therefore, it is in the opinion of the applicants that given the USPTO having cited Transco Vs Performance in context with a series of continuation applications filed by the applicants, that examination of this continuation patent application amendment result in the award of a patent to SAW Concepts LLC first named inventor Tammy Lee McGee, second named inventor Steven J. McGee based on citation of Transco Vs Performance Contracting by the USPTO.

This opinion pursuant of the award of a patent acknowledging that a patentable idea has been described re: USPTO citation of Transco Vs Performance is the most salient background, historical information that the applicants present. The applicants acknowledge that discussing past examinations in a “new” application is irregular. The applicants opinion is that USPTO body of law does not apply to the same force and effect outside a formal examination of a patent application in the form of informal letters and would again remind the USPTO that it has decided that SAW Concepts LLC has described a patent worthy idea and therefore, this application should never have been required nor any correspondence needed after Ser. No. 12/856/715 examination.

### RELATED ART

The Heart Beacon Cycle derives best practices from the US Army Communications—Electronics' Command's “Greatest Invention” Force XXI Battle Command Brigade and Below also known as Blue Force Tracker and Joint Blue Forces Situational Awareness JBFSA. We cite DARPA Mission—Aware Networking/Mission Oriented Resilient Clouds MERC.

The invention cites deriving best practice, best efforts University of Southern California's Sea Gull Protocol from it's Ocean Store descriptions of objects of search within a geo spatial-temporally defined environment representative of a systems of systems, network of networks.

Iteration. Iteration means the act of repeating a process usually with the aim of approaching a desired goal or target or result. Each repetition of the process is also called an “iteration,” and the results of one iteration are used as the starting point for the next iteration. Example: SCADE DO-178 or SCADA (see related art entries) methods, processes and techniques involving the consistent snapshots of data taken at the time of event to enable dynamic alteration of business processes to target new business opportunities enabling highly customizable services and the ability to change parts of the system/system of systems without affecting other parts of the system due to the asynchronous nature of signaling, middleware supporting systems.

Church—Turing thesis: Quote “the fundamental premise behind the thesis, the notion of what it means for a function to be effectively calculable—is “a somewhat vague intuitive one”.[4] Thus, the thesis, although it has near-universal acceptance, cannot be formally proven. We assert the effectiveness of the Heart Beacon Cycle may not be expected to be formally proven.

The Heart Beacon Cycle methodology cites The Open Group Architecture Framework upon which to select from building block choices available to use by a federated group as an architectural framework as a best effort, best practice method and means. TOGAF® is a framework for enterprise architecture which provides a comprehensive approach for designing, planning, implementing, and governing an enterprise information architecture. TOGAF is a high level and holistic approach to design, which is typically modeled at four levels: Business, Application, Data, and Technology. It tries to give a well-tested overall starting model to information architects, which can then be built upon. It relies heavily on modularization, standardization and already existing, proven technologies and products. An architecture framework is a set of tools which can be used for developing a broad range of different architectures. It should: describe a method for defining an information system in terms of a set of building blocks show how the building blocks fit together contain a set of tools. provide a common vocabulary, include a list of recommended standards, include a list of compliant products that can be used to implement the building blocks. TOGAF is an architecture framework. ANSI/IEEE Standard 1471-2000 specification of architecture (of software-intensive systems) may be stated as: “the fundamental organization of a system, embodied in its components, their relationships to each other and the environment, and the principles governing its design and evolution.” However TOGAF has its own view, which may be specified as either a “formal description of a system, or a detailed plan of the system at component level to guide its implementation”, or as “the structure of components, their interrelationships, and the principles and guidelines governing their design and evolution over time.” Best effort, best practice is key.

Appliqué: an appliqué is a smaller ornament or device applied to another surface. An appliqué is usually one piece. In the context of ceramics, for example, an appliqué is a separate piece of clay added to the primary work, generally for the purpose of decoration. The term is borrowed from French and, in this context, means “applied” or “thing that has been applied.” Appliqué in context with the invention relates to layering situational understanding overlays as computer graphics displaying a status of tracked vehicles, individuals or (grouped) sensors over a base geo-spatial map. In context with military command, control, communications, intelligence and sensor systems (C3ISR), mosaic refers to a system designed to display situational awareness data developed by another military program manager with the difference being that the Mosaic program supplied users with high bandwidth connections on the “upper tactical internet” as apposed to low bandwidth tactical radio supported users on the “lower tactical internet.

Self-organization denotes a system of synergistically cooperative elements whose patterns of global behavior are distributed (i.e., no single element coordinates the activity) and self-limiting in nature. The most robust and unambiguous examples of self-organizing systems are from the physics of non-equilibrium processes. Self-organization is also relevant in chemistry, where it has often been taken as being synonymous with self-assembly. The concept of self-organization is central to the description of biological systems, from the sub-cellular to the ecosystem level.

Meme: A meme is “an idea, behavior, or style that spreads from person to person within a culture.”[2] A meme acts as a unit for carrying cultural ideas, symbols, or practices that can be transmitted from one mind to another through writing, speech, gestures, rituals, or other imitable phenomena. Supporters of the concept regard memes as cultural analogues to genes in that they self-replicate, mutate, and respond to selective pressures. Source: Wikipedia

Templates: Template may mean: a stencil, pattern or overlay used in graphic arts (drawing, painting, etc.) and sewing to replicate letters, shapes or designs. A pre-developed page layout in electronic or paper media used to make new pages with a similar design, pattern, or style Form letter, a predefined letter which retains its primary intent when individually customized with variable data or text. As a table contents: template (file format), a standardized non-executable file type used by computer software as a pre-formatted example on which to base other files, especially documents. Template (word processing), a standard document containing layout and styles used to configure word processing software. Style sheet (web development) or master page on which one can globally edit and format graphic elements and text common to each page of a document. Web template or web template system, a master page used to produce web pages. A main document from which mail merge documents are created. Source: Wikipedia.

Procedure: a procedure is a set of actions or operations which have to be executed in the same manner in order to always obtain the same result under the same circumstances. A SOP is specifically designed to describe and guide multiple iterations of the same procedure over a broad number of locations, on multiple occasions, and over an open period of time until such SOP is updated for whatever reason, or discontinued. A procedure is a document written to support a “Policy Directive”. A Procedure is designed to describe Who, What, Where, When, and Why by means of establishing corporate accountability in support of the implementation of a “policy”. The “How” is further documented by each organizational unit in the form of “work instructions” which aims to further support a procedure by providing greater detail. In general, procedures follow a set order or routine. However, acts of God (111) often interrupt the normal (work) flow, sequence of a procedure. Source: Wikipedia

Process Mining Framework for Software Processes Paper. Abstract: Software development processes are often not explicitly modeled and sometimes even chaotic. In order to keep track of the involved documents and files, engineers use Software Configuration Management (SCM) systems. Along the way, those systems collect and store information on the software process itself. Thus, SCM information can be used for constructing explicit process models, which is called software process mining. In this paper we show that a Process Mining Framework can be used for obtaining software process models as well as for analyzing and optimizing them.

Function Point FP: A function point is a unit of measurement to express the amount of business functionality an information system provides to a user. Automated FP standard by Object Management Group OMG replicates the IFPUG process by detecting data and transaction functions, and distinguish internal and external logical files to calculate function points. he functional user requirements of the software are identified and each one is categorized into one of five types: outputs, inquiries, inputs, internal files, and external interfaces. Once the function is identified and categorized into a type, it is then assessed for complexity and assigned a number of function points. Each of these functional user requirements maps to an end-user business function, such as a data entry for an Input or a user query for an Inquiry. This distinction is important because it tends to make the functions measured in function points map easily into user-oriented requirements, but it also tends to hide internal functions (e.g. algorithms), which also require resources to implement, however, there is no ISO recognized FSM Method that includes algorithmic complexity in the sizing result. Recently there have been different approaches proposed to deal with this perceived weakness, implemented in several commercial software products. The variations of the Albrecht based IFPUG method designed to make up for this (and other weaknesses) include:
Early and easy function points—Adjusts for problem and data complexity with two questions that yield a somewhat subjective complexity measurement; simplifies measurement by eliminating the need to count data elements.
Engineering function points: —Elements (variable names) and operators (e.g., arithmetic, equality/inequality, Boolean) are counted. This variation highlights computational function.[5] The intent is similar to that of the operator/operand-based Halstead Complexity Measures.
Bang measure—Defines a function metric based on twelve primitive (simple) counts that affect or show Bang, defined as “the measure of true function to be delivered as perceived by the user.” Bang measure may be helpful in evaluating a software unit's value in terms of how much useful function it provides, although there is little evidence in the literature of such application. The use of Bang measure could apply when re-engineering (either complete or piecewise) is being considered, as discussed in Maintenance of Operational Systems Overview.
Feature points—Adds changes to improve applicability to systems with significant internal processing (e.g., operating systems, communications systems). This allows accounting for functions not readily perceivable by the user, but essential for proper operation.
Weighted Micro Function Points—One of the newer models (2009) which adjusts function points using weights derived from program flow complexity, operand and operator vocabulary, object usage, and algorithmic intricacy. The use of function points in favor of lines of code seek to address several additional issues: the risk of “inflation” of the created lines of code, and thus reducing the value of the measurement system, if developers are incentivized to be more productive. FP advocates refer to this as measuring the size of the solution instead of the size of the problem. Lines of Code (LOC) measures reward low level languages because more lines of code are needed to deliver a similar amount of functionality to a higher level language. C. Jones offers a method of correcting this in his work. Function Points can be derived from requirements and therefore are useful in methods such as estimation by proxy. Source: Wikipedia

Arbitrage: in economics and finance, arbitrage is the practice of taking advantage of a price difference between two or more markets: striking a combination of matching deals that capitalize upon the imbalance, the profit being the difference between the market prices. When used by academics, an arbitrage is a transaction that involves no negative cash flow at any probabilistic or temporal state and a positive cash flow in at least one state. For example, an arbitrage involves taking advantage of differences in price of a single asset or identical cash-flows; in common use, it is also used to refer to differences between similar assets (relative value or convergence trades), as in merger arbitrage. People who engage in arbitrage are called arbitrageurs such as a bank or brokerage firm. Arbitrage is applied to trading in financial instruments, i.e., bonds, stocks, derivatives, commodities and currencies. For example, time banking is a pattern of reciprocal service exchange that uses units of time as currency as a complementary monetary system. A time bank, also known as a service exchange, is a community that practices time banking. The unit of currency, always valued at an hour's worth of any person's labor, used by these groups has various names, but is generally known as a time dollar in the U.S. and a time credit in the U.K. Time banking credits are created at the time of transaction which would benefit from the Heart Beacon Cycle's method to stochastically harmonize transactions across time zones accounting for stochastic conditions. A Heart Beacon Cycle measures the amount of time and distance needed to move goods and or services from a to b and from time increment a to b to c and so forth where one may use a merchant banker as a broker to improve accounting for and meter services. See abacus counting frame, wampum entries below for more detailed treatise (s) Abacus, also called a counting frame, is a calculating tool used primarily in parts of Asia for performing arithmetic processes. Today, abaci are often constructed as a bamboo frame with beads sliding on wires, but originally they were beans or stones moved in grooves in sand or on tablets of wood, stone, or metal. The abacus was in use centuries before the adoption of the written modern numeral system and is still widely used by merchants. Source: Wikipedia

Wampum is used to mark exchanges for engagement, marriage, and betrothal agreements, as well as for ceremony and condolence ceremonies. Wampum as currency: when Europeans came to the Americas, they realized the importance of wampum to Native people. While the Native people did not use it as money, the New England colonies used it as a medium of exchange.

Fungibility. A good is fungible if one unit of the good is substantially equivalent to another unit of the same good of the same quality at the same time and place. Fungibility is the property of a good or a commodity whose individual units are capable of mutual substitution, such as sweet crude oil, shares in a company, bonds, precious metals, or currencies. It refers to the equivalence of each unit of a commodity with other units of the same commodity. Fungibility does not describe or relate to any exchange of one commodity for some other, different commodity.

Terra (The Trade Reference Currency, TRC) is the name of a possible “world currency”. The concept was proposed by Belgian economist and expert on monetary systems Bernard A. Lietaer in 2001, based on a similar proposal from the 1930s. The currency is meant to be based on a basket of the 9-12 most important commodities (according to their importance in world wide trade). Terra=reference unit defined as standardized basket of key internationally traded commodities & services. Example: 100 Terra=barrel of oil, +10 bushels of wheat, +20 kg of copper, + 1/10 of ounce of gold any standardizable good or service can be included. The Terra is a demurrage-charged currency. A demurrage charge acts like a parking fee, incurring a cost over time to its holder. The cost for holding onto the Terra currency is estimated at 3.5%-4% per annum and corresponds to the costs incurred for storing the physical commodities included in the Terra basket. This demurrage charge insures the currency's use mainly as a planning, contractual and trading device: it would not be hoarded but always tend to remain in circulation. It would thereby strongly activate commercial exchanges and investments wherever it circulates. In short, the Terra purposely fulfills only two of the three traditional monetary functions. It is designed to serve only as unit of account and medium of exchange, and not as a store of value. Practical Operations of the Terra:

### (1). Terra Creation Process:

(1a.) Excess Inventory Sale. The process whereby the Terra Trade Reference Currency is created begins with the sale of some excess commodity inventory to the Terra Alliance by one of its backer/members (e.g., 1 million barrels of crude oil by an oil producer).vii

(1b). Commodity Valuation in Terras. The value of this sale of oil to the Terra Alliance (i.e., how many Terras the one million barrels of oil will be worth) is calculated at market prices. This is accomplished by determining the commodity prices at the time of the sale for both the inventory in question (in this case oil) and the sum of each of the commodities in the Terra basket using a pre-agreed upon procedure. viii. The formula used to calculate the commodity valuation in Terras is: Commodity value per unit X number of units=Terras Terra Unit Value Global currency Terra equates to macro economic cycles. Micro-currencies, micro-revenue equate to micro-economics, Heart Beacon mediation occurs between macro and the micro at gateways/off site connector relating, mediating and relaying reports used to derive unused resources in macro-cycle macro-economics with unmet needs which would otherwise not exist without use of the Heart Beacon Cycle. Gateways/off site connectors are used to aggregate, mediate transactions from macro-economic cycles to micro micro-economic cycles where unmet resources are correlated with unmet needs then displayed as sync delta changes on appliqué overlays for example, a stock market exchange pool is displayed using water drop in pond meme geo-spatial temporal intensity meters/metrics filtered then displayed onto appliqué decision graphical overlays. Using Heart Beacon Cycle procedures will improve through stochastic harmonization, and reliable reporting, will systematically help stabilize effects on global business cycles and re-align financial interests with long-term sustainability between micro-economic and macro-economic systems. The Terra equates or represents macro-cycle, macro-economics. Micro-cycles equate or represent micro-currencies, micro-revenue where micro-cycles statistics are aggregated into state meta data snapshots that are relayed through mediation gateway (off site connector in the main baseball tournament embodiment) where gateways connect to data fusion economic centers that aggregate, mediate transactions from micro-to macro economic cycles displayed as sync delta changes on appliqué overlays where intervals in time as terra “parking fees” are described by heartbeat cycles. Using Heart Beacon Cycle procedures will improve through stochastic harmonization and reliable reporting will systematically stabilize effects on global business cycles, re-align financial interests with long-term sustainability between micro-economic and macro-economic systems.

Demurrage Charge. A time-related charge on money. It acts in a manner similar to a rental fee, which increases the longer it is held. For example, a 5% annual demurrage charge on $100 incurs a $5 fee, leaving a remainder of $95. The demurrage feature wields two profound effects, it promotes a currency's circulation as a trading device; and it encourages long-term thinking. See Terra Demurrage-Charged related art entry Source: Terra White Paper_{—}2.27.04.

Federated Identity Management: federation describes organization arrangements necessary for interconnection among individuals merged into groups joined to achieve common goals Federated systems interoperate across organizational boundaries. Federated identity management is an arrangement that can be made among multiple organizations that lets subscribers use the same identification data to obtain access to the secured resources of all organizations in the group. Identity federation offers economic advantages, as well as convenience, to organizations and their users. Within a federated system, identities and associated credentials are stored, owned and managed separately—usually by using directory services. Each individual member of the federation continues to manage its own identities, but focuses on sharing and accepting identities and group credentials. A cloud in which the resources are provisioned for exclusive use by a specific community of consumers from multiple organizations that have shared concerns. Federated Community Cloud have a wide variation in requirements. Use cases best ascribe requirements for Federated Community Clouds. Relevant capabilities. Along with other cloud commuting characteristics, Federated Cloud Computing may include one or more of the following capabilities: privacy, security, compliance adherence, trust infrastructure, common governance, private communications The following variations are included for reference and additional consideration: Federated Cloud: a Community Cloud where cloud resources are provisioned for exclusive use by a specific community of consumers from multiple organizations that have shared concerns. It may be owned, managed, and operated by one or more organizations, a third party, or some combination of them, and it may exist on or off premises. A Federated Cloud is a community cloud sharing common resources. In context with a Heart Beacon Cycle, service templates and service contract lists are required and consist of processes and services. Source: NIST Cloud Standards Federation Team Cloud Computing, Open Identity Exchange (OIX) OpenID Connect Implementer's Drafts OAuth 2.0 protocol

Distributed Workflow Management. The template system that this application has been citing In application continuations since 2004 (Blue Force Tracker) is based on workflow over TCP/IP multicast. Distributed Workflow Management, known as process programming involves several standards: BPEL, XPDL, Wf-XML, BDML. All were conceived prior to the inter-cloud age. Distributed Workflow Engines must: independently manage data movement and service execution, use federated security and delegation of trust, transparently manage failure, differentiate between Orchestration vs. Choreography and make distinctions between centralized vs. distributed control. Pegasus, Triana, Taverna, Kepler are well-known grid workflow engines. Workflow engines often work cooperatively with Integrated Rule-Oriented Data System TROD: a rule engine watches all data transactions, infers when micro-services must be executed to enforce data policy and uses agents as peers to enforce distributed data policy Wf-XML is a Business Process Management standard developed by the Workflow Management Coalition. Wf-XML is designed and implemented as an extension to the OASIS Asynchronous Service Access Protocol. ASAP provides a standardized way that a program can start and monitor a program that might take a long time to complete. It provides the capability to monitor a running service, and be informed of changes in its status. Wf-XML extends this by providing additional standard web service operations that allow sending and retrieving “program” or definition of a service. A process engine has this behavior of providing a service that lasts a long time, and also being programmable by being able to install process definitions. Wf-XML offers a standard way for a BPM engine to invoke a process in another BPM engine, and to wait for it to complete. Process editing tools and process execution tools may be produced by different vendors. A standard way to retrieve process definitions and send definitions will allow a user to match the best process definition tool with a best process execution engine for their needs. Wf-XML completes the job by giving a standard way to pass the process definition between the design tool and the execution engine. See Internet Engineering Task Force (IETF) effort Simple Workflow Access Protocol (SWAP). See also WIMC standard known as Wf-XML ASAP and Wf-XML 2.0 uses SOAP Simple Object Access Protocol messages to provide the same capability. End Wikipedia entry. In context with a Heart Beacon Cycle, the invention would use Wf-XML extensively in the process of gathering heartbeat time-stamped state meta-data from individual devices forming the individual entries into a group composite entry e.g. a Unit Task Order UTO to effect unit structure change. Previous method patent continuation applications have stated that the template system the Heart Beacon Cycle invention uses to form a template framework is workflow over multi-cast TCP/IP. Source: Wikipedia and prior continuations

Service Level Agreements SLA defines language and protocol for advertising service provider capabilities, creating agreements based on offers, monitoring compliance, and penalties/rewards for non-compliance. RESTful implementations exist (Representational State Transfer). Rounds of negotiation are modeled as a rooted tree. Source: NIST Cloud Computing Working Groups REST: Representational State Transfer style of software architecture for distributed systems.

ReST paper “Extending the REpresentational State Transfer (REST). Architectural Style for Decentralized Systems Rohit Khare and Richard N. Taylor University of California, Irvine. For example, Page 3 paragraph 3.2: REST: REpresentational State Transfer: “To ground our exploration of these new issues, we began by restating REST to verify that it could induce the property of consensus. Our more-rigorous correctness argument elucidated that REST depends on synchronized global clocks to ensure leases expire simultaneously. Synchronization still presumes that every response message specifies its lease interval. Many real-world ORIGIN_SERVER (s) do not specify when next permissible resource update is scheduled. The external environment could update resources at random (e.g. editing a file “by hand”). One solution is a heartbeat: defining a default lease duration and delaying updates until the next cycle”. Note that the second message's lease expires before it even arrives. One solution is a heartbeat: defining a default lease duration and delaying updates until the next cycle” The point being made here by the referenced source and Simple Wins Concepts LLC is that REST alone does not address many issues. Page 9, paragraph 7 ARRESTED Document “First, we identified four new capabilities that could be combined with REST individually to induce the properties we desired: events, routes, locks, and estimates. Then, we were able to combine these to derive four new styles optimized for each of the four types of resources. For centralized resources, we enforce simultaneous agreement by extending REST into an event-based architectural style by adding A synchronous event notification and routing through active proxies (ARREST). For distributed control of shared resources, we enforce ACID transactions by further extending REST with end-to-end Decision functions that enable each component to serialize all updates (ARREST+D). The alternative to simultaneous agreement is decentralization: permitting independent agents to make their own decisions. This requires accommodating four intrinsic sources of uncertainty that arise when communicating with remote agencies: loss, congestion, delay, and disagreement. Their corresponding constraints are best effort data transfer, Efficient summarization of data to be sent, Approximate estimates of current values from data already received, and Self-centered trust management. These so-called ‘BASE’ properties can be enforced by replacing references to shared resources with end-to-end Estimator functions. Such extensions to REST can increase precision of measurements of a single remote resource (ARREST+E); as well as increase accuracy by assessing the opinions of several different agencies (ARRESTED) to eliminate independent sources of error. Furthermore, application of these styles to real-world problems has been shown to be both feasible and effective, using both open-source and commercial tools. The Heart Beacon Cycle and ARREST extensions contain many of the same building blocks but have yet to be harmonized to reach the full potential of NSF funded research as enhance by DARPA/IARPA best practice as enhanced by novel Heart Beacon Cycle approaches in describing and metering events in time/space e.g., the water drop in pond meme/Paul Revere memes for example. 3.2 REST: REpresentational State TransferTo ground our exploration of these new issues, we began by restating REST to verify that it could induce the property of consensus. Our more-rigorous correctness argument elucidated that REST depends on synchronized global clocks to ensure leases expire simultaneously. Synchronization still presumes that every response message specifies its lease interval. Many real-world ORIGIN_SERVER (s) do not specify when next permissible resource update is scheduled. The external environment could update resources at random (e.g. editing a file “by hand”). One solution is a heartbeat: defining a default lease duration and delaying updates until the next cycle. The Heart Beacon Cycle stipulates micro-cycles supporting longer, macro-cycles. NSF REST extensions and Heart Beacon Cycle building blocks/core Functions both focus on updating state meta data snapshots/heartbeat sync delta messages over a Distributed, wide area Cloud computing/grid environment where a global clock—in this diagram, National Institute of Standards And Technology NIST's Time Server providing time sync pulses to network time sync equipment e.g., Symmetricom. NSF's REST ORIGIN SERVER corresponds with NIST TIME Server state meta data snapshots are sampled In micro-cycles aggregated/“summarized” in NSF ARREST parlance. Heart Beacon Cycle's water drop in pond, Paul Revere memes lend to consistency and reliability among scalability and therefore, elasticity measures and metrics Cloud Computing Metrics as derived from National Institute of Standards and Technology NIST United States Government Cloud Computing Standards and Technology Roadmap (NIST SP 500-293) Requirement 10: —10.1 Specify and Standardize the Units of Measurement for Cloud services, 10.2 RESTful implementations exist (Representational State Transfer). Rounds of negotiation are modeled as a rooted tree.

Signal From Wikipedia, the free encyclopedia: Signal, signals, signaling, or signalling may refer 1 Transportation 2 Communications 3 Names 4 Other 5 See also Communications Beacon, Distress signal, International maritime signal flags, using International Code of Signals Maritime flag signalling, flaghoist signalling, by which ships communicate with each other Naval flag signalling, covers various forms of flag signalling, such as semaphore or flaghoist Recognition signal in human, technical or biological communications, Unix signal, a form of inter-process communication, Signal (electrical engineering), a function that conveys information about the behavior or attributes of some phenomenon, Signals, military communications, Signalling (telecommunications), communication protocols, Signalling (economics) in economic theory, Signals in legal citations, Signal velocity, Source: Wikipedia

Timekeeping is a part of the foundation of recordkeeping. The UTC timestamp in use worldwide is an atomic time standard. The relative accuracy of such a time standard is currently on the order of 10-15[13] (corresponding to 1 second in approximately 30 million years). The smallest time step considered observable is called the Planck time, which is approximately 5.391×10-44 seconds—many orders of magnitude below the resolution of current time standards. Wikipedia

U.S. Pat. No. 7,272,148 Non-ALG approach for application layer session traversal of IPv6/IPv4 NAT-PT gateway: 2. The method of claim 1: forming a heartbeat message sent through a network address translator wherein said heartbeat message includes a header that has as an IPv6 source address; 6. A method of coupling together an IPv4 node and an IPv6 node, comprising:

(a) forming a heartbeat message;
(b) sending said heartbeat message through a network address translator;
(c) forming a heartbeat response message;
(d) sending said response message back through the network address translator; and
(e) repeating (a) through (d) at a periodic rate to prevent a control session, in which the IPv4 node and IPv6 node communicate with each other, from timing out. A structure for coupling together addressable disparate nodes, such as IPv4 nodes and IPv6 nodes, without the use of an application level gateway. Instead, the system includes two executable applications, HEART and ECHO, that avoid the necessity of an application level gateway. In general, HEART and ECHO cooperate with each other through a network address translator-protocol translator (NAT-PT) to cause the NAT-PT to temporarily assign an IPv4 address to a control session between the IPv4 and IPv6 nodes and also prevent the control session from timing out due to lack of timely communications between the IPv4 and IPv6 nodes. Referring still to FIG. 2, HEART 118 is an executable software component which runs on a processor in an IPv6 node. HEART 118 generally performs two functions. The first function is to initiate a process by which a temporary IPv4 address can be assigned to the node 102/104 session so that the IPv6 node 102 can use the IPv4 address when forming its data payloads. The other function performed by HEART 118 is keep the control session between nodes 102 and 104 active until it is no longer needed. ECHO 120 receives the pure IPv4 HEARTBEAT message and swaps the source and destination addresses around to thereby create a return ECHO message. That is, the source address of the ECHO message is ECHO 120's IPv4 address and the destination address is the NAT-PT assigned IPv4 address from pool 108. ECHO 120 preferably forms the payload of the ECHO message to include the NAT-PT assigned IPv4 address from pool 108, which, as noted above, at this time is still unknown by HEART and the IPv6 application. ECHO 120 then transmits the ECHO message back to HEART through NAT-PT 106. Source: U.S. Pat. No. 7,272,148

Open Checklist Interactive Language (OCIL) defines a framework for expressing questionnaires that is used in software process development to harvest information stored during previous data collection efforts or to collect information from people. The intent of OCIL is to provide a standardized basis for expressing questionnaires and related information, such as answers to questions and final questionnaire results, so that the questionnaires can use a standardized, machine readable approach to interacting with humans and using information stored during previous data collection efforts. OCIL documents are Extensible Markup Language (XML) based. This report defines and explains the requirements that IT products and OCIL documents asserting conformance with the OCIL 2.0 specification must meet. OCIL allows organizations to author questionnaires in a standardized format that can be processed by a variety of software products. OCIL also includes constructs for representing such things as questions, instructions that guide users towards an answer, and submission of user provided documents that provide evidence for responses. OCIL facilitates uniform data collection and reporting. Other benefits of using OCIL include: Performing every manual check in the same manner with all required steps followed, regardless of who performs the check. Allowing responses to manual checks to be reviewed for auditing purposes. Fostering the development of standardized, interoperable capabilities in products for creating, evaluating, and supporting manual checks. Fostering collaboration among security-related communities in authoring and composing manual checks. Enhancing the manageability of manual checks. Source: NIST Interagency Report 7692

Wide Area Network Management: See: OGF Network Measurement (NM-WG): the Open Grid Forum OGF is the umbrella group for: Network Markup Language (NML-WG), Taxonomy of network concepts for topology, measurement, etc., Network Service interface (NSI-WG) is the framework for connection service, topology exchange, monitoring negotiation, Network Measurement Control (NMC-WG) protocols for services to exchange measurements, commands

Cloud Auditing Data Federation (CADF) Scope/Objectives: develop standards for a Federation of cloud audit data by specifying a normative, prescriptive audit event data format along with interface definitions and a compatible component and interaction model. A data model will include support for: classification by extensible event taxonomies—normative, prescriptive taxonomies used to categorize cloud provider IT Resources, event actions and outcomes. Federation of customized audit reports and logs—event data will support federation and be composable (sic) into customizable reports and logs. An interface model includes: definition of service methods to manage and federate the data model's events, logs and reports. Interfaces will support audit data submission, import and export, query and subscription.

Crowd funding/sourcing (alternately crowd financing, equity crowd-funding, or hyper funding) describes the collective cooperation, attention and trust by people who network and pool their money and other resources together, usually via the Internet, to support efforts initiated by other people or organizations. Crowd funding occurs for any variety of purposes. Source: Wikipedia

BITCOIN: Bitcoin (sign: BTC) is a decentralized digital currency based on an open-source, peer-to-peer internet protocol. It was introduced by a pseudonymous developer named Satoshi Nakamoto in 2009. Internationally, bit coins can be exchanged by personal computer directly through a wallet file or a website without an intermediate financial institution. In trade, one bitcoin is subdivided into 100 million smaller units called satoshis, defined by eight decimal places. Bitcoin does not operate like typical currencies: it has no central bank and it solely relies on an internet-based peer-to-peer network. The money supply is automated, limited, divided and scheduled, and given to servers or “bitcoin miners” that verify bitcoin transactions and add them to an archived transaction log every 10 minutes. The log is authenticated by ECDSA digital signatures and verified by the intense process of bruteforcing SHA256 hash functions of varying difficulty by competing “bitcoin miners.” Transaction fees may apply to new transactions depending on the strain put on the network's resources. Each 10-minute portion or “block” of the transaction log has an assigned money supply. The amount per block depends on how long the network has been running. Currently, 25 bitcoins are generated with every 10-minute block. This will be halved to 12.5 BTC during the year 2017 and halved continuously every 4 years after until a hard limit of 21 million bitcoins is reached during the year 2140. Bitcoin is the most widely used alternative currency. As of March 2013, the monetary base of bitcoin is valued at over $500 million USD. Double-spending is the result of successfully spending some money more than once. Bitcoin protects against double spending by verifying each transaction added to the block chain to ensure that the inputs for the transaction had not previously already been spent. Other electronic systems prevent double-spending by having a master authoritative source that follows business rules for authorizing each transaction. Bitcoin uses a decentralized system, where a consensus among nodes following the same protocol is substituted for a central authority. Bitcoin has some exposure to fraudulent double-spending when a transaction is first made, with less and less risk as a transaction gains confirmations. Source: Wikipedia

Ripple monetary system: Ripple is an open-source software project for developing and implementing a protocol for an open decentralized payment network. In its developed form (it is not substantially implemented), the Ripple network would be a peer-to-peer distributed social network service with a monetary honor system based on trust that already exists between people in real-world social networks; this form is financial capital backed completely by social capital. Time banking is a pattern of reciprocal service exchange that uses units of time as currency. It is an example of an complementary monetary system. A time bank, also known as a service exchange, is a community that practices time banking. The unit of currency, always valued at an hour's worth of any person's labor, used by these groups has various names, but is generally known as a time dollar in the U.S. and a time credit in the U.K. Time banking is primarily used to provide incentives and rewards for work which a pure market system devalues. Essentially, the “time” one spends providing these types of community services earns “time” that one can spend to receive services.[1] As well as gaining credits, participating individuals, particularly those more used to being recipients in other parts of their lives, can potentially gain confidence, social contact and skills through giving to others. Communities therefore use time banking as a tool to forge stronger intra-community connections, a process known as “building social capital.”

FIX 4.0: Heartbeat <0> message: Description “The Heartbeat <0> is useful for monitoring status of communication links and to identify when a last of a string of messages was not received. When either end of a FIX connection has not sent any data for [HeartBtInt <108>] seconds, it will transmit a Heartbeat <0> message. When either end of the connection has not received any data for (HeartBtInt <108>+“some reasonable transmission time”) seconds, it will transmit a Test Request <1> message. If there is still no Heartbeat <0> message received after (HeartBtInt <108>+“some reasonable transmission time”) seconds then the connection should be considered lost and corrective action be initiated. If HeartBtInt <108> is set to zero then no regular Heartbeat <0> messages will be generated. Note that a Test Request <1> message can still be sent independent of the value of the HeartBtInt <108> which will force a Heartbeat <0> message. Heartbeats issued as the result of Test Request <1> must contain the TestReqID <112> transmitted in the Test Request <1> message. This is useful to verify that a Heartbeat <0> is the result of the Test Request <1> and not as the result of a regular timeout.” Source FIX Protocol

Hong Kong Stock Exchange (Heartbeat of China): A heartbeat in context with the Hong Kong stock exchange includes the time stamp and conventions to indicate real time transmission data and snapshot updates and conventions for data re-transmissions that is functionally similar with the Heart Beacon invention's re-use of the template systems (state meta data) snapshots also known as sync delta messages/heartbeat messages. Since the Hong Kong market is TCP/IP based it relies like other markets on multicast—unicast IP packet transmissions for broadcast and single trade entity updates as does the Heart Beacon invention's template system. Hong Kong's Hkex's Snapshot Image for Recovery is analogous to the template system's heartbeat sync delta messages in that messages are retransmitted to account for missed or out of sequence messages that would cause participating entity/organization to be out of sync with other traders requiring retransmission of the missing or out of sequence sync delta message. The following quotation is from the Hkex source document cited below: “Once an information vendor connects to PRS Plus, snapshot image is automatically downloaded at a predefined transmission rate and has a lower sending priority than a real time message”. Hong Kong Hkex broadcast messages:
Trade detail message=analogous to the template system “SITREP” situation report.
Trade statistic message=analogous to military template system “SPOT REPORT”
Summary statistics message=analogous to template system aggregated sync delta message
Freeform=analogous to military messaging template system “FREE TEXT” message
control message=analogous to a Unit Task Order UTO, and the Alert message is analogous to either a Freeform message or leader initiated SPOT (Size, Position, Observation, Time) report
Underlying instrument message is analogous to a UTO Unit Task Order message
Quotation message is analogous to military template system (Blue Force Tracker) SPOT report
Series definition message is analogous to a sync delta message/heartbeat message
Market/Commodity status message is analogous to a template system SPOT report
Heartbeat message is analogous to template heartbeat messages/state meta-data snapshot

Source: Hong Kong HKEx-IS Information Systems Market Data Transmission Spec PRS V1.0 Flash Trade/High Frequency Trading circuit breaker: a network heartbeat/TCP/IP sub-protocol sets start/stop and Time To Live TTL of a stock market flash trade sessions then notifies next user of next available trade window as an option to the current practice of unrestrained, undefined High Frequency Trade HFT sessions not bounded by time intervals i.e., start, stop, duration as Time To Live TTL. The invention poses a sync delta heartbeat message as the method and means to send alerts of threshold activity to alert then halt runaway flash stock trade activity. High frequency trade algorithms are sophisticated and distributed. The heartbeat as an interval/opportunity in time to do/not do a computational task is the only universal method and means to place start, stop, time to live instructions as bits to a master, central controller managing, controlling high frequency flash trade distributed algorithms. All sophisticated algorithms, bots, mots, scripts, agents. make calls to the heartbeat TCP/IP time stamp and data get/put function. Therefore, a heartbeat is the only universal time control method and means

Candles stock exchange patterns. A candle defines a day's trading: opening price, closing price, daily high, daily low and positive or negative close. This information is wrapped up in a simple symbol that includes a rectangle and two lines, one extending vertically from the top and bottom of the rectangle. The rectangle represents the open and closing prices of the FOREX pair; this rectangle is then color-coded based on whether the currency trading was positive or negative. The two vertical lines represent the high and low that the pair realized for the day.

Intermarket analysis U.S. Pat. No. 8,442,891 B2: A method and a system for performing intermarket analysis. The method can include, from a pool of available markets in which at least one key intermarket has been selected and removed, selecting at least one market as a general intermarket, and removing the market selected as the general intermarket from the pool of available markets. From the pool of available markets from which the general intermarket has been removed, at least one market can be selected as a predictive intermarket and removed from a pool of markets. // Context to invention: “pools” defined by water drop in pond meme for metrics, metering and geo-spatial temporal intensity and “output” onto appliqué overlays

Tranches. A tranche refers to a piece, portion, or slice of a deal. The portion is one of several related securities that are offered simultaneously, but with each having different risks, rewards, and/or maturities. “Tranche” is the French word for “slice.” Investopedia explains Tranches: Tranche is a term used to describe a specific class of bonds within an offering in which each tranche offers varying degrees of risk to the investor. For example, a collateralized mortgage obligation (CMO) that offers a partitioned mortgage-backed security (MBS) portfolio might have mortgages (tranches) that have 1-year, 2-year, 5-year, and 20-year maturities. Tranches can also refer to segments that are offered domestically and internationally. The Heart Beacon Cycle methodology proposes that individual investors may enter a federated group identified by an organization identifier ORG ID where commodity types are identified by Uniform Resource Name URN and activity uniquely identified by time stamping state meta data prior to data fusion center insertion to offer members of the federated group improve network forensics and data analytics as well as newscast beacon broadcast alerts shown on appliqué decision overlay views. Pip: the smallest price change that a given exchange rate can make. Since most major currency pairs are priced to four decimal places, the smallest change is that of the last decimal point—for most pairs this is the equivalent of 1/100 of one percent, or one basis point. Investopedia explains ‘Pip’ for example, the smallest move the USD/CAD currency pair can make is $0.0001, or one basis point. The smallest move in a currency does not always need to be equal to one basis point, but this is generally the case with most currency pairs. In relation to the Heart Beacon Cycle idea, a heartbeat defines available time sequence intervals in which Pips occur, start and end. Heartbeat messages convey Pip changes as sums for example from tracked holdings in a portfolio to a data fusion center where Pip changes may be aggregated in to a cumulative sync delta report sent in a message to other federated participating systems to display currency fluctuations in systems participating in a federated group supported by systems and networks

Microeconomics (from Greek prefix mikro-meaning “small” and economics) is a branch of economics that studies the behavior of individual households and firms in making decisions on the allocation of limited resources (see scarcity).[1] Typically, it applies to markets where goods or services are bought and sold. Microeconomics examines how these decisions and behaviors affect the supply and demand for goods and services, which determines prices, and how prices, in turn, determine the quantity supplied and quantity demanded of goods and services.[2][3] This is in contrast to macroeconomics, which involves the “sum total of economic activity, dealing with the issues of growth, inflation, and unemployment.”[2] Microeconomics also deals with the effects of national economic policies (such as changing taxation levels) on the aforementioned aspects of the economy. Particularly in the wake of the Lucas critique, much of modern macroeconomic theory has been built upon ‘micro-foundations’—i.e. based upon assumptions about micro-level behavior. A goal of microeconomics is to analyze markets that establish relative prices amongst goods and services and allocation of limited resources amongst many alternative uses. Microeconomics analyzes market failure, where markets fail to produce efficient results, and describes the theoretical conditions needed for perfect competition. Fields of study in microeconomics include general equilibrium, markets under asymmetric information, choice under uncertainty and economic applications of game theory. Source Wikipedia

Macroeconomics (from the Greek prefix makro-meaning “large” and economics) is a branch of economics dealing with the performance, structure, behavior, and decision-making of an economy as a whole, rather than individual markets. This includes national, regional, and global economies.[1][2] With microeconomics, macroeconomics is one of the two most general fields in economics. Macroeconomists study aggregated indicators such as GDP, unemployment rates, and price indices to understand how the whole economy functions. Macroeconomists develop models that explain the relationship between such factors as national income, output, consumption, unemployment, inflation, savings, investment, international trade and international finance. In contrast, microeconomics is primarily focused on the actions of individual agents, such as firms and consumers, and how their behavior determines prices and quantities in specific markets. Macroeconomic forecasts are used by both governments and large corporations to assist in the development and evaluation of economic policy and business strategy. Source: Wikipedia

Gateway address, Computer terminology an IP address for a network interface on a router that leads to a larger network Gateway (telecommunications), a network node equipped for interfacing with another network that uses different communication protocols Gateway (web page), a webpage designed to attract visitors and search engines to a particular website payment gateway, the software interface between a web-based shopping cart and a merchant account. Gateway (computer program), a link between two computer programs allowing them to share information and bypass certain protocols on a host computer. Source Wikipedia.

Currency converter: A currency converter is software code that is designed to convert one currency into another in order to check its corresponding value. The code is generally a part of a web site or it forms a mobile app and it is based on current market or bank exchange rates. In order to convert one currency into another, a user enters an amount of money (e.g. ‘1000’) and chooses the currency he/she wishes to check the monetary value of (e.g. ‘United States Dollar’). After that, the user selects one, or sometimes several other currencies, he/she would like to see the result in. The application then calculates and displays the corresponding amount of money. Currency converters aim to maintain real-time information on current market or bank exchange rates, so that the calculated result changes whenever the value of either of the component currencies does. They do so by connecting to a database of current currency exchange rates. The frequency at which currency converters update the exchange rates they use varies: Yahoo currency converter updates its rates every day,[1] while Convert My Money currency converter—every hour.[2] Currency converters are often used as a means of checking the relative value of a currency before exchanging it into another currency. Source: Wikipedia

Heartbeat Message Definition: A heartbeat message is a message sent from an originator to a destination that enables the destination to identify if and when the originator fails or is no longer available. Heartbeat messages are typically sent non-stop on a periodic or recurring basis from the originator's start-up until the originator's shutdown. When the destination identifies a lack of heartbeat messages during an anticipated arrival period, the destination may determine that the originator has failed, shutdown, or is generally no longer available. In military command and control systems, a heartbeat message has a brevity code of K00.99 Source: Wikipedia see also applicant's previous continuation applications for detailed descriptions of heartbeat messages

See also: Universal Mobile Telecommunications System (UMTS); Signaling System No. 7 (SS7) signaling transport in core network; heartbeat, heartbeat messages, heartbeat procedure Heartbeat messages are part of the become the standard protocol for interoperability between all messaging middleware namely the Advanced Message Queuing Protocol (AMQP) is an open standard for passing business messages between applications or organizations. It connects systems, feeds business processes with the information they need and reliably transmits onward the instructions that achieve their goals. AMQP connects across: Organizations—applications in different organizations. Technologies—applications on different platforms. Time—systems don't need to be available simultaneously Space—reliably operate at a distance, or over poor networks

Security and Exchange Commission memorandum concerning heartbeat messages: “A Heartbeat message is a communication which acts as a virtual pulse between a Gateway and the Trading Host. The Heartbeat message sent by the Gateway and a Gateway for a specified period of time, the Quote Removal Mechanism will automatically cancel all Market Maker quotes that were posted through the affected Gateway. As proposed, the Quote Removal Mechanism will monitor the connections between the Trading Host and the Gateways. The Trading Host will continuously count the number of seconds (“n”) (the “Counter”) since the last Heartbeat message was received from a particular Gateway. Each Heartbeat message received by the Trading Host from a particular Gateway will restart the Counter for that particular Gateway. The Quote Removal Mechanism will be triggered, and a Market Maker's quotes will automatically be removed from the Trading Host, if the Counter reaches “n” seconds. Any non-connectivity is Gateway-specific. Therefore, the cancellation of the Market Makers' quotes entered into the Trading Host via a particular Gateway will neither impact nor determine the treatment of the quotes of the same or other Market Makers entered into the Trading Host via a separate and distinct Gateway. After the Quote Removal Mechanism is employed, and upon a reconnection between the Gateway and the Trading Host, the Trading Host will send a message to the affected Market Makers informing them that their quotes through the specific affected Gateway have been automatically cancelled. The period of non-connectivity that will trigger the removal of the Market Makers' quotes via the Quote Removal Mechanism will be standard for all Market Makers. The Quote Removal Mechanism will be enabled for all Market Makers on their appointed options classes during the trading day and may not be disabled by the Market Makers. Examples illustrate the manner in which the Quote Removal Mechanism will function

1) 11:30:00 Counter starts, 11:30:02—Trading Host receives a Heartbeat message from Gateway 1. Counter re-starts 2) 3:30:00 Counter starts 3:30:02: —Trading Host receives a Heartbeat message from Gateway 1. Counter re-starts 3:30:07—No Heartbeat messages received from Gateway 1 after 5 seconds. Pursuant to the proposed Quote Removal Mechanism, all Market Maker quotes entered through Gateway 1 are removed from the Trading Host. As demonstrated above, the Counter will restart for a Gateway each time the Trading Host receives a Heartbeat message from that particular Gateway. Once connectivity to the Gateway is reestablished, the Market Makers affected by the mechanism will be able to send messages to the Trading Host in order to reestablish their quotes. Any quotes affected by the Quote Removal Mechanism, including quotes that are removed from the Trading Host and/or quotes sent to BOX during the period of non-connectivity, will not be taken into account when determining whether a Market Maker has fulfilled its continuous quoting obligations on BOX. Only after connectivity to the Gateway has been reestablished will quotes once again be taken into account for this purpose”.

Source: Securities Exchange Commission Release No. 34-58140; SR-BSE-2008-40 7/10 2008 Heartbeat Administration Interface (SCOP): Uses: Cloud Interface Management, configuration, start, stop cloud services, edit configuration using heartbeat messages. SCOP enables view/edit configuration files e.g., heartbeat message state management snapshots, take a server online/offline, add/remove virtual/real servers, etc. SCOP type tools are used to maintaining records of “CRUD” of actors, entities, artifacts—creation, replacement, update, and deletion A heartbeat configuration management interface like Source Forge dot net's SCOP Heartbeat Administration Interface (SCOP) is used as a cloud computing Interface management application that sets initial configuration, start, stop cloud services, edit configurations sent to devices, platforms etc. using heartbeat messages. SCOP enables view, editing of configuration files e.g., heartbeat message as state management snapshots, take a (master scheduling) server online/offline, add/remove virtual/real servers, etc. Using a system administration interface like SCOP is used in conjunction and coordination with a master scheduling service i.e. U.S. Pat. No. 6,747,976 Distributed scheduling architecture with efficient reservation protocol is include in a distributed scheduling architecture to account for hierarchy of schedulers comprising one master scheduler and many slave schedulers where time slots are allocated as heartbeat intervals based on information received through a reservation protocol copies information from a prior heartbeat micro-cycle if that state meta data information is out of date. Distributed algorithms are complex and agile. However, algorithms, regardless of how sophisticated, agile and distributed they are assigned a central, master distributed scheduler that may be sent instructions such as commands to end processes if for example, set thresholds are exceeded. Simple Network Management Protocol (SNMP) is used to monitor, query network components for information about configuration, activity, errors, etc. SNMP trapped information is used to extrapolate whether a user is static (not moving), dynamic (moving) based on consistency of reporting—missing n reports equates to a stale condition and missing n+1 reports (exceeded an arbitrary threshold) means that the entity/object/artifact/platform, device is considered inoperative and assumed non-mission capable until reported and verified involves a detection/verification process.

Micro-revenue is the earning of revenue by streams of traditional or virtual currency, where many small transactions or micropayments contribute to a much larger outcome. Micro-revenue follows the logic that great change can be accomplished by many small acts and is an evolved idea from the success of the microcredit approach to financing small business. This is especially achievable within on-line communities that arise around a cause, a belief or a mass-appeal project. Micro-revenue has particular advantages for social businesses that rely upon small-scale transactions but may have ambitious or hard-to-define investment targets that can be hard to fund using traditional means. The micro-revenue proposition draws significant strength from Crowd-sourcing the phenomenon explored by Jeff Howe in his book of the same name. Communities of activity and of interest are no longer constrained by geography and can be massive in scale while drawing on devolved knowledge, which encourages the rise of micro-revenue. The phrase ‘micro-revenue’ was coined and developed by Howard Jones, Director of Human Networks at the Eden Project in Cornwall. This was as a result of his creating the Living Networks program as a first example of very large, networked, social business. For the model to work, the architecture and characteristics of the network needed to allow very large numbers of tiny transactions that develop revenue to support the program and feed its development. The reasoning for this to happen is summarized in an article by Howard Jones in the book Beyond by Mario Raich. The practicalities are that this open-source approach to network economies can help provide environments for new communities of interest and ideas, for support systems, and for increased resilience for societies that are vulnerable to existing or traditional socio-economic rules. Source: Wikipedia Article Entry: Micro-Revenue. See also: micro-currencies

Spatial econometrics is the field where spatial analysis and econometrics intersect. In general, econometrics differs from other branches of statistics in focusing on theoretical models, whose parameters are estimated using regression analysis. Spatial econometrics is a refinement of this, where either the theoretical model involves interactions between different entities, or the data observations are not truly independent. Thus, models incorporating spatial auto-correlation or neighborhood effects can be estimated using spatial econometric methods. Such models are common in regional science, real estate economics, and education economics. Source: Wikipedia

Complementary currency (CC) is a currency meant to be used as a complement to another currency, typically a national currency.[1] Complementary currency is sometimes referred to as complementary community currency (CCC) or as community currency. The term local currency, describing a complementary currency which is limited to a single locality, is sometimes used interchangeably with complementary currency. There are, however, some complementary currencies which are regional or global, such as the Community Exchange System, WIR and Friendly Favors, or the proposed global currency terra. Complementary currency describes currencies that exists as a supplement to our conventional (national) money. “A complementary currency ( . . . ) is an agreement to use something else than legal tender (i.e. national money) as a medium of exchange, with the purpose to link unmet needs with otherwise unused resources” (Lietaer & Hallsmith 2006: 2). Complementary currencies advocates thus don't claim a full separation of money and state. Complementary currencies are often designed intentionally to address specific issues or problems.[3] Most complementary currencies have multiple purposes and/or are intended to address multiple issues. They are very useful for communities that do not have access to financial capital, and can be useful for adjusting peoples' spending behavior. [4] In the current economic climate, some local money projects can also be promoted as low carbon, by encouraging localization of trade and relationships lifeboat currencies encouraging use of under-used resources recognizing the informal economy Source: Wikipedia

Micro-payment: A micropayment is a financial transaction involving a very small sum of money and usually one that occurs online. Micropayments were originally envisioned to involve much smaller sums of money, practical systems to allow transactions of less than 1 USD have seen little success.[3] One problem that has prevented the emergence of micropayment systems is a need to keep costs for individual transactions low,[4] which is impractical when transacting such small sums[5] even if the transaction fee is just a few cents. Source: Wikipedia

Real-time bidding (RTB) is method of selling and buying online display advertising in real time one ad impression at a time. here are 3 groups of entities involved, just like in financial markets: buyers and systems that use Demand Side Platforms (DSP), sellers who use Supply Side Platforms (SSP), online real-time ad exchanges. An emerging standard is OpenRTB. A goal of OpenRTB Online is to reduce the cost and increase the consistency of managing the synchronization of advertiser requirements and publisher requirements with all players in the ecosystem e.g., synchronization of block lists, common taxonomies, etc. device issues, data overlays, and web vs. application nuances. The protocols outlined in this document should be considered guidelines, not absolute rules. The overall goal of OpenRTB is to create a lingua franca for communicating between buyers and sellers. The intent is not to regulate exactly how each business operates. As a project, we aim to make integration between parties easier, so that innovation can happen at a deeper-level at each of the businesses in the ecosystem. OpenRTB supports both “offline” batch synchronization of information and “online” real-time synchronization. Open RTB's objects include “geo-objects”. The Heart Beacon Cycle involves identifying objects/resources (Uniform Resource Name) in a mesh fabric using water drop in pond type meme protocols and Paul Revere type memes to describe time—space and synchronization deltas in time-space. In context with the Heart Beacon the main embodiments add as an improvement internet TCP/IP networking and firefly mathematical protocol stochastic harmonization combined with Heart Beacon Cycle sync delta summary synchronization as a comparison. Source OpenRTB site and Wikipedia entries

Firefly inspired Heartbeat Synchronization: in a paper entitled Firefly-inspired Heartbeat Synchronization in Overlay Networks by the University of Bolonga and Trento Italy along with the University of Szeged, Hungary: “Heartbeat synchronization strives to have nodes in a distributed system generate periodic, local “heartbeat” events approximately at the same time. Many useful distributed protocols rely on the existence of such heartbeats for driving their cycle-based execution. The heartbeat synchronization protocol for overlay networks is inspired by mathematical models of flash synchronization in certain species of fire flies. Nodes send flash messages to their neighbors when a local heartbeat triggers. Fireflies adjust the phase of their next heartbeat based on incoming flash messages using an algorithm inspired by mathematical models of firefly synchronization. Heartbeat synchronization strives to have nodes in a distributed system generate periodic, local “heartbeat” events approximately at the same time. It differs from classical clock synchronization in that nodes are not interested in counting cycles and agreeing on a ID of a current cycle. There is no requirement regarding the length of a cycle with respect to real time as long as a length is bounded and all nodes agree on it eventually. What we are interested in guaranteeing is that all nodes start and end their cycles at the same time, with an error that is at least one, but preferably more, orders of magnitude smaller than a chosen cycle length. Firefly heartbeat synchronization reduces uncertainty in stochastic networks”

Hop Count: in computer networking, hop count refers to intermediate devices (routers, switches) through which data must pass between source and destination, rather than flowing directly over a single wire. Each router along a data path constitutes a hop, as data is moved from one Layer 3 network to another. Hop count is therefore a basic measurement of distance in a network. By itself, hop count is not a useful metric for determining the optimum network path, as it does not take into consideration the speed, load, reliability, or latency of any particular hop, but merely a total count. Hop counts are often useful to find faults in a network to discover if routing is correct. Network utilities like Ping can be used to determine the hop count to a specific destination. Ping generates packets that include a field reserved for the hop count. Each time a capable device receives these packets, that device modifies the packet, incrementing a hop count by one. Devices compare a hop count against a predetermined limit and discards a packet if its hop count is too high. See also TCP/IP, ICMP, Routing, Time to live. Source: Wikipedia Hop counts in context with Heart Beacon Cycle meme Water Drop in Pond (124/130): Earth quakes serve as a best effort corollary to a water drop in pond meme example where circular, spherical zones of a water drop in pond represent aftershock size, frequency with time: Aftershocks rates and magnitudes follow several well-established empirical laws. Omori's Law The rate of aftershocks with time follows Omori's law (modified) is an empirical relation for the temporal decay of aftershock rates. In 1894, Fusakichi Omori published his work on aftershocks of earthquakes, in which he stated that aftershock frequency decreases by roughly the reciprocal of time after the main shock. where: n(t) is the rate of earthquakes measured in a certain time t after the main shock, K is the amplitude, and c is the “time offset” parameter. The modified version of Omori's law, now commonly used, was proposed by Utsu in 1961.[2][3] where p modifies the decay rate and typically falls in the range 0.7-1.5. According to these equations, the rate of aftershocks decreases quickly with time. The rate of aftershocks is proportional to the inverse of time since the main shock and this relationship can be used to estimate the probability of future aftershock occurrence.[4] Thus whatever the probability of an aftershock are on the first day, the second day will have 1/2 the probability of the first day and the tenth day will have approximately 1/10 the probability of the first day (when p is equal to 1). These patterns describe only the statistical behavior of aftershocks; the actual times, numbers and locations of the aftershocks are stochastic, while tending to follow these patterns. As this is an empirical law, values of the parameters are obtained by fitting to data after a main-shock has occurred, and they imply no specific physical mechanism in any given case. Bath's Law states that the difference in magnitude between a main shock and its largest aftershock is approximately constant, independent of the main shock magnitude, typically 1.1-1.2 on the Moment magnitude scale Gutenberg-Richter law: Aftershock sequences also typically follow the Gutenberg-Richter law of size scaling, which refers to the relationship between the magnitude and total number of earthquakes in a region in a given time period i.e., more small aftershocks, less large aftershocks

IODEF-RID Schema: The Incident Object Description Exchange Format defines a data representation that provides a framework for sharing information commonly exchanged by Computer Security Incident Response Teams (CSIRTs) about computer security incidents. Three classes in the RID extension facilitate RID communications. A RequestStatus class is used to indicate the approval status of a TraceRequest or Investigation request; a IncidentSource class is used to report whether or not a source was found and to identify the source host(s) or network(s); and a RID_Policy class provides information on the agreed-upon policies and specifies the type of communication message being used. A RID schema acts as an envelope for the IODEF schema. Strategic Markup Language StratML is planned to be a standardized XML template and vocabulary for strategic plans, performance plans and performance reports in alignment with policies and standards. This standard will enable the sharing, referencing, indexing, discovery, linking, reuse and analysis of the elements of strategic plans including goal and objective statements. Strategy Markup Language (StratML) Part 1 is an XML vocabulary and schema for strategic plans. Purposes include but may not be limited to the following: facilitate the sharing, referencing, indexing, discovery, linking, reuse, and analyses of the elements of strategic plans, including goal and objective statements as well as the names and descriptions of stakeholder groups and any other content commonly included in strategic plans.

Source: Real-time Inter-network Defense 6.4.1 Multi-hop TraceRequest Authentication Extended Incident Handling Working Group Kathleen M. Moriarty Internet-draft EMC: Informational Jul. 6, 2010 RID IETF Office Secretary Defense OSD Department of Defense IETF 1981 ICMPv6 [RFC 2006b] Echo Request/Response IETF 2006a generalized notion of the Heartbeat tactic to System Monitor. In a high availability system, a system monitor tactic is used to monitor state of health, which includes the detection of hung or runaway processes; a heartbeat is one measure of health that a System Monitor could observe. When a detection mechanism is implemented using a counter or timer that is periodically reset, this specialization of System Monitor is referred to as a Watchdog. During nominal operation, a process being monitored will periodically reset the watchdog counter/timer, commonly referred to as “petting the watchdog.” A heartbeat is defined in this context as a periodic message exchange between the system monitor and process Indicates to system monitor when fault is incurred in process. Expiration of the watchdog counter/timer provides an indication to a System Monitor that a process being monitored has incurred a fault. When a underlying fault detection mechanism employs a periodic message exchange between the System Monitor and a process being monitored, this is referred to as a Heartbeat. Source: Software Engineering Institute article: Realizing and Refining Architectural Tactics

Newscast peer sampling service: middleware service that provides random samples from a decentralized network to support gossip-based applications such as multicast, data aggregation and overlay topology management. Lightweight gossip-based implementations of peer sampling services have shown to provide good quality random sampling while being extremely robust to many failure scenarios, including node churn and catastrophic failure. Newscast is based on an adaptive self-control mechanism for its parameters where nodes passively monitor local protocol events using them as feedback for a local control loop for self-tuning the protocol parameters. Significance to a Heart Beacon Cycle: a novel combination of a synchronous, predicable state management sampling process (TCP/IP heartbeat) with heartbeat inspired firefly synchronization statistical movement towards a mean/average leveraging the best of both approaches to harmonize stochastic networks reducing jitter and improving network availability.

C37.118-2005 IEEE Standard for Synchrophasors for Power Systems: This standard defines synchronized phasor measurements used in power system applications. It provides a method to quantify the measurement, tests to be sure a measurement conforms to the definition, and error limits for a test. It also defines a data communication protocol, including message formats for communicating this data in a real-time system. Applications of C37.118-2005 include “watchdog heartbeats” and periodic pulse heartbeats suitable for data acquisition. Source: IEEE

University of California Berkeley Sea Gull Protocol: Seagull is a data maintenance project with a desired outcome to identify a minimal set of requirements to store data in wide-area networks including metrics of system usage and means to measure performance in terms of number of failures, (un)announced, bandwidth, usage experience, etc. A file is cached and replicated throughout an infrastructure as a Byzantine ring method committing changes to a file that performs an agreement on changes and multicasts changes to each replica. Every version of every object is archived tradeoffs/consequences. In Sea Gull, a clustering object function is ambiguous to minimize probability of failure across clusters. In Sea Gull's detection phase, the goal is to maintain routing and object state using minimal resources. Bubbles as concentric circles (124, 130) represent cached and replicated files. (118) and bubbles as concentric circles represent a Byzantine ring responsible for committing changes to a file. Suppose now that the author wants to add a new verse to the song and modify the file. Changes to the file are submitted to the infrastructure performing a Byzantine agreement on changes that are broadcasted, newscasted, multicasted or beaconed to each file/document/artifact replica. Since each replica can respond to a request for file updates, so remote acceptance of file changes are verified in an acknowledgement that changes were accepted and applied where the system administrator receives an aggregate report of participating systems activities or lack thereof summarizing results returned in context with displaying them on an appliqué overlay dashboard. This allows each platform, device, user that maintains a file replica (118) to come and go as it pleases (tether and un-tether to the network) with a broadcast update refresh process that verifies data refresh during Heart Beacon Cycles. This application is interested in Sea Gull's TCP/IP internet multicast using a method with increasing radius function maintaining a “tapestry MIB (management information Base) in context with increasing and decreasing radii. Sea Gull's heartbeat period increases with distance. Distance is number of application-level hops. Redundancy steps are built into the update process e.g., during a Heart Beacon Cycle. A modification to a UTO (118) file is submitted to the network, a Byzantine agreement is performed and immediately fragments from the erasure codes i.e., the old task order has been overwritten (118) were disseminated and committed tracked by organizational ID and URN and time stamp per instance/platform/device/user. Note that fragments are much smaller than the actual data (e.g., only the changes to the file, not the whole file known as a sync delta message were sent). The system is kept durable in Sea Gull as a repair process that is referential to and replaces lost redundancy/fragments which are like sync delta changes in a Heart Beacon Process. A Heart Beacon Process makes use of Simple Network Management Protocol (SNMP) as a standard protocol for monitoring to query network components for information about their configuration, activity, errors, etc as part of citing the need for TCP/IP as a requirement in embodiment 1. SNMP trapped information is used to extrapolate whether a user is static (not moving), dynamic (moving) based on consistency of reporting—missing n reports equates to a stale condition and missing n+1 reports (exceeded an arbitrary threshold) means that the entity/object/artifact/platform, device is considered inoperative and assumed non-mission capable until reported and verified as otherwise which involves a detection/verification process. Sea Gull protocol example, Republish/Object Heartbeats: Object Heartbeat (Republish) where Heartbeat period increasing with distance (i.e. Heartbeat frequency decreases with distance) Distance is number of application-level hops in a Distributed SWeep where Request object from storage servers is applied during a Sweep period increasing with distance (i.e. Sweep frequency decreases with distance). Global Sweep (Responsible Party/Client), Request object from storage servers at regular intervals. Period constant. (i.e. frequency constant). The resulting Fraction of Blocks Lost Per Year (cycle) (FBLPY) for a variety of epoch lengths and number of fragments is achieved by following a process where for a given frequency of repair and number of fragments (i.e., changes to a TTO, UTO file (118), this (appliqué overlay) graph shows the fraction of all encoded blocks that are lost/stale/straggler, inoperative. To generate a graph (appliqué overlay 134), we construct a probability that a fragment (of the sync delta update 115) will survive until the next epoch from the distribution of disk lifetimes, using a method similar to computing the residual average lifetime of a randomly selected disk (in data fusion center 119). The probability that a block can be reconstructed is the sum of all cases in which at least m fragments survive. A FBLPY is an inverse of a mean of a geometric distribution (FIG. 1 lower right hand of diagram corresponding to a little league baseball field) produced from the block survival (i.e. 1/Mean Time To Forward MTTF of a block) in a method involving detection and then reconstruction of fragments. A Sea Gull system automatically adapts to failure and attempts to repair itself. Gain in stability is achieved through analysis of performance and efficiency statistics. This invention inventor is citing the Sea Gull Protocol example in context with a Heart Beacon Cycle to show similarity and established effectiveness where the Sea Gull protocol may not necessarily be present in the embodiment but would be highly desirable given it is a close commercial rendition of the military Blue Force Tracker system described in previous applications as a continuation thus describing the main intent of the invention namely, identify the common components/building blocks/processes replicated over a a systems of systems. Sea Gull describes a method using heartbeats and repair as a method to improve updating systems that intrinsically move towards an inconsistent state entropy using a heart cycle based paradigm. Source: Copyright 2003 Hakim/Weatherspoon UC Berkeley Ocean Store Boston University's Beacon Project as part of the city of Boston's traffic mitigation “Big Dig” A Network Diagnosis Toolkit. The focus of the Beacon Project is the development of tools capable of diagnosing network conditions with only the assistance of end-to-end measurements. In its basic form, this toolkit is designed to passively monitor network conditions at a single busy network endpoint such as a server. In its full generality, this toolkit can be used to actively monitor network conditions, and can be concurrently operated by a set of collaborating endpoints. Over short time scales, Beacon will use wavelet analysis to identify local scaling events in wide-area TCP traffic which trigger bursts of packet loss. At medium time scales, a Beacon will draw correlations between end-to-end measurements made by concurrent TCP connections to draw conclusions about hotspots in the network. Over the long time scales, a Beacon will build up an understanding of long-term network dynamics, especially focusing on regions which persistently experience congestion from the perspective of the source

CodeBlue MoteTrak: Harvard University/Boston Medical system includes MoteTrack, a system for tracking a location of individual patient devices indoors and outdoors, using radio signal information. In MoteTrack, a hospital, clinic, or other area is outfitted with a set of fixed radio beacon nodes that are used to calculate a 3D position of the wireless sensors, which may be attached to patients, carried by physicians or nurses, or attached as “location tags” to medical equipment. MoteTrack has been demonstrated in a building-wide deployment at Harvard and yields an 80th percentile error of about 2 meters, adequate for location-tracking applications.

FLUX: A Forensic Time Machine for Wireless Networks: monitoring infrastructure for forensic data collection, storage and analysis supporting the recording and retrieval of traffic signatures and environmental observations, considered to be a source of network evidence. Limeric Univ SABER (Situational Awareness BEacon with Reply) is a sophisticated battle group situational awareness system capable of determining the location of beacon-equipped assets worldwide. Using the Global Positioning System (GPS), SABER produces accurate position and platform identification data and sends to tactical users and global command and control nodes, It's system relays position information via UHF line-of-sight and UHF satellite communications channels

Sentinel Beacon Command Station: is a ruggedized PC that receives the data transmitted from beacons and processes beacon data to produce location and track information for an incident commander. It is designed to work as a mesh network so that a beacon out of range of a command station can have its data relayed by other beacons. South West Research Institute Domain Announcement Protocol DAP: by Telcordia: Beacon Protocol maintains domains with network splits and merges. Algorithms dynamically decide domain membership based on node mobility, and roles. Source Telcordia Labs

Apache Hadoop: Hadoop consists of the Hadoop Common which provides access to files. A heartbeat is sent from the TaskTracker to the JobTracker and uses XML messages. is an open-source software framework that supports data-intensive distributed applications, licensed under the Apache v2 license. It supports the running of applications on large clusters of commodity hardware. Hadoop was derived from Google's MapReduce and Google File System (GFS) papers. Hadoop was named after a child's toy. The Hadoop framework transparently provides both reliability and data motion to applications. Hadoop implements a computational paradigm named MapReduce, where the application is divided into many small fragments of work, each of which may be executed or re-executed on any node in the cluster. In addition, it provides a distributed file system that stores data on the compute nodes, providing very high aggregate bandwidth across the cluster. Both map/reduce and the distributed file system are designed so that node failures are automatically handled by the framework. It enables applications to work with thousands of computation-independent computers and petabytes of data. The entire Apache Hadoop “platform” is now commonly considered to consist of the Hadoop kernel, MapReduce and Hadoop Distributed File System (HDFS), as well as a number of related projects—including Apache Hive, Apache HBase, and others. Source: Wikipedia Apache Hadoop entry

Drupal. The standard release of Drupal, known as Drupal core, contains basic features common to content management systems. These include user account registration and maintenance, menu management, RSS feeds, page layout customization, and system administration. Heartbeat displays user activity on a website. This module is an API to log activity. The logged data contains message structures, attributes and variables. Once the activity messages exist in the database, they will be parsed and build into activity streams. Logging Each module can log their own activity streams. This could be done by calling the api functions or by rules. This implicates that other modules, using the rules ui, can be interesting for Heartbeat if activity events and triggers are defined. Great modules that handle user relations like organic groups and friendlist describe rule events. Display Heartbeat has global configuration for display, message template configuration and stream configuration. Each stream (or access type) is a class based on Heartbeat_Access. It is basically a query builder (more gracefully in Drupal 7 branch thx to excellent database design) that returns its results to a parser. The activity messages can be restricted on several levels which means that there are lots of access checks. Because sometimes this debugging is rather hard, heartbeat can now run in debug-mode. This way it's real easy to see why a message is blocked when viewing a stream. Each message can have a number of attachments. E.g.: commenting, flags. As community module, heartbeat integrates with flag_friend, friendlist and User relationships. The connected heartbeat is a built-in stream, available when enabling the friendlist_activity module. Make sure to select the friends API in the global settings. Features Heartbeat logs activity for nodes, comments, users/profiles and organic group activity Integration module for flags, so each activity stream item can have a number of flags as message attachment. heartbeat comments submodule to comment on a message. Message templates can be set to use node-comments when in node context. shout submodule to shout a message like twitter or facebook's “What are you doing”, and to allow commenting Heartbeat Display suite implementation to make the theming controllable by UI only. Build modes can be set per message type or overriden per stream. View integration although heartbeat is in fact a display module includes grouping and “max number” heartbeat blocks and pages. Other modules that work with heartbeat activity: Facebook-style Statuses. Flag, flag friend, Friendlist, User relationships and of course Display suite. Drupal Project Heartbeat World Bank API|drupal.org/project/wbapi. The World Bank API makes freely available. Wikipedia entry.

OpenStack Metering Using Ceilometer. The objective of the OpenStack project is to produce an Open Source Cloud Computing platform that will meet the needs of public and private clouds by being simple to implement and massively scalable. Since OpenStack provides infrastructure as a service (IaaS) to end clients, it's necessary to be able to meter its performance and utilization for billing, benchmarking, scalability, and statistics purposes. Architecture of OpenStack Ceilometer
The efficient collection of metering data in terms of CPU and network costs.
Collecting data by monitoring notifications sent from services or by polling the infrastructure.
Configuring the type of collected data to meet various operating requirements.
Accessing and inserting the metering data through the REST API.
Expanding the framework to collect custom usage data by additional plugins.
Producing signed and non-repudiable metering messages.

Measurements in Ceilometer. Three type of meters are defined in ceilometer:
Cumulative: Increasing over time (for example, instance hours)
Gauge: Discrete items (i.e., floating IPs, image uploads) fluctuating values (such as disk I/O)
Delta: Changing over time (for example, bandwidth)

Each meter is collected from one or more samples (gathered from the messaging queue or polled by agents), which are represented by counter objects. Each counter has the following fields:
counter_name: string for meter id. As a convention, the ‘.’ separator is used to go from least to most discriminant word (for example, disk.ephemeral.size).
counter_type: one of the described counter types (cumulative, gauge, delta).
counter_volume: amount of measured data (CPU ticks, bytes transmitted through network, provisioning time, etc.). This field is irrelevant for gauge-type counters and should be set to some default value in this case (usually: 1).
counter_unit: description of the counter unit of measurement. Information units should be expressed in bits (‘b’) or bytes (‘B’). When measurements do not represent a volume, unit descriptions should always precisely describe what is measured (instances, images, floating IPs)
resource_id: identifier of the resource being measured (UUID for instance, network, image,)
project_id: project (tenant) ID the resource belongs to.
user_id: the User ID the resource belongs to.
resource_metadata: Some additional metadata taken from the metering notification payload.

In context with the Heart Beacon Cycle invention, note that Openstack Ceilometer metering does not (yet) cite the American Registry for Internet Numbers Organizational Identifier or the Uniform Resource Name which the inventors point out as common building blocks. OpenStack metering Ceilometer specific options in its global configuration settings Ceilometer's metering_api_port is 8777, the port for the ceilometer API server qpid_heartbeat, is 60 denoting seconds between connection keep-alive heartbeats. Heartbeat state meta data snapshots are aggregated into heartbeat snapshot sync delta messages signaled over wide areas.

George Mason University XOM: Extensible Modeling and Simulation Framework Overlay Multicast (XOM): use of Internet/Web-based services in real-time distributed virtual simulation (RT-DVS) and other real-time overlay multicast protocols. XOM addresses Quality of Service (QoS) and many-to-many multicast services. Source: George Mason University University of North Carolina Chapel Hill: Practical Beacon Placement for Link Monitoring using Network Tomography Recent interest in using tomography for network monitoring has motivated the issue of whether it is possible to use only a small number of probing nodes (beacons) for monitoring all edges of a network in the presence of dynamic routing. Use a two-pronged approach to compute an efficient beacon set: (I) we formulate the need for, and design algorithms for, computing the set of edges that can be monitored by a beacon under all possible routing states; and (ii) we minimize the number of beacons used to monitor all network edges.

James Madison University: Time-lining Events from Disparate Sources. We propose the creation of a framework that allows a forensic investigator to synchronize timed events that are obtained from different sources to a common reference time. Once the timestamps have been synchronized, they may be ordered into a timeline of events as they occurred in relation to each other. This will enable the investigator to reconstruct events that are directly or indirectly responsible for incidents in computing. Source: James Madison University

SCADE Safety-Critical Application Development Environment is a development environment used by system and software engineers to produce mission and safety-critical applications. SCADE methods include taking consistent snapshots of data at the time of the event. This procedure aids the ability to dynamically alter business processes aiding in agile, adhoc targeting of new business situations/opportunities enabling highly customizable services and the ability to change parts of a system (s) without effecting other parts of the system (s) due to the asynchronous nature of the supporting system and may be used in tandem with synchronous updates to a system (s. SCADE is a development tool for DO-178B level A/Code generators DO-178B, EN 50128 and IEC 61508 certified) Model test coverage WCET and stack analysis SCADA (supervisory control and data acquisition) generally refers to industrial control systems (ICS): computer systems that monitor and control industrial, infrastructure, or facility-based processes, as described below: Industrial processes include those of manufacturing, production, power generation, fabrication, and refining, and may run in continuous, batch, repetitive, or discrete modes. Infrastructure processes may be public or private, and include water treatment and distribution, wastewater collection and treatment, oil and gas pipelines, electrical power transmission and distribution, wind farms, civil defense siren systems, and large communication systems. SCADA processes monitor and control HVAC, access, and energy consumption.

Micro-grid/Distributed generation: Distributed generation, also called on-site generation, dispersed generation, embedded generation, decentralized generation, decentralized energy or distributed energy, generates electricity from many small energy sources. Energy distribution control systems have the ability to aggregate and economically optimize the dispatch of distributed generation resources for both electricity and heat production (sometimes called a virtual power plant). Multiple demand side management strategies for industrial, commercial and residential consumers include solutions for individual residential, commercial or industrial consumers and aggregations of consumers in this case into groups dedicated to micro-grid exchanges. Micro-grid Management Systems is an automation system that can manage electric as well as thermal systems. The system of choice depends on the size and complexity of the system. Key benefits include: Flexible, expandable base system with a component-based architecture lets consumers expand the system to match growth with metrics and metering lending to incremental upgrade options. Intuitive display and database-creation and maintenance tools provide low cost customization. The Heart Beacon Cycle improves on micro-grid management by adding repeatable metrics and metering as node to node, cell to cell hop count sync deltas for the aggregation, summation and threshold reporting of unused resources with unmet needs displayed to federated arbitrage subscribers as news-casted trade opportunities.

Conceptual Search: IDOL Intelligent Data Operating Layer (IDOL) owned by HP/Autonomy uses patented pattern-matching technology to form a conceptual and contextual understanding of all content, independent of language or format, thereby enabling searches to be performed conceptually. IDOL use a scalable technology that recognizes concepts. Structural perception of data based on local contexts is achieved by first identify a contextual set of a point by finding nearest neighbors. Contextual distance between the point and one of its neighbors is defined by a difference between a contribution to the integrity of geometric structures of a contextual set, which is depicted by a structural descriptor. Euclidean space is a plane and three-dimensional space of Euclidean geometry. Query By Example: Users submit sample data as input and IDOL returns references to conceptually related documents ranked by relevance or contextual distance. Refine By Example: Based on the results of a natural language query, users can quickly refine their search by selecting refined examples to precisely focus on a context they require. Relevance Ranking In evaluating all types of queries, IDOL employs complex algorithms based on a combination of Information Theory and Bayesian methods to automatically weight and rank documents by statistical relevance. Relevance is a measure of a conceptual overlap between a query text and a text in a document. IDOL allows manipulation of relevance of query results in several ways: setting up a field process where users modify IDOL's configuration file, raising the percentage relevance of results according to the number of times that terms in specified fields match the query terms. Uses include: auto classification including: taxonomy creation, clustering of information, automated retention, de-duplication where enforcement is applied using a single set of policies applied across distributed systems. Search technology is key to identifying items or users of interest in a geo-spatial area that may be invited to participate in federated group arbitrage activities using virtual collections of objects, artifacts, users for example. Virtual Collection VC: collection created for a specific purpose by selecting resources from other collections and storing their references with the metadata for this VC. Source HP/Autonomy Structured Generalized Markup Language SGML/Lightweight eXtensible Markup Language or XML. Used to describe entities, groups, teams, agencies using <brackets>. Another option is JSON JavaScript Object Notation cited below as long as a proprietary strategy is converted (gateway) at boundary (125) or interface with other federations. DFDL (Data Format Description Language, pronounced “daffodil”) is a standard for modeling and parsing all kinds of text and binary data. The point being in context with a Heart Beacon Cycle is that the invention does not stipulate specifics of data description as long as conformity is achieved within and among groups Cloud computing Accounting Message Format: key values include: current time, site, machine name, site name, zone name, LocalUserID/Local User Name, LocalGroupId=group name, GlobalUserName. Message includes completion status: started, completed, suspended as epoch times—start time, end time and suspended. Message includes: time zone, duration as actual time used in seconds, milliseconds. Message includes CPU cycles used, network inbound interval and outbound interval, storageRecordID and cloud type. Embodiment use: card carried by runner where the LocalGroupID name is an Organizational ID or ORG ID and resources are URN (s) Metadata descriptions. Metadata describes data unambiguously. four key meta data aspects: <Subject> where subject identifies the entity being measured e.g., network path between a pair of hosts, nodes, routers, servers, switches. <Event Type> identifies exactly what sort of measurement event occurred and is a canonical name of the aspect of the subject being measured, or the actual event (i.e. “characteristic”). <Parameters> parameters describe details of a measurement i.e., exact way a particular measurement was gathered including measurements and meters. Parameters take a form of name, value pairs. <Resource Type> described by Uniform Resource Name URN A uniform resource name. (URN) is a uniform resource identifier (URI) that uses a URN scheme. Both URNs (names) and URLs (locators) are URIs, and a particular URI may be a name and a locator at the same time. A functional requirements for uniform resource names is described in RFC 1737. URNs are part of a larger Internet architecture composed of URNs, uniform resource characteristics (URCs), and uniform resource locators (URLs). Each plays a specific role: URNs are used for identification, URCs for including meta-information. URLs for locating or finding resources. Sample format for the URN: <URN>=“urn:”<NID> <NSS> where <NID> is the namespace identifier, and <NSS> is the namespace-specific string. Phrases enclosed in quotes are required. A leading “urn:” sequence is case-insensitive. A namespace ID determines a syntactic interpretation of a namespace-specific string. Source: American Registry for Internet Numbers

Hierarchy of Network Measurements: two major classes of namespace URIs. First is a canonical name. Second is based on an organization's domain name and allows for autonomous extension in much the same way as an enterprise branch of a name space allows. Embedding of schemas into other systems is encouraged e.g., National Information Exchange Model NIEM payloads or child schemas embedded within OASIS Common Alert Protocol schemas noting that relevant parts of a namespace can be appended to another namespace if one is already in use. Each of schema areas must have a version number. Each of a URI (s) comprising a namespaces end in a version number. <Data> element has an Identifier (Id) and an Identifier Reference (metadataIdRef) refers to “metadata” that describes it. Data descriptions contain “datum” elements. “Datum” elements hold a timestamp and value of the measurement or value of an event. For many network measurement data sources, this can be a time-series of timestamp, value pairs. For other measurement types, a result value may be a vector. Container Elements are contained in two types of outer elements, “Message” and “Store”. Each may have an attribute called “type” to indicate its type. Each may also contain one “parameters” element to indicate message- or store-level parameters and options. This allows for customization in XML namespaces in context with using elements to describe any network measurement with a proviso that exact content of each namespace will vary with a measurement type where reuse of basic element names is used varying the contents of the basic elements for each type of data. In this way, examination of the structure of a message or information store can take place without getting bogged down with details of the contents. Source: Wikipedia

Self Organizing Network SON: involves: planning, configuration, management, optimization and self-configuration and network healing. For example, newly joined, added base stations in s SON are self-configured with a ‘plug-and-play’ paradigm, while all operational base stations regularly self-optimize using algorithmic behavior parameters in response to observed network performance and link/radio conditions. Self-healing mechanisms temporarily compensate for detected equipment outages, while awaiting a more permanent solution. Self-configuration strives towards the ‘plug-and-play’ paradigm in the way that new base stations are automatically configured and integrated into a network. Source: Wikipedia

Self Organizing Maps SOM: self-organizing map (SOM) or self-organizing feature map (SOFM) is a type of artificial neural network that is trained using unsupervised learning to produce a low-dimensional (typically two-dimensional), discretized (sic) representation of input space of training samples, called a map. SOMs are useful for visualizing low-dimensional views of high-dimensional data, akin to multidimensional scaling. Source Wikipedia

Normalized Information Distance (NID): use distances rather than coordinates. Normalized information distance is a universal distance measure for objects of all kinds. It is based on Kolmogorov complexity. NID is a class of distances appropriate for measuring similarity relations between sequences, e.g. one type of similarity per distance and it is universal in that it discovers all computable similarities. It is a metric called a similarity metric. First, compression algorithms can be used to approximate the Kolmogorov complexity if the objects have a string representation. Second, for names and abstract concepts, page count statistics from the web are used. These practical realizations of the normalized information distance can be applied to machine learning tasks, especially clustering, to perform feature and parameter-free data mining. Normalized Compression Distance (NCD) is an approximation to NID, using compressor and is ideally symmetric—ideally from 0 (no similarity) to 1 (identical). A matrix of NCDs constructs builds a tree by minimizing a cost function, the tree can be visualized graphically. Proximity in a tree=</> similar files. A display technique is called a “dendrogram” from Greek dendron “tree”, and gamma “drawing” tree diagram used to illustrate the arrangement of clusters produced by hierarchical clustering where in fine-grained clustering higher levels in a hierarchy are ignored and coarse-grained clustering includes high levels. Data is clustered using Euclidean distance as a distance metric. Euclidean metric is “ordinary” distance between two points that one would measure with a ruler, and is given by Pythagorean formula. By using this formula as distance, Euclidean space (or even any inner product space) becomes a metric space. Metric or distance function is a function which defines a distance between elements of a set. A set with a metric is called a metric space. Source: Wikipedia

Topological space topology: a metric is called metrizable and is homeomorphic—mappings that preserve all topological properties of a given space where the homeomorphism is a continuous stretching and bending of an object into a new shape e.g. coffee cup into a donut. In topology, a branch of mathematics, a first-countable space is a topological space satisfying a “first axiom of countability” condition. In set theory, a cardinality of a continuum is a cardinality or “size” of a set of real numbers called a continuum or infinite cardinal number denoted by R. A real number is a value that represents a quantity along a continuous line. In differential geometry, “metric” is used to refer to a structure defined only on a differentiable manifold that is more properly termed a metric tensor. a metric space is a set where a notion of distance (called a metric) between elements of the set is defined. A metric space corresponding to our intuitive understanding of space is a 3-dimensional Euclidean space. A notion of “metric” is a generalization of the Euclidean metric arising from the four properties of Euclidean distance. A Euclidean metric defines the distance between two points as a length of a straight line segment connecting them. The geometric properties of a space depend on the chosen metric.

Metric space: types of metric spaces: Complete spaces: a space is complete if there are no “points missing” from it (inside or at the boundary). In the context of intervals in a space of real numbers and occasionally regions in a Euclidean space Rn a bounded set is referred to as “a finite interval” or “finite region” such as: compact spaces, Connectedness: a metric space is connected if the only subsets that are both open and closed are an empty set and itself. A metric space is path connected if for any two points there exists a continuous map where every path connected space is connected Locally connected spaces and locally path connected spaces. Simply connected spaces are those that, in a certain sense, do not have “holes”. Separable spaces: a metric space is separable space if it has a countable dense subset. Other examples include: uniformly continuous maps, Quality Threshold Technique, K-means technique. Sequential Leader Technique, Center: normally a vector Average of feature vectors of cluster members use cluster members e.g., all of them or a subset containing those closest to all the others Closest “distance to center” can mean linkage from an edge cluster to cluster located at the radius center. Inter cluster distances=minimum distance (hop) between clusters. Complete distance=maximum distance/total hops. Average linkage is a mean of means. Node Compression Data technique: using data with known categories: 1. Split data into two sets; 2. Build correct clusters with one set; 3. Count data in second set which are closest (lowest linkage) to adjacent cluster NCD Variation Technique: 1 Cluster a subset of data using NCD; 2. Select representatives from each cluster; 3. Feature vector components are distances from datum to representatives;

4. Cluster rest of data without NCD: Euclidean, Manhattan, or some other distance Vectors are used to define boundaries and to determine thresholds in spaces over time involving magnitude (e.g., earthquake) and direction e.g., Tsunami. A vector in mathematics is a quantity possessing both magnitude and direction, represented by an arrow of a direction indicating a direction of the quantity and a length of which is proportional to magnitude.

Scalar vector values i.e. a quantity with an additional requirement that such quantities obey parallelogram law of addition where such quantities transform or change coordinates in a given system. Vectors are used to show direction or course followed by an airplane, missile, convoy or land slide. Vectors from a known, surveyed point are used to establish boundaries where discrete distances are established and predicted by hops at set intervals. Objects within defined boundary areas (e.g., boundary boxes, circles) are classified into interest types that are grouped in this case by belonging to organizations by Organizational Identifiers ORG ID by resource types as described by Uniform Resource Names URN. Change detection within borders are displayed by threshold changes e.g., band 1, 2, 3 in the case of concentric circles or squares and over time by histograms. Objects or entities identified by interest types are typed belonging to specific groups where entities and object data describing them (meta-data) are aggregated into folders awaiting processing by algorithms usually in batch mode by keyword

Meter: An electricity meter or energy meter is a device that measures the amount of electric energy consumed by a residence, business, or an electrically powered device. Electricity meters are typically calibrated in billing units, the most common one being the kilowatt hour [kWh]. Periodic readings of electric meters establishes billing cycles and energy used during a cycle. IEC62056 is a set of standards for Electricity metering—Data exchange for meter reading, tariff and load control—by International Electrotechnical Commission. objects that share common characteristics are generalized as an interface class with a class_id. Instantiations of an interface class are called COSEM objects. A heartbeat procedure is used to monitor all transmission paths

Meter: A device that measures and records the quantity, degree, or rate of something.

Origami paper folding techniques are used to defining unusual or exceptional geo-spatial boundaries where a geometric shape that begins as a square or a rectangle folded to represent virtually any shape or describe any space where the formation of the shapes are mathematically modeled and predictable. Origami designs begin with a square sheet of paper whose sides may be different colors or prints. Origami is defined as “folding of spaces over and upon each other”. Self Organizing Maps and Origami as mathematically modeled and predictable description of spaces are mutually supporting in defining and describing entities within a described space as a cluster or set of group participants as data points upon which to perform computational processes. Source: Wikipedia entry on Self Organizing Maps SOM and Origami <Tag> maps/clusters as a self organizing system: in the main embodiment of the invention, leagues follow textual tag conventions of the National Information Exchange Model where participation is voluntary predicated on use of a minimum high level set of <tag> sets. The National Information Exchange model equates to a league commission where league commission is governed by elected league officials. As in federal and state Government, a Federal Level/League Commission level mandates a table of contents and hierarchical framework of a SOP as a directory of requirements where lower organization levels write chapters below a chapter title and pages containing detailed instructions, processes, procedures. Location involves use of space defined by linear boundaries or three dimensional circular or elliptical areas defined by geometric shapes. Actions in a given location are synchronized to occur within a given time where incremental actions are described by time phased activities. Time frame is defined by start, stop, delay, slow, resume, repeat and bounded by an expected duration or window of validity/window of effectiveness. Movements are described in phases using geo-spatial and temporal references from a known (i.e. surveyed point) such as phase lines and areas as circles or ellipses where pre-defined time intervals are assigned for groups to move from phase line to phase line or area/zone to another pre-defined area/zone. Pre-defined areas of geometric shapes are usually rectangular, hexagonal and circular or elliptical use involves grouping individuals found when searching within and area or space subsequently formed into groups where distinguishing characteristics i.e., individual belongs to team and wears jersey/uniform number n. Once individuals are indentified as part of a group, then group is identified or named using naming conventions involving use of tags with a left bracket and a right bracket forming a pair of tags bounding the defined group for example, <Cardinals> Data Islands/Data Resource Islands: ID attribute of the <XML> element is used to reference data islands. Rows are created for each element tagged with <meeting> tag. Individuals or objects processing is a pre-requisite to group geo-spatial-intensity processing in regard to data intensity and spatio-temporal intensity to address challenges in organizing and administering data content, Geo-dynamics includes intensiveness, data parameter extraction, and a geo-spatial visualization of decision making in a globally distributed and dynamic environment where information includes locality, capacity, volume, quality of data and data visualization using spatio-temporal principles bounded and described by FIG. 1 lower right graphic describing the main embodiment

Dymaxion Map. With an undistorted cartographic projection of the Earth's surface, ability to be easily reconfigured and transform from a 2-D map to a 3-D globe, the Dymaxion Map (patented in 1946 by Buckminster Fuller) shows the earth surface in it's entirety without distortion. The Fuller Projection Map Also know as the “Dymaxion Map,” the Fuller Projection Map is the only flat map of the entire surface of the Earth which reveals our planet as one island in one ocean, without any visually obvious distortion of the relative shapes and sizes of the land areas, and without splitting any continents. Traditional world maps reinforce the elements that separate humanity and fail to highlight the patterns and relationships emerging from the ever evolving and accelerating process of globalization. Instead of serving as “a precise means for seeing the world from the dynamic, cosmic and comprehensive viewpoint,” the maps we use still cause humanity to “appear inherently disassociated, remote, self-interestedly preoccupied with the political concept of its got to be you or me; there is not enough for both.” All flat world map representations of the spherical globe contain some amount of distortion either in shape, area, distance or direction measurements. On the well-known Mercator world map, Greenland appears to be three times its relative globe size and Antarctica appears as a long thin white strip along the bottom edge of the map. Even the popular Robinson Projection, now used in many schools, still contains a large amount of area distortion with Greenland appearing 60 percent larger than its relative globe size. Fuller's view was that given a way to visualize the whole planet with greater accuracy, we humans will be better equipped to address challenges as we face our common future aboard Spaceship Earth. Source: Buckminster Fuller Institute

Geo-spatial intensity computing issues involve metering and metrics parameter extraction in data mining and phenomena simulation. Concurrent-access-intensity is intensive at one time (such as earthquake and tsunami of Japan in March 2011) and light at other times requiring elastically invoking more service instances from multiple locations to respond to usage spikes. Elastic automated provision and releasing of computing resources responds to concurrent access pikes while sharing computing resources for other applications when there were no concurrent access spikes. Spatio-temporal intensive scenario: real-time processing requires an infrastructure that can process real-time data flow and simulate potential link travel times, as well as conduct real-time traffic routing according to predicted link travel time. Computing power (e.g., opportunities in time to perform computational tasks) is shared across geo-spatially defined regions in context with: (1) traffic peak periods varying with time zones; (2) collecting, simulating, and routing area data producing data transferred across regions; (3) routing tasks are related to dynamic traffic network topology and can be data intensive; and (4) routing requests have significant spikes characterized with dynamic, changing request numbers. Spatio-temporal principles involve: (1) enabling the discoverability, accessibility and use of distributed, heterogeneous and massive volumes of data; (2) optimization of cloud computing infrastructure by temporally arranging, selecting and use of computing temporal resources for computing intensive problems; (3) enabling timely response to world-wide distributed and locally clustered users through geo-spatial optimization; and (4) assisting with the design of spatio-temporal data structure, algorithms, to optimize the information workflow to solve complex problems. Source Wikipedia

Self Organizing Directories: distributed directory service enabling nodes to add information to directories, such as mappings of resource names to resource locations, or service information to service providers. System nodes look up information in a directory to find out which host provides a particular service. A difference between a self directory service and traditional directory services, such as Domain Name System DNS and Lightweight Directory Access Protocol LDAP, is that a self organizing directory is decentralized and includes processes where entities and nodes report and list a discovery of each other. Every network host is storing parts of directory structure dynamically assigned to it by other hosts, where information is replicated over several hosts. If a host leaves the network or crashes, information can be retrieved from another host storing the same information. Directories describe a namespace which is a context for entity identifiers. In an operating system, an example of namespace is a directory. Each name in a directory uniquely identifies one file or subdirectory, but one file may have the same name multiple times. Names in a namespace cannot have more than one meaning e.g. different meanings cannot share the same name in a given namespace. A namespace is also called a context, because a (same) name in different namespaces can have different meanings, each one appropriate for its namespace. Names in a namespace can represent objects as well as concepts. Source: Distributed Systems Laboratory Swedish Institute of Computer Science

X.500: wikipedia.org/wiki/X.500 Directory Service: A primary concept of X.500 is that there is a single Directory Information Tree (DIT), a hierarchical organization of entries which are distributed across one or more servers, called Directory System Agents (DSA). An entry consists of a set of attributes, each attribute with one or more values. Each entry has a unique Distinguished Name, formed by combining its Relative Distinguished Name (RDN), one or more attributes of the entry itself, and the RDNs of each of the superior entries up to the root of the DIT. As LDAP implements a very similar data model to that of X.500, there is further description of the data model LDAP. Refer to this entry in context with FIG. 1 item 107 Reporting forming a self organizing structure: players as a rule; do not make team reports until a player or players join a team. When players join a team they agree to league reporting conventions that are defined in greater detail in a league SOP. Players, for example, agree to help gather information/data and report statistics, events and alerts by making pencil entries to 3×5 cards kept in a uniform pocket. Use of reporting as a self organization structure within a systems of systems framework is accomplished by reporting state meta-data snapshots gathered during a micro-cycle running concurrently and supporting a longer, greater duration macro-cycle (cycles are variable depending upon the use case) which are synchronized as a heartbeat timed cycle within a leader's decision/planning cycle where cumulative sync delta changes/state meta-data snapshots/heartbeat messages (terms are synonyms and interchangeable) are merged into sync delta change reports also known as heartbeat messages. Heartbeat message use is found in stock exchange, military situational awareness, First Response e9-1-1 standards maintained by the National Emergency Numbering Association NENA to name a few heartbeat message uses Restated for clarity, affiliation causes reporting of activities, events, and activities forming a self describing structure within an iterative cycle within a cycle where reports were previously non-existent. Reporting relates to monitoring and event management. A process of gathering sync delta snapshots is iterative. In context with a Heart Beacon Cycle, sync delta reports are displayed onto appliqué geo-spatial overlays by the process of filtering data element key words filtering on time stamp secondary keys tagged by organization (primary key) and resource type (ORG ID, URN) prior to data fusion center insertion in a pre-determined temporal micro-cycle running concurrently and supporting a longer macro-cycle reporting period. In other words, devices, platforms, computational devices report state meta-data changes in micro-cycles where reporting is only limited in terms of frequency/sampling rate by available TCP/IP frames as time slots. In the main embodiment, macro-cycles represent longer reporting periods corresponding to innings and game length for example, as 5, 10, 15 and longer periods vice TCP/IP milliseconds characteristic of a micro-cycle. Micro-cycles run within macro-cycles Individual or single instances of actors and objects or resources are monitored since individual entities, objects, or instances are required to form groups. Monitoring the state of individuals, entities, devices, and resources forming groups when formed into for example, network mesh-fabric clusters is performed since loss of individuals within clusters represents a threshold condition state change where the group may no longer fit the definition of a group. Area searches for desired traits e.g., rare items, thresholds of items not met or drops below a specific count identify individuals, entities, or artifacts. Searches identify opportunities to pursue collaborative, cooperative, time sensitive ventures where search on rare items as an example is then followed by invitations to join federated groups. Group structures are changed as sub-divisions (split, divide) to adapt and adjust to activities or event changes in status requiring group mobility adjustments e.g., move to avoid hazard. Adjustments to sub-divisions of the group are made where groups are split, joined, moved, added, dropped from the main group in the main embodiment based on leader's intent and managerial approach/leadership style. Decisions from leaders result in corresponding changes in hierarchical relationships among sub-groups and main group where associations of higher to lower, left to right, supporting to supported (derived from military operations) are changed then are advertised/broadcasted/news casted maintaining linkage of sub-organizations in in network directory relationships maintain directory relationships/links/paths/routes. See X.500 for detailed treatise on directory services. Unified Modeling Language (UML) is used to specify, visualize, modify, construct and document artifacts of an object-oriented software-intensive system. UML provides a standard means to visualize a system's architectural blueprints, including elements such as: activities, actors, business processes, database schemas, (logical) components, programming language statements, reusable software components. UML combines techniques from data modeling (entity relationship diagrams), business modeling (work flows), object modeling, and component modeling. It is used with all processes, throughout the software development life cycle across different implementation technologies See Wikipedia entry

State_(computer_science): In computer science and automata theory, a state is a unique configuration of information in a program or machine. It is a concept that occasionally extends into some forms of systems programming such as lexers and parsers. Whether (the) automaton in question is a finite state machine, a pushdown automaton or a full-fledged Turing machine, a state is a particular set of instructions executed in response to a machine's input. State can be thought of as analogous to a practical computer's main memory. Behavior of a system is a function of a definition of the automaton, the input, and current state. Types of states: compatible states are states in a state machine that do not conflict for any input values. Thus for every input, both states must have the same output, and both states must have the same successor (or unspecified successors), or both must not change. Compatible states are redundant, if occurring in the same state machine. Distinguishable states are states in a state machine that have at least one input sequence causing different output sequences—no matter which state is the initial state. Equivalent states are states in a state machine which, for every possible input sequence, the same output sequence will be produced—no matter which state is the initial state. An information system or protocol that relies upon state is said to be stateful. One that does not is said to be stateless. For example, there are stateless firewalls and stateless servers, and HTTP is considered a stateless protocol. A character encoding such as ISO 2022 is said to be stateful, if the interpretation of a particular code value depends on the code values that came before it. See also: Finite state machine (FSM), Mode (computer interface), Program state state diagram. State space (dynamical system). Source: Wikipedia entry for State

Self-Organizing Systems-of-Systems: are characterized by intelligent, multi-agent, self-organizing with swarm intelligence, tight learning loops, fast evolution, and dedicated intent e.g. working towards common goals. In this embodiment, groups are joined into federated uniquely identified groups where individual entities changes as part of group or team activities are monitored to assess change as part of a system of systems. Self-organizing characteristics:
Common purpose—the primitive needs that motivate actions
Conditional dependency—dependency driven through interconnectivity of participants
Situation awareness—perception, correlation, projection usually in a geo-spatial zone
Adaptability—readily capable to adjust e.g., cloud computing elasticity
Autonomy—ability to make independent decisions when affiliated in a group
Whole-part relationship—belonging to something bigger, sum of parts greater than whole Systems-of-Systems definition: a set or arrangement of systems that results from independent systems integrated into a larger system that delivers unique capabilities where systems with independent purpose are federated with other systems with complimentary capabilities in achieving higher-level objective(s) where new relationships (organizational/structural) are formed into a self organizing structure where unique behavior emerges in the federated group Example of a System of System: Swarm Discovery and Cooperation: context: one or more objects of interest must be located in a sparse environment, and the mission objective cannot be accomplished effectively by any one individual. Problem: Locate objects in a sparse environment and perform some cooperative operation on them (e.g. transport or disarm). Forces: time pressure to accomplish mission vs. cost of multiple resources and time pressure to find an object vs. search area size. Risk of search-agent loss verses cost of redundancy. Solution: randomly deploy a large number of simple agents across the target space. Each agent searches for the object of interest, which can be detected using individual sensors. Once found, a discovering agent notifies others to assist in actions on a target. Examples: mine detection, multi-agent search and transport, search and rescue, and foraging ants. System of Systems as a self organizing structure summary: Six necessary characteristics for self-organization: common purpose, conditional dependency, situation awareness, adaptability, autonomy, whole-part relationship. Candidate patterns: crowd sourced incident reporting, swarm discovery and cooperation and collaborative, and distributed learning. Source: Wikipedia

Status: a semantic meaning of status is site dependent. Status property must contain data of type string. Status property must exist. Status property must support as a minimum, values: aborted, a policy or human intervention causes a job to cease execution, completed, failed—execution halted without external intervention, held—execution is held at (t) time as usage record was generated, queued—execution was queued at (t) time this usage record was generated, started—execution started at (t) time this usage record was generated, and suspended—execution was suspended at (t) time this usage record was generated. Status includes: service status resource monitoring, resource performance estimation and selection, resource discovery and reservation, resource setup and service activation, alteration and reversion of the user access to a cloud service, and releasing resources, and inter-cloud, team, league resource management Service status represents the completion status of jobs/processes/and entry/exit status of an interactive running process or the exit status from the batch queuing system's accounting record

Example procedural template: Source: Stanford Research Institute's Linear Accelerator SLAC:

Table of Contents:

| | |
|---|---|
| 1. | Introduction 3 |
| 1.1 | Purpose 3 |
| 1.2 | Scope 3 |
| 1.3 | Roles 3 |
| 1.4 | Definitions and Acronyms 3 |
| 1.5 | References 3 |
| 1.5.1 | Traceability 3 |
| 1.5.2 | Policies 3 |
| 1.5.3 | Standards 4 |
| 1.5.4 | Processes 4 |
| 1.5.5 | Procedures 4 |
| 1.5.6 | Guidelines 4 |
| 1.5.7 | Templates 4 |
| 1.5.8 | Checklists 4 |
| 1.5.9 | Training 4 |
| 1.5.10 | Tools 4 |
| 1.6 | Profiles 4 |
| 2. | Procedure (Steps) 5 |
| 2.1 | Begin a list of steps beginning at the number one 5 |
| 2.2 | Begin a list of steps that restart at the number one 5 |
| 3. | Process/Procedure (Mapping)6 |
| 3.1 | Entry Criteria 6 |
| 3.2 | Process/Procedure Map 6 |
| 3.3 | Inputs 6 |
| 3.4 | Activities 6 |
| 3.5 | Outputs 7 |
| 3.6 | Verification and Validation 7 |
| 3.7 | Exit Criteria 7 |
| 3.8 | Metrics 8 |
| 3.9 | Records Control Table 8 |
| 3.10 | Controlled Documents Table 8 |

Appendix A - Dictionary of Terms 9
Appendix B - Acronyms 10
Appendix C - Flowcharting Symbols 11
Appendix D - Bibliography 12
Appendix E - Document Change Control 13

Procedural Template usage in context with this application: Procedural template entries at most, includes a line or two. In depth technical treatise (s) citing every conceivable nuance is impractical, counterproductive and out of scope of a procedural template. For example, in a little league baseball tournament embodiment, teams are expected to understand the conventions of baseball tournaments prior to play—e.g., actors, observers should know a priori who the main actors are in a baseball tournament. Internet reliant embodiments, participants in a federation must be familiar with for example, directory service, Unified Markup Language UML, eXtensible Markup Language (XML), TCP/IP internet protocol. Procedural template entries are to be considered a priori to avoid lengthy debate that is counter purpose, counter productive deterrents to group federation and cooperative activities. Procedural templates are use case specific in that a different embodiment with a different environment in a different domain such as educational, first response, stock market trade arbitrage would not be exactly the same yet underlying procedures and self organizing structures are similar in terms of being comprised of the basic entries as (technical) building blocks/components in a framework and are inclusive prerequisites and preconditions to forming a Heart Beacon Cycle. Procedural templates cite one to two line entries as a table of contents and include a paragraph or two at most to provide a high level summary or gist of the required component. Procedural template entries are pointers and references and are referential to a Treatise (s): a treatise is a formal and systematic written discourse on some subject, generally longer and treating it in greater depth than an essay, and more concerned with investigating or exposing the principles of the subject. For example, the Open Group Architectural Framework TOGAF has views which may be specified as either a “formal description of a system, or a detailed plan of the system at component level to guide its implementation”, or as “the structure of components, their interrelationships, and the principles and guidelines governing their design and evolution over time.” In context with the Heart Beacon Cycle, the idea is to start from a known working system to derive a procedural template to guide groups in best effort, best practices following a reference architecture that serves to provide pointers to more detailed treatises in the area of use of situational understanding among groups. A Heart Beacon Cycle procedural template is comprised of a high level table of contents requirements level and at most, a paragraph or two. The standards in SOP (137) may include instructions relating to detailed procedures and processes desired or unique to a community of interest or a community of practice located in appendixes or annexes, footnotes or in a fine print note for completeness. The SOP cites major building block components required to be present or available, the procedures and process templates that need/are required to be available, but not (the) exact code or intricate instructions of the procedures and processes. Procedural templates are made up of processes used to form self organizing structures within groups use directories to find other groups by using maps to find resources, and locations where a self organizing structure is created by defining previously non-existing structure. Procedural templates form self organizing structures involving maps, directories, and reports where reporting occurs in a local, micro-cycle running concurrently and within and supportive of a macro—non local temporal cycle associated with higher organization echelons. Operations once adopted as standard are listed into standard operational procedures (SOP) reference used as a guide where entries are used as references and pointers to detailed treatises. Note: many entries in the procedural template are not claimed as novel or unique, therefore, detailed description of functions for example, directory services (107) is out of scope of this application. Both unique and novel entries e.g., time stamping state meta-data prior to data fusion center insertion, Paul Revere/Water Drop in Pond geo-spatial-temporal memes and common, standard, a priori entries i.e., directory, map, network, system of system are needed in a Heart Beacon Cycle Heart Beacon Cycle applications include forming structure by following a procedural method by time stamping data and typing it by organizational identifiers, unified resource names (Org ID/URN) prior to data fusion center reporting resulting in structure that previously did not exist (self organizing structure leveraging synchronized, reliable reporting) to unstructured data collection, processing, and analysis. Forming a Heart Beacon Cycle involves viewing of time tagged and organizationally identified data into a aggregate, filtered and fused view as an appliqué overlay or as a mosaic drawn from n similar systems. Use of Heart Beacon Cycle methods will assist and improve unstructured data capture, dynamic analytical rendering, analysis, and actuarial-modeling systems to enable regulated financial institutions to assess asymmetric economic risks.

Novelty is achieved through use of common building blocks organized into a procedural template framework listing processes, procedures, components as pointers to more detailed treatises as guides fore example to form individual, objects, resources, things into federated groups synchronized in time-space by unique Paul Revere, water drop in pond meme geo-spatial temporal intensity measures and metrics to engage in for example equitable trade arbitrage among a system of systems shown Russian nesting doll style filtering data onto appliqué views.

The main embodiment's little league baseball tournament meme is used for universal recognition.

Systemic. Systemic refers to something that is spread throughout, system-wide, affecting a group or system such as a body, economy, market or society as a whole.

### BRIEF DESCRIPTION OF THE DRAWINGS

FIG. 1: A Heart Beacon Cycle is a description of forming groups into a collaborative federation of players into teams, teams into leagues under a league commission organizing in time (heartbeat interval described) and space for example, playing fields to accomplish common goals and purposes e.g., conduct a little league baseball game tournament

FIG. 2: Heart Beacon Cycle Legend describing components relating to FIG. 1

FIG. 3: Building Blocks. FIG. 3 is an updated graphic describing the four main building blocks comprising the Heart Beacon Cycle: TCP/IP Heartbeat as building block I, procedural template (s) as building block two, Paul Revere beacon technology meme as building block 3, and the water drop in pond beacon technology meme as building block 4.

FIG. 4: Building Blocks/Template System: this figure cites the building blocks of the template system that prior continuations: Ser. No. 11,601,035 Method to enable the heartbeat beacon for homeland security and homeland defense interoperability filed Nov. 17, 2006 as a continuation to: Ser. No. 10/709,358 Method to enable Heartbeat e9-1-1 filed Apr. 29, 2004 as a continuation to: Ser. No. 10,708,000 shown on the top most swim lane of FIG. 4 (FIG. 4, numbers 301, 302, 303) compared with building blocks of a system agnostic, generic template used in the most recent of continuation applications and this application (FIG. 4, numbers 310-317).

FIG. 5: Procedural Template from prior continuation application. FIG. 5 is a graphic brought forward from previous continuation applications showing that the applicant used the concept of a continuation on which to build on a common theme variation where the sum of the parts comprise the whole in a Russian nesting doll concept described in embodiment one. Ser. No. 10/605,144 Method to Commercialize Structured Military Messaging is upper left (402), Ser. No. 10/708,000 Method to Enable a Homeland Security Heartbeat is lower left, and Ser. No. 10/709,358 Method to enable Heartbeat e9-1-1 are shown integrating and complimenting each other. This application unifies all continuation applications based on common building blocks/procedures used previously.

FIG. 6: Heart Beacon Cycle Big Picture. This figure was used in previous applications to show a sample environment for a sample, generic embodiment to describe the invention's functions

FIG. 7: Severity Metrics Precedence Template: is another graphic reused from prior continuation applications showing the concept of precedence in context with the innovative use of Paul Revere and Water Drop in Pond memes to represent changes in thresholds

FIG. 8: Metrics and Metering. This graphic shows a concept to meter and form metrics using hop count techniques that are current standards in industry with the invention's innovative use of Paul Revere and Water Drop in Pond beacon broadcast, newscast memes to depict change

### DETAILED DESCRIPTION OF AN ILLUSTRATIVE EMBODIMENT

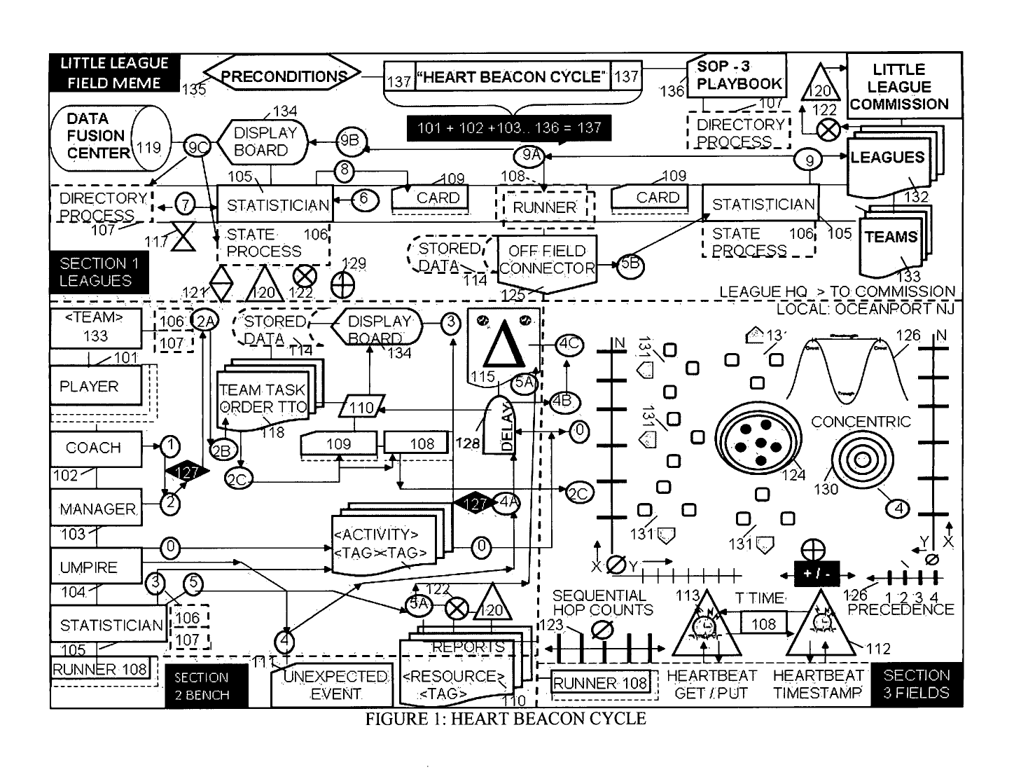

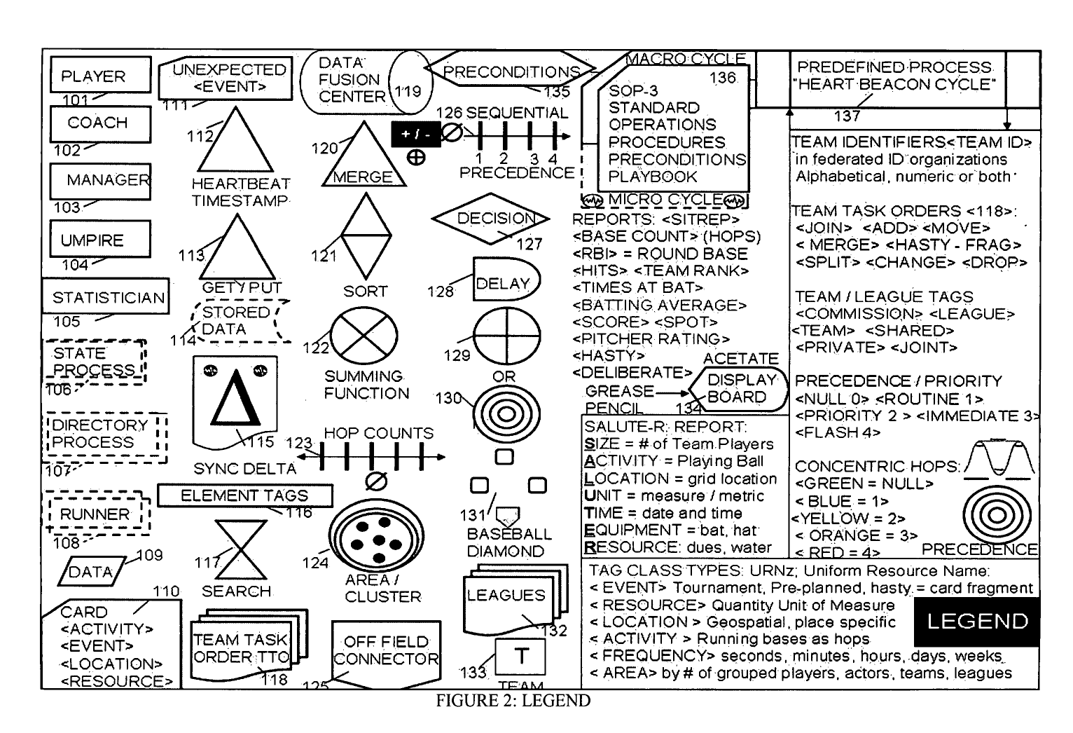

FIGS. 1 and 2 are used to describe the main embodiment in a non-networked environment. Forming a Heart Beacon Cycle is a best effort, best practice method and means using nested self organizing, mutually reinforcing structures i.e., reports, maps, directories, network, into a systems of systems framework which in turn is self organizing and self forming. This framework in the aggregate is characterized as a high level guide and set of pointers to detailed treatises represented and formed as a Standard, Operating Procedural SOP. This SOP is comprised of process templates, preconditions and prerequisites. A SOP as a framework that helps guide individual and group participation in federated group collaborative, location specific activities, events, and resource sharing. Groups are synchronized in time and space correlating to events, and activities, and resource sharing i.e., equitably metered arbitrage where group activities and abilities are advertised by newscasts based on precedence (rare item, threshold exceeded). Items 101-134 culminate as a list of preconditions (135) contained within team, league SOP (s) (136) when signed form a teaming agreement. Items 101-136 must be present and agreed upon prior to initializing a Heart Beacon Cycle (137). IOW rule book (135) limits what committees can be formed and their powers described by roles/actors i.e., coach, manager.

The SOP lists the minimum SOP component parts as a procedural template and a model and as a guide providing links, pointers, references to more detailed standards or technical treatises. The league SOP cites the required components functions and the schedule of use for example, but does not instruct precisely how to use the components in every possible instance or permutation for this is not practical and is a barrier or deterrent to individuals joining teams and teams joining joining leagues. The SOP aids and guides group federation into collaborative teaming arrangements. The Standard Operational Procedure SOP is comprised of a table of contents with single or at most double line entries with enumerated descriptions of components as building blocks (i.e. process that checks state/state process checker, directory services process) used in common procedures predicated on a baseball tournament. The intent of this concept as described in the main embodiment is not to reinvent the game of baseball, rather, to examine it as a well known reference and meme for main components and processes used as best practice, best effort collection of procedures. The SOP is a rough outline written by league members.

For example, the invention cites a sub-set collection of cards as a reference to tags and data that describe tags and data (meta data) carried by the actors in a cargo or uniform pocket as a quick reference for directory listings and statistical card tags and tagging convention. The invention cites the players, teams, and leagues as leafs, branches, and forests described as directory listings where players are described by rosters on teams in leagues described by lists. This convention of carrying a sub-set partial collection of cards in a pocket or cargo pouch on the person or person's participating as actors on teams, the self forming model helps efficiently form and maintains referential data/information intrinsic to self forming reporting aspect that in turn supports the self organization of maps, directories in the overall system of systems framework. This example is included as an example of a paragraph in the SOP describing the level of detail that at most will be included given the nature and spirit of applying an SOP as a guide/pointer to treatises.

Legend for FIG. 1: Environment: manual non-internet Little League baseball team tournament where 5 to n ball fields are shared in geo-spatial and temporal proximity. Players have pedometers with clocks. Actors e.g., items 101-109 are in accordance with IAW Unified Modeling Language UML conventions which clarify actors, actors roles The game of baseball is used as a source for common language memes for computer science functions.

Given this is a high level framework/template, treatises on baseball or computer science functions/procedures/standards are out of scope. Detail is general at the league/federation level and becomes more specific and granular at the lower levels of the league/organization Players (101) report (observe), record <tags> on 3×5 index cards (109, 110). Cards that actors (UML convention) as players carry is a form with blanks, e.g., date, place, game number, team roster, location of team, etc. Players affiliate with team, position assignment. Player may fill many <positions>, must meet preconditions: (135) <size> <height> and <weight>, sign SOP Coach (102): is a decider, strategic planner, decision maker and play/plan chooser. Coach has playbook corresponding to internet embodiment computation procedures (136) of strategies which he (s) selects from based on his assessment of this team's talents and skill level (which team members execute a bunt, hit long, throw long, steal, or slide). Coach's instructions indicate intent and choices selected that may be pre-ordered/pre-planned or hasty corresponding to either scripted plays or real time, spontaneous instructions of player change management

Manager (103) is a task and mission manager who executes team substitutions, local and short term organizational decisions using Team Task Order TTO (118). Performs adhoc substitution of players, (101) teams (133) to and from leagues (132) described by league directory rosters (107) as adhoc tactical substitution decisions (127). Managers refer to cards storing available teams in hierarchical organizational structure IAW directory service listing standards forming a method to annotate affiliation options as pick lists of player, team, league <joins>, <adds>, <moves>, <merge>, <split>, <change>, <drops> during (player) change management operations

Umpire (104): field of play controller and arbiter over league resource use, rule checker and league judge who authorizes, monitors SOP (136) conditions, agreements, and clauses ensuring game integrity and league security. Umpire interrupts game play to issue instructions by signaling to the team using hand gestures, whistle, voice instructions when play starts, stops, or resumes. Umpire decides on duress conditions involving overall conditions affecting health, security and state of play status and may reverse precedence (126) where duress, hasty instructions/conditions are given card passing priority. Monitoring may be real time by direct observation or delayed dependent on time needed for card delivery and processing. As in the game of baseball, umpire is expected to use his judgment and experience to make expeditious calls based on real time observations as a first course of action relying on non-real time card processing e.g., instant replay on an as needed basis. Umpire's hasty instructions are free text alerts and warnings of hazardous conditions <severe weather>, <earthquake>, <flood> where text tags are encouraged but not required for speed and brevity. Umpires preside over play, activities, events in context with making rulings. Umpires may give precedence over which version of a play observation made by Umpire's assistants (field judges) is upheld e.g., that of the runner's version of the newsworthy item if the runner's version conflicts with the field judges/Umpire's or other actor's versions. The umpire's ruling may be flagged by a coach for league/commission review. Umpire acts as an impartial 3^{rd} party observer for the league and watches for actor, player infractions that he reports to the league and local actors to take action per SOP

Statistician: (105) teams have statisticians (105), assistant statisticians who perform statistical and directory procedures for example, state management change processes (106) where output of the state process checker is in the form of reports described in the SOP. Statistician operates and maintains a master scheduler function and acts as the master time keeper, process and data processing batch and job admission scheduler. Statistician is responsible for maintaining records i.e., the “CRUD” of actors, entities, artifacts—creation, replacement, update, and deletion. Statistician maintains card record repository storing and is responsible for recording results of statistical processes. State processes (106) are computational activities such as summing, sorting, merging performed as part of use case dependent, domain and environment specific activities related to maintain card collections. Statistician conducts state processing activities for example, arithmetic, mathematical processes i.e., integer change checking for state threshold changes from one heartbeat micro-cycle to the next. For example, statistician checks, records actions/events for changes in state as part of a process examining changes occurring during heartbeat cycles (112) by examining data on cards at the end of n heartbeat micro-cycles that have accumulated during a macro-cycle. Statistician, for example, searches (117) cards and sorts (121) by (time stamp as secondary key/ORG ID as primary key), merges (120) and sums (122) card data into reports and statistics displayed (134) on acetate appliqué sheets with a grease pencil. Statistician's use state process checking procedures to inspect cards for micro-cycle heartbeat time stamp (s) (112) and heartbeat data get/put of tags (113) since last micro-cycle card exchange. There are many types of state process checking procedures. As an example, duplicative data is removed by checking the unique time stamp/ORG ID/URN combination for all tags before the cards are entered into data fusion center (s) (119). Output of state process checker process is collected by state manage process, from lower to higher, left to right and supported to supporting (convention of directory tree) following SOP guidelines. Statistician (105) maintains card clearing house—inbox, outbox. Inbox/outbox stores as temporary card stores. Cards are collected, collated, and processed to make or form reports. A statistician as a rule, prepares most of the reports. Other actors may assist the statistician as necessary or desired. Permanent stores are maintained off field (file cabinets and strong boxes) in secure facilities (119). Statisticians may have assistants maintaining multiple instances of directory (106) and state checker processes (107) for example, helping statistician (s) scan cards for <tag> changes. Micro-cycle <tag> changes are merged into a composite sync delta report (115) which are delivered through off field connector (125) to league statistician (s) that merge team sync delta reports into macro-cycle cumulative league report (s). Macro-cycle reports are interchanged between leagues over a wide area using sync delta message/card (s). Inning runs is an example of micro-cycle statistics. Posting which team won the game is an example of a macro-cycle change in a sync delta report. Micro and macro cycle state change reporting runs concurrently and are mutually reinforcing processes. See related arts section entry on state relating to computer science as a pointer to detailed treatises. State management/state checking is pre-requisite but not claimed as novel except that invention stipulates time stamping and identifying state meta data by organizational ID and Uniform Resource Name URN prior to data center insertion. See related art section state change entry as a pointer to a detailed treatise. Listing of all possible permutations in a use case or use cases is out of scope of this template

Directory process (107): directory file folder process manager. Index card packs are used as partial, portable directory listing and referral look-up to find team names and data tags that describe other data (meta-data). League Commission is the top authoritative entry or root, or base comprising a Directory Information Tree DIT where the tree is upside down with the root at the top and leaves at the bottom or ground level using a tree meme. The DIT is described by forests as leagues, teams as trees with actors as branches and players, runners and equipment as leaves. DITS are maintained by directory processor (s). Actors carry a DIT subset in card sets as part of the uniform (in a uniform pocket). Directory services list league resources in catalogs to aid discovery by teams and players. Data describing data (meta-data) is organized into schemas describing services aiding lookup and discovery. For example, if a sync delta report (115) involves moving team from team to league, then the sync delta card describes changes to the hierarchical directory card structure where directory changes over a wide area (125) are made to DIT (s) (Directory Information Tree) maintaining a league's namespace description library of links, paths, and shared objects, actors. See related art section directory services entry as a pointer to detailed treatises e.g., X.500 and LDAP and ARIN ORG ID and URN descriptions for detailed treatises. Directory services must be present. Directory services treatise is out of scope Runner (108) acts as news announcer/beacon and 3×5 card transfer agent (Messenger with messages). Runner gathers data (gets) and delivers data (puts) (113) annotating data on cards Data is synchronized and correlated with heartbeat micro-cycle timestamp intervals. Boundary lines indicate routes that runners as a rule, follow. Boundary lines indicate a bus or cart route that runners follow when using vehicles. Runner cards/messages carry cards with <tag> annotations that describe events, activities, resource usage etc. in context with time and space (area i.e., near surveyor's mark under home plate where home plate and bases are analogous to network nodes in computer science). Areas within boundary lanes may be further defined using surveying techniques where the area is described by drawing lines from a known point as a radius in concentric circles (130) or concentric squares. Area between boundary lines defining areas is performed by surveying techniques usually and as a rule as hexagon cells or squares and/or rectangles. Runners are the primary reporters of newsworthy data changes although any actor/team member may report newsworthy information during their assigned heartbeat interval defined time slot i.e., n milliseconds, 5, 10, 15 minutes. Runners carry cards: store tags, time and ORG ID (organization) keys. Tags can be nested procedures (109). Tags are written onto 3×5 cards in pencil with erasers. Actors carry a subset of cards where entry fields refer to global SOP rules, conventions and a section of a card set refers, maps to specific actor's roles. Card sets are updated for changes at the end of each macro-cycle. Card updates during macro-cycles involve directory card (107) updates (analogous to database and directory server refreshes). Card delivery are analogous to state meta data refresh/updates (106) that are handed from player to runner, runner to team actors—usually the statisticians. Actor cards are differentiated by role pre-assigned during team and league affiliation. Duplicative card reports made by more than one actor reporting the same event/activity is handled referencing the heartbeat timestamp to determine the authoritative report for example on a First In, First Out FIFO basis based on league SOP. This process addresses a claim when more than one similar system is generating reports or situational awareness reports simultaneously necessitating event/activity filtering using time stamp and organizational ID tagging performed prior to data fusion center insertion as a method and means to arrive at a single, consistent common report in a single, authoritative view of the activity/event in a appliqué visual overlay view (s). Card Types (110): Cards are memes for messages, database replication, and file folder synchronization artifacts. For brevity and clarity, four categories are needed as a minimum: <activity> <event> <location> <resource>. In general, cards are collected, collated, and merged during micro-cycles into macro-cycle reports. Other card types or report types may be adopted as deemed necessary. SOP describes generic reports as a general guide. Card reports are: SPOT Size, Position, Observation, Time; SALUTE-R: Size, Activity, Location, Unit, Time, Equipment, and Resources. SPOT, SALUTE cards when merged (120) become a Situation Report SITREP. SALUTE. Use of SPOT/SALUTE is discretionary based on Coach preferences/instructions. Example: when a coach or manager asks for a SITREP, he may ask one runner or actor or multiple runners and actors. SPOT and SALUTE reports are hasty. SITREP reports are deliberate and tend to be a merge or roll-up of multiple SPOT and/or SALUTE reports. SALUTE: Size, Activity, Location, Time, and Equipment is a more involved version of the SPOT given an equipment category. If a SITREP report is requested, then a summary and merging of SPOTS and/or the longer SALUTE reports are used to form the SITREP. A subset collection of cards is used as a reference to tags and data describing tags and data (meta data) carried by the actors in a cargo or uniform pocket as a quick reference for directory listings and statistical card tags and tagging convention. Actors carry a sub-set partial collection of cards in a pocket or cargo pouch on the person or person's participating as actors on teams, the self forming model helps efficiently form and maintains referential data/information intrinsic to reports and reporting as a self forming method that in turn supports the self organization of maps, directories, networks in the overall procedural template system of systems framework. The exact number and type of cards and how the cards are segmented into sections for specific data and a detailed description of the workflow of cards is use case specific and requires a detailed treatise on reporting and data replication that is beyond the scope of this high level procedural template See also Army Field Manual 101-5 Staff Organizations and Operations for detailed treatise describing staff reports and procedures relative to organizing and supporting operations. See also FM 101-5-2 U.S. Army Report and Message Formats for detailed treatises on OPORD, UTO

Unexpected Event: (111) “act of God” such as severe weather, earthquakes or flood or a sudden, hasty, non-predefined process or operation that disrupts, delays or cancels activities, events

Heartbeat Time Stamp (112): data card collection is time stamped (112) referenced to player's and team member's pedometers. A heartbeat timestamp interval is sequential, occurs at regular and reliable intervals in time and is characteristic of and occurs within micro-cycles. A heartbeat time stamp (112) forms a temporal boundary as a heartbeat is a computing science meme for an opportunity in time to do/not do a computational task in this case, a heartbeat get data/put data (get/put) (113) where instructions are read from cards during a assigned time slot. For example, a player, on receiving instructions from a runner delivering a card, executes the first available instruction bounded and time framed by a heartbeat time stamp (112) and ignores duplicative instructions as stipulated in detailed team treatises which are outside the scope of this procedural template as a guideline. A convention involving heartbeat time stamps (112) to define and delineate time frames by start, stop, delay, slow, resume, repeat and bounded by an expected duration or window of validity/window of effectiveness. For example, movements are described in phases using geo-spatial and temporal references from a known (i.e. surveyed point) such as phase lines and areas as circles or ellipses where pre-defined by heartbeat time intervals are assigned for groups to move from phase line to phase line or area/zone to another pre-defined area/zone. This is referential to Army FM 101-5: The Army's Field Manual for Operations and Mission planning. See also applicant's prior continuation applications as prior art for a more detailed description of military derived template procedures.

Heartbeat (data) Get/Put (113): data gathering, placement function into temporary data stores (114) where a data transfer “gets/puts” are synchronized temporally (in time) by heartbeat time stamps (112) as a method to place/insert start/stop instructions precisely and synchronously to (computational) tasks with a bounded and finite Time to Live (TTL). TTL/Time To Traverse i.e. advancing home base to first, second, third and back to home base is one TTL/TTT interval. Both 112 and 113 relate to intervals in time. A TCP/IP heartbeat is the only internet function that actually places (puts) and retrieves (gets) data. For example, <bunt> instruction contains <name> <Wrigley Field> <location> home plate <surveyor mark>. See TCP/IP heartbeat and heartbeat messages treatises. All methods i.e., bots, motes, agents, algorithms etc. rely on the heartbeat Stored Data (114): inbox/outbox. Cards form short term data storage structures. For example, cards are picked up, delivered to-from inbox and outboxes on the statistician's table. Longer term card/data storage is related to the data fusion center (119). Stored data (stores) (114) temporarily contain stored data (114) e.g., inbox/outboxes maintained and related to actor type statistician who temporarily stores (holds/keeps) cards delivered by runners. Data stores operate on micro-cycles locally until a macro-cycle defined transfer process occurs. For example, cards are transferred to data fusion center (119) via the off-field connector (105) during league's macro-cycle/unless/OR there is an exception or duress condition superseding the macro-cycle delivery schedule, Then, league/organization duress procedures supercede and take precedence

Sync Delta (115): Sync delta report (115) is associated with a statistician. Statistician uses a Heartbeat Administration Interface for example SCOP) is used to perform tasks for example, game schedule (interface) management i.e., setting initial configuration, game start, stop, game processes initialization and management services. Statistician edits card configuration e.g., tables, fields, <tag> elements in cards as heartbeat messages. SCOP enables view/edit configuration files e.g., heartbeat message as state management snapshots, take a (master scheduling) server online/offline, add/remove data to/from reports, etc. A report is created when cards are sorted (121), merged (120) into a composite report that summarizes changes in state meta data that are made within micro-cycles which are then used to update data in longer duration macro-cycles. For example, in directory service art, statistical data is described within a directory's hierarchical structure as meta-data tags belong to actor's roles and the actor's assigned processes. Sync Delta (115) reports describe data checked for changes from heartbeat time stamp 1 to heartbeat time stamp 2 to n (112) compiled into composite sync delta reports as interval in time “heartbeat snapshots” also known as state meta-data snapshots also known as heartbeat messages as cited in various commercial domains. Snapshots are data refresh summaries between two discrete, heartbeat time stamped, bounded intervals in time. For example, if a sync delta report (115) involves moving a team or squad, from one team to another, then a sync delta report describes changes in the hierarchical directory service annotations on 3×5 cards. A sync delta report/state meta-data snapshot/heartbeat message is a method that synchronizes state data changes from micro to macro cycles, from lower to higher, left to right, adjacent organizations as a self organizing structure where meta data describes actors/players as leafs, teams as branches, and leagues as trees and leagues in commissions as forests where leagues agree to exchange changes to directory structure as SOP described or referenced in SOP. See X.500 directory services treatises for a more detailed description of directory service art

Element types (116): describes data elements as tags in terms of <private element>, <domains>, <shared element>, <community>, <joint> and <global> where elements are related to an integer 0, 1, 2, 3, 4, 5, n where element types are variable by tag type and by numeric mapping that may be positive or negative as long as they are cited as standard in the SOP (136)

See the Office of the Secretary of Defense OSD STRATML IODEF RID classes cited briefly in the related arts section that serves as a pointer to OSD's more detailed treatise on element tagging for organization management over a wide area involving disparate domains. Elements assignment by organizations and specific resource identifiers is use case specific and varies between organizations. A Heart Beacon Cycle will stipulate main class categories leaving nuances and details to the specific use cases as a pointer to detailed treatises

Search: 117: teams are scanned for actor/player tag types and primary, secondary etc. key tag categories searching for elements and tags grouped by categories, elements and types. When items exceed or fall below set thresholds (league/group/organizations set specific threshold levels) reported during status updates that occur in micro-cycles which are later summarized during macro-cycle recapitulation processes where summaries are filtered, for example, for a rare item discovery or a key threshold exceeded as an item of potential subscriber interest where subscribers receive newscast broadcasts using multiple beacon techniques or technology notifications announcing windows of opportunity to collaboratively participate in event follow up as trade/arbitrage activities by league/organization (s). Discovery of shortages of water or chalk for example, occurring within micro-cycle reporting procedures represent examples of search/reporting activity as micro-cycle reports. See detailed search engine treatises for specific and more exact details of the detailed functions and search technology art

Team Task Order TTO: (118): described in Manager (103) section is used to affect decisions by changing team/unit/organization structure with corresponding changes to card directory lists. A TTO describes what, when, where, how, how often in context with organizational split, joins, moves, adds, drops, merges in context with supporting network and sub-network Domain Name Service DNS technology art. DNS technology and related art is well known and is referential See US Army Field Manuals FM 101-5 and FM 101-5-1 Operational Terms and Graphics. See also Wf-XML workflow a Business Process Management BPM standard Workflow Management Coalition. Wf-XML is an extension to the OASIS Asynchronous Service Access Protocol. ASAP provides a standardized way that (a) program (s) can start, monitor program (s). A TTO is a required pre-requisite and key part of the procedural template in applications dating to 2004

Data Fusion Center (119): Each league has a data fusion center which is maintained by at least one statistician who as a rule has 1 or more assistants. Leagues receive reports from teams where copies of the reports and cards are maintained in the data center awaiting requests for statistical processing. Off field data storage center where multiple statisticians send reports to higher, adjacent and remote league facilities. SOP (136) mandates data, cards and reports from the lower section two must be time stamped and identified by team/organization type with delineations for resources as a Uniform Resource Name prior to data fusion center merges. A Fusion center is an information sharing center, many of which were jointly created between 2003 and 2007 under the U.S. Department of Homeland Security and the U.S. Department of Justice

Merge (120): procedure combining separate cards into a composite card report filtered and combined (fused—see data fusion center) locally by statistician (105) data fusion center (119).

Sort (121) keeping cards, reports of like type separated or separate

Summing Function (122): statistical process tallying, counting and adding to a total

Hop Counts: (123): Hops are linear and sequential referring to applicant's Paul Revere meme (126). Hops are described/defined from null as a condition/state i.e., stationary, inactive. Hops are changes in location from point a to point b to point n. Hops follow a base running paradigm in the main embodiment (131) and are referential to TCP/IP in embodiment 1. Hops are counted incrementally where hops are changes in location e.g., home plate to first, second, and third base and back to home base (131). Hop metrics are incremental changes from null 0, 1, 2, 3, 4-N (126) that may be positive or negative values to equitably meter, measure and derive performance or effectiveness metrics in team arbitrage and resource pooling activities Hops describe, delineate status (state) phase (changes) recorded on 3×5 card (s), sorted (122) in card stack (s) awaiting card changes summary (122) then statistician posts to display (134). Hops descriptions vary with use case context. For example, a hop of a given distance D requires x amount of time to complete. Hops occur along a linear path, or pre-defined route (base running) and are sequential. (Paul Revere meme 123) If hops are occurring from a known point of a circle, moving outwards, they are sequential as measured by the time required to move from hop metric A to hop metric point B described as concentric, circular rings i.e., a to b, to c, to n or 1 to 2 to 3, 4 further described in SOP as an example water drop in pond meme (130). Hop count data is de-duplicated by observing the time stamp of the hop by role comparing the reports by for example, FIFO (First In, First Out) or LIFO Last In First Out. Filtering by time stamp and by role reduces/eliminates duplicative reporting i.e., statistician reports to league headquarters through the off field connector (125) prior to insertion into data center (119) data stores (114). See abacus. Use of hop count by applicant is in context with memes Paul Revere (123) and water drop in pond (124, 130). During duress or emergency situations, umpire may reverse the usual FIFO First In First Out order of hop counts and stipulate LIFO or last in first out and may reverse running of the bases as an example for expeditious evacuation. Time stamps (112) frame and temporally bound hops in temporally—e.g., in time and space. Get-puts of data (113) operate within a timeframe or temporal boundary (start get—put stop get—put) (113). The time stamp where the data get/put may be used to record a hop or an action/activity but not both at the same time. Recording a hop precedes recording of the associated activity which takes a longer period in time. Hops or changes from the last known position are used to extrapolate player motion and tendencies statistically. No report during a time stamp interval is noted as an event. For example, a team player not showing up in time for a game to start is an event. A series of cycles with no reports from a player or actor implies that the player may be subject to de-affiliation due to being in a duress condition (ill, missing, lost). This convention is useful when populating report data to a geo-spatial temporal appliqué overlay display where players shown as symbolic icons colors are changed from blue (ready to play/fully mission capable to gray (missed a reporting micro-cycle) to red (missing, inoperative). See military developed Joint Blue Force Situational Awareness program for detailed treatise. See hop count treatise in Wikipedia and related art section referential to internet/TCP/IP treatises

Areas defined by radius/circumference (124) (water drop in pond meme) are described within a circumference of a circle used to encompass or encircle a cluster of players, teams, or leagues into a discrete set. Resource items are typed, classified by <tags> measured from a known reference point i.e. ten digit map grid coordinate describing a limited or bounded geo-spatial area described by concentric rings/circles shown to expand or contract with threshold metric changes denoting intensity i.e., an earthquake occurs during game with pre/after shocks. Wave crests and troughs are converted into analog integer equivalents where amplitude and frequency changes convey event intensity, duration as thresholds. Discrete wave crest to trough phase changes are summed. Wave crests and troughs define cycles in terms of on, off, duration and describe slowing and speeding up of events, activities occurring within the circular geo-spatial area containing items of interest—see geo-spatial area entries, in related art for treatises

Radius searches performed within circumference (124) use <tags> as search key tag/word targets. Search results are filtered and processed by tag classes and types then saved as search results time tagged with the micro-cycle heartbeat timestamp (112) running concurrently within and assisting with the formation of a self organizing reporting cycle in a macro-cycle as part of a Heart Beacon Cycle (137). Radius search results displayed to an appliqué overlay for example, changing threshold, duration and intensity conditions in precedence processing parameters i.e., flash override, flash, immediate, priority routine shown on appliqué acetate overlay display boards (134). Time filtered and spatially described reports comprised of state meta-data snapshot/heartbeat message/sync delta messages where state meta data is harvested during micro-cycles to be posted/displayed during longer macro-cycles facilitates shared team situational understanding of events. Statisticians perform radius searches. Leagues have radius search conventions procedures i.e. left, right field lines form radius search boundaries, outfield fence forms boundaries, and surveyed points of bases provide known reference points. Radius searches are associated with the water drop in pond (124) meme related to geo-spatial temporal intensity processing more fully described in the related art, summary and embodiments

Off Field Connector (125): is a service delivery way point/hub/gateway (see see Security and Exchange Commission treatise on heartbeat messages and gateways) i.e., card or letter mail box located on a micro/macro/local/higher headquarters physical space boundaries where cards are queued for pickup and delivery on a scheduled basis for inter-team, peer to peer and interleague card exchanges. Off Field Connector (125) is an interaction/interface/transaction boundary or card transaction point between leagues and teams where processes are run using parsing/processing techniques to process state meta-data <tags>. Is a locus/hub for service orchestration of processes and choreographs activities between team, league and league commissions at the macro-level where setting the macro-cycle synchronization schedule occurs acting as a distributed services broker regulating player, team (user) access to league and commission resources. Is a service orchestration and choreograph locus/hub/way point between local actors/runners who generally service macro-cycle data delivery get/put transactions and do not cross the boundary to a league level where runners generally operate and service requests referencing and relating macro-cycle longer, slower reporting periods. See related art for reference to macro-micro cycle definition as a pointer to more detailed treatises Precedence: (126): Sequential hop counts: Changes in state from base to base or local to off field as linear, sequential hops. Starting state/condition is null i.e. 0, 1, 2, 3, 4 . . . where elements, tags are processed by type and given priority by group conventions such as duress condition, scarce, rarity (Honus Wagner baseball card) or hazardous condition Null is stationary, start condition. Change from null 1, 2, 3, 4 . . . n increase where null is no activity, 1 is elevated and 2 is imminent. See items 124 and 130 for precedence relating to circumference, circular area conventions. Precedence processing may be reversed during league defined or duress conditions where last are processed first LIFO instead of FIFO (Last In First Out, First In Last Out) related to hops

Decision (127): an act or process of deciding; determination, as of a question or doubt, by making a judgment: An act of or need for making up one's mind: A judgment, as one formally pronounced by a court. The quality of being decided; firmness. For example, making a play call

Delay (128): deferral, halt, followed by restart responsive to mitigating circumstances

OR (129): As a rule, a change or option choice/switch i.e. coach chooses Hasty or Deliberate action. OR is choice, branching function described by nested tags on cards

Concentric, Circular Water Drop in Pond meme (124, 130): changes in phase and amplitude corresponding to area radius, circumference (124). Concentric hop counts changes in circular area radius (124) are related numerically to threshold metrics. Wave crests and troughs are converted into analog integer equivalents where amplitude and frequency changes convey event intensity, duration as threshold changes. Discrete wave crest to trough phase changes are mathematically and arithmetically computationally processed for example, summed or averaged

Baseball diamond (131): describes an area (124) defined by left and right boundaries and has length and depth. Represents hop counts as base to base incremental counts i.e., home plate to first=1 hop, or traversing a baseball field from one diamond to another

Leagues (132): Leagues consist of teams, strings (1^{st}, 2^{nd}, 3^{rd} string) players. League is organized hierarchically as a trees that have branches that have leaves convention comparable and analogous to a directory reference which in the main embodiment uses 3×5 card stacks

Teams (133): Teams are units of action that execute activities (play baseball game) and are a basic unit of organization where structure changes are shown in response to changing conditions Display Board (134): acetate sheet overlays appliqué style over a board with grease pencil entries Pre-conditions (135): culmination and accumulation of items 101-135: a precondition is a condition or predicate that must always be true prior to the execution of some section of code or before an operation in a formal specification. If a precondition is violated, the effect of the section of code becomes undefined and thus may or may not carry out its intended work. Pre-conditions must be followed. For example, runners may not run the bases in reverse order. League may not violate SOP rules. If league violates SOP rules, teams and players may de-affiliate at any time. Preferably, de-affiliation occurs after League Commission mediation

SOP (136): list of league/team/player defined standards, operations, procedures, processes and preconditions that must be present for the league agreement to be in effect. An SOP is more than a table of contents in that each entry in the table of contents contains a paragraph or several descriptive paragraphs with references or pointers to other relevant standard documents

FIG. 1: Heart Beacon Cycle Procedures 0-9: FIG. 1 has three sections. The top most section is divided by a horizontal line drawn above team (133) over to league HQ labeled section 1. Section 1 represents the league environment. Section 2 in the lower left hand corner is a baseball team's dugout area. Section 3 lower right hand corner refers to the playing fields area

0 Umpire makes SOP (136) checks (135) is satisfied, changes status (128) of game
1 Coach (102) selects <play> <hasty> (111)<position change>
2 Manager (103) decides (127) to substitute first string (101) to support Coaches (102) play
2a Manager (103) selects 2^{nd} string team as substitutes using directory process (106)
2b Manager (103) selects TTO (118)<Reorganize> <substitution> writes <change> <location> (field) and position (s) 1^{st}, 2^{nd}, 3^{rd}, base . . . on TTO card, notes TTO number
2c Players (101) receive cards from runners (108) read cards, move from bench to field
3: Roster change 1^{st} to 2^{nd} string noticed by statistician (105) noted on card then displayed (134)
4 Unexpected (111)<event> <earthquake> (130) creates sink hole in field (131)
4a Event (earthquake) ruled (127) by Umpire (104) to be condition to delay (128) game
4b League suggests to Umpire that teams (133) share field (131) in space where outfields adjoin.
4c Since Team A is currently practicing bunt plays, only 1 outfielder set from 1 team (team B) needs to occupy space (131) setting condition for team B (missed last cycle game play game)<earthquake> <sink hole> to practice accumulate <resource> training unit with no conflict of interest resulting in multi team situational understanding and multi team collaboration
5 Statistician (105) receives LOG_SITREP (logistics) card (110) then fills in requisition form for <bat> and <player> giving card to runner who takes card to league (125) statistician (105)
5a Statistician (105) posts summary of changes occurring between heartbeat timestamp cycle A and B (112)<minus 1 bat> <minus 1 player> where changes are sent as a merged (120) Sync Delta report (115) instead of duplicating and sending the entire report avoiding sending repetitive form data. Sync Delta data posted to display board (134) activity: resupply <bat> <player>
5b Statistician (105) state change data (115) is written to cards using data from cards stored (114) on table delivered by runners (108) to league (132) using the best means available (125)
6 League statistician posts LOGSITREP request on league display board (134)
7 League statisticians (105) search (117) sources for <bats>, <players> (101)
8 League statisticians (105) look in card stacks for source for bat and player <resupply>
9 League receives team summed (122) changes merges (120) into single Commission report
9a Awards and remunerations couriered (108) to league members (125)
9b League displays cumulative team activity (119) within discrete Heart Beacon Cycle (137)
9c Statisticians (105) update roster changes in directory records (106) (107) disseminate changes over a wide area basis (125) to directory rosters (106) (107) then league, teams update Heart Beacon Cycle (137) repeat (iteration, iterative);

The main embodiment meme environment is an example environment comprising a sample procedural template list: common building blocks, common denominators using little league tournament for brevity and clarity as compared with previous continuation applications that cite military situational understanding system described in the public domain i.e., History and Discovery television channel documentaries and public web pages on Blue Force Tracker to establish and describe as a list of pre-requisites the items necessary to form federated groups for synchronized collaboration as a best practice, best effort method and means with novel aspects. A Heart Beacon Cycle is a set of cyclic, iterative, repetitive steps in which leaders, whether military or civilian, in the course of executing missions and plans must be translated into networking terms which the system administrator/military communication's officer must convert. In FIG. 1: Heart Beacon Cycle Procedures 0-9, the steps 0-9 as a rule are followed in sequence unless an act of God (111) or unforeseen circumstance is encountered or a leader simply changes his or her decision. Steps 0-9 follow if, then, else paradigms. Changes to step order may occur according to adaptive, iterative process capture change management techniques. A Heart Beacon Cycle is a process that is designed to react plan changes for many reasons such as acts of god, or simply a leader changing his or her mind or strategy which again, must be translated into networking corollaries e.g., organizational changes such as moves, adds, drops, joins, splits where organizations and sub-groups in organizations are affected in sub-nets. A Heart Beacon Cycle is a best effort, best practice, iterative procedural template method and as such, does not account for every possible permutation of events, activities encountered.

A Heart Beacon Cycle is a method using procedural templates comprised of policies, procedures as prerequisites in the aggregate forming nested, mutually reinforcing self organizing structures in systems of systems frameworks as templates/guides to form agile, adhoc federated groups orchestrated by sharing appliqué geo-spatial intensity common picture views synchronized in time—space where items 101-136 are minimum requirements. A Heart Beacon Cycle: is an aggregate, cumulative, adaptive approach using nested sets of self organizing structures i.e., network, map, directory, reporting, and system of systems structures formed by procedural templates comprised of policies, processes as standard operating procedures as preconditions formed into systems of systems frameworks where collections of objects and resources are described within Virtual Clusters VC using Paul Revere, water drop in pond methods where events, activities and resource sharing schedules are synchronized in time—space by heartbeat macro/micro cycles within wide area, cloud computing, electrical smart grids, and multiple inter-networked domains supporting federated ID groups collaborating on projects/activities such as equitable trade arbitrage initiated by place based, area/location specific searches

Main embodiment items 101-134 culminate into a list of preconditions (135) contained within a team, league SOP (136) when signed form a best effort, best practice teaming agreement. Items 101-136 must be present and agreed upon prior to initializing a Heart Beacon Cycle (137)

The invention's purpose in forming an SOP is to describe a minimum component items required to form a valid, repeatable procedural template as a model and guide in synchronized collaborative activities. A league SOP lists the required components, functions and a schedule, but does not instruct precisely how to use multiple components in every possible instance or permutations as this is not practical and tends to discourage affiliation/joining into federated groups belonging to federations where participation is voluntary predicated on observing a minimum high level set of requirements i.e. a table of contents and hierarchical framework of an SOP. Equity in league dealings is defined by consensus and conformance. Teams as organizations include additional detail into their chapters as treatises as they deem necessary to account for unique preferences or requirements. An SOP is a high level league document that is formed as a reference to publically well known and available standards as detail treatises using a table of contents with summary, short paragraphs of descriptions of components as building blocks (i.e. state process checker, directory process) operated or used in common procedures predicated on a game that has been established but not perfected nor ever will be perfected given the human element i.e. coaches decisions—see Money Ball movie reference. The inventor is not reinventing the game of baseball. Baseball is used as a meme examine the invention's main components and processes used as examples of best practice/best effort towards conducting tournaments as a federation in simplistic, common terms. The invention/inventor does not intend to reinvent cited components, procedures and processes. Detailed functional/operational detail is left up to individual organizations in the federation. A Heart Beacon Cycle (137) involves data aggregation followed by data dissemination related to changing events caused by acts of God (111) or actors' decisions. A distributed form of collaborative data processing, newscast processing is described by runners delivering cards where runners announce newsworthy events. Resource types are processed by precedence processing using a category described by statistical means being scarce (below threshold) or rare i.e. Honus Wagner baseball card. By classifying missions <search> for rare card <if find> creates condition change <state change> action: <buy> then deliver to trading post. Tournaments involve large numbers of players that are grouped into teams then aggregated or collected into geo-spatial areas defined by time and space measures where the aggregation of various sorts of tagged data are distributed by runners across connection points in a grid or mesh. Finding extreme values, counting discrete observations or computing an average or a sum of parameter values are typical examples of activities tangential to the tournament that provide input to monitoring activities in playing area (FIG. 1 lower right). The news broadcasting aspect of the runner helps form self organizing structures by announcing opportunities to merge teams on a short term, adhoc, agile basis using directory references (lookups) for collaborative ventures forming organizations where none existed previously as a novel, self organizing structure

A Heart Beacon Cycle (137) is a self organizing temporal synchronization method consisting of micro heartbeat timestamp cycles (112) running within a longer macro cycles (137) where micro-cycle heartbeat time stamps (112) are used to reliably time tag data get/puts (113) prior to data fusion center (119) insertion. A micro-heartbeat timestamp cycle (112) runs within a longer UTO task re-organization macro-cycle (137) described by longer distances, time intervals. Macro-cycles are derived by league commission research into the average or statistical mean of game duration over t amount of time. Macro-cycles have a window of validity/window of effectiveness corresponding to the established league commission game time allotted. If game time allotted is exceeded as in an overtime condition, then the league announces that an overtime condition is in effect and effective until overtime conditions are met as described in the SOP A Heart Beacon Cycle (137) is self organizing in that prior to a player, team, league affiliation, no time cycle pre-condition existed among players, teams, leagues where the cyclical and repetitive nature of the reports within a reliable, predictable reporting interval represents structure and form that otherwise would not exist. The time cycle is chronologically sorted. Similar logic applies to the directory organization. Directories do not exist until affiliation by teams and players and interleague commissions do not exist until multiple leagues affiliate and agree to share directory structure updates. Teams form a league and multiple leagues form and provide an opportunity in time for a league commission to exist with the condition that changes are monitored and exchanged thereafter on a recurring time interval basis to maintain the structure and form of the affiliation—a little league commission in the main embodiment

A Heart Beacon Cycle (137) is comprised of multiple forms of self organizing structures. Players as a rule; do not make team reports until a team is joined contingent on agreement to report forming previously non-existent reporting cycles (137). State meta-data snapshots gathered during a micro-cycle within a macro-cycle are synchronized as a cycle within a cycle co-processed where the cumulative sync delta changes are merged into sync delta change reports (115). The process of gathering sync delta snapshots is iterative. Sync delta (115) reports are displayed onto a appliqué geo-spatial overlay (134) filtered by data element key words and by time stamps tagged by organization and resource type (ORG II), URN) prior to data fusion center insertion in a pre-determined temporal micro-cycle running concurrently and supporting a longer macro-cycle forming a novel self organizing, situational awareness method.

Affiliation causes reporting of activities, events, and activities forming a self describing structure within an iterative cycle within a cycle where reports were non-existent. A Heart Beacon Cycle is comprised of a self organizing directory structure. If a Team Task Order TTO (118) involves moving a team (133) from one league (132) to another, then the sync delta report (115) describes changes in a hierarchical directory where annotations are made to 3×5 cards. A (card) directory, when updated over a wide area in a macro cycle (137) functions to share organize data and information about player, team, league and league commission structure, location as tree branches and leaf change mappings as changes or updates rather than sending the entire structure that otherwise would not have existed thus forming a self organizing structure

Self-Organizing Maps (SOMs) are used in the automatic clustering of <data tags> on cards using bodies (corpus) of tagged data using two different self-organizing map models. One model requires <tagged> documents to be represented by real-valued vectors, obtained using a circle of tags approach described by area water drop in pond area model meme (124). A second approach clusters structured data into tree structured representations preserving a structural information in the cards. A SOM for Data Structures (SOM-SD) encodes card organizational directory data into tree structured graphs where individual points of a graph and processed one at a time (123) rather than by processing a graph as a whole into a topological order i.e. from a tree leaf connectors towards a tree root connectors causing runners with cards to move from leaf connectors to root connectors. Vector elements are weighted to control priority and precedence (126) correlated to a similarity measure. Map boundaries form blocks describing a predefined area or space to organize federated group activities or discrete areas of mesh-fabrics SOM-SD map is a given set of graphs, and all sub-graphs onto the same visual display (134) map. Tagged documents are represented as graph data structures annotated on 3×5 cards. Self-Organizing Maps group XML structured data into clusters, scaled in linear time (126) with increasing size of the body of cards (corpus). Prior knowledge of data structures SOP (136) aids grouping of tagged cards. Board display appliqué visuals (134) are made by grouping x dimensional datasets into y dimensional display plane (FIG. 1 lower right). SOM is a discrete display space with N×N grid points, each grid point is associated with a y dimensional vector, and contents of these vectors encode the relationships (distances) among the point dimensional data (124). The result is that data items that were “similar” or “close” to each other in a original multidimensional data space are then mapped into near by areas of the 2-dimensional display space (134). SOM is a topology-preserving map as there is a topological structure imposed on the entities clustered in the area. A topological map is a mapping that preserves players grouped as teams playing baseball in area relations. The SOM has N×N grid points, associated dimensional vector called a code book (analogous to a play book 136). For example, surveyors form maps through triangulation from a known point. A Heart Beacon Cycle (137) unique aspect and novelty is the use of a meme cited by the applicant as a water drop model uses circular, circumference conventions starting from a known, surveyed point. Geo graphical data closer to home or a known reference point is updated before information is updated farther than home given the time to travel required from the known point to the point requiring the updates. For example, map data belongs to states hierarchically sub-ordinate to the country. County (Monmouth) is hierarchically subordinate to the state of New Jersey where Oceanport is hierarchically subordinate to Monmouth Country where Sea Girt Avenue has house on 82 Sea Girt Avenue that has a surveyor point located within 10 feet of the cable and light poles. Light poles have a vertical height measured from ground/sea level and are located within 10 feet of the surveyor reference. Sync delta changes to map data is preferred to sending data relating to the description of entire map sets. In the main embodiment, surveying techniques describe space using geometry where space (124) and distance (pitcher's mound to home plate) requires Time To Traverse (ITT). Time to Traverse/Time To Live (TTL) parameters that are measured and metered as hop counts linearly and sequentially (123). Area radius is measured by a linear/sequential hop count line with hashes/bars delineating space intervals (123) as a left and right boundary (FIG. 1 lower right hand corner) Area (124) gaps are filled by forming grouped clusters of populations of team members, players, objects and artifacts of interest to define, describe and occupy the space where no organization existed previously. Water drop in pond ripples (124, 130) are analogous to sine waves where crests and troughs relate to amplitude and frequency phases that are converted into discrete integer hops (123 Paul Revere Meme expressing changing precedence conditions. Linear/sequential (123) and area/cluster (124) methods when combined form a lattice mesh fabric/matrix describing and forming boundaries (mesh-fabric blocks) in areas occupied by groups of clustered objects and artifacts as a self organizing structure where a fabric/mesh did not previously exist

Mesh/fabrics as organizing structures are formed by using time to describe depth and length, and hop counts to delineate distances in space where mesh fabrics. Mesh/fabric area gaps (124) in space/time are filled with entities (players 101) formed into groups/teams (133) organized in clusters of groups. Location and place specific searches are conducted for resource pooling/arbitrage activities searching on objects of interest in time (pedometers) uniquely identified by <brackets> denoting class types and groups within mesh/fabrics. Interoperability between different vendors is improved by the use of machine readable service level agreement (SLA)<tags> used to describe measures of performance and measures of effectiveness (MOE/MOP) used by transaction execution services in autonomic, automated service agreements. Cloud computing elasticity: cloud's ability to deliver on scale, scalability—both up and down—and do so rapidly. A Heart Beacon Cycle water drop in pond, Paul Revere memes lend to consistency and reliability among scalability and therefore, elasticity measures and metrics Vectors are hexagonal or rectangular as a rule but may be other geometric shapes or defined by Origami squares that are mathematically predicted and described to embody virtually any shape within a mesh/fabric using boundaries defined by a linear sequential Paul Revere meme. Affiliation in a mesh—fabric is facilitated by aggregates data points into clusters—either formed from concentric squares or circles (130) where the center radius point is derived from known surveyor points i.e., mapped to house owned by occupant belonging to town, to country to state and to country. Boundary lines may act as a bus or cart route or lanes i.e., swim lanes when arrayed in parallel. Areas within boundary lanes may be defined using surveying techniques where an area is described by drawing lines from a known point as a radius in concentric circles (130) or concentric squares. As a rule, area between boundary lines defining areas will be constructed and depicted by surveying techniques as hexagon cells. Irregularly shaped areas, e.g., the state of Idaho (not square, rectangular, or circular) are represented by mathematical predictions of Origami shapes. Association of players grouped/federated into teams/organizations described by <tags> in space (within concentric circles, squares, hexagon cells or Origami mathematically described structures) and time form self organizing structures

A Heart Beacon Cycle's self forming directory structure describes paths to the forests and trees as links facilitating description of the Transparent Interconnect of Lots of Links (TRILL) mesh-fabric standard as well as the Shortest Path Bridging and Multi-chassis Link aggregation where hops meter transactions and traversals of racks and chassis located in cloud and smart grids. A fabric-path approach is described by use of a linear, sequential Paul Revere meme to describe time and space boundaries and a circular, radius water drop in pond meme (s) combined with Origami square folding techniques describe the space and the name space where clusters of managed objects, entities, users, groups and their associated resources reside facilitating cross vendor service orchestration and automated, autonomic service agreements between vendors and private, public, and hybrid environments such as cloud instantiations Items 101-134 culminate into a list of preconditions (135) contained within a team, league SOP (136) when signed form a best effort, best practice teaming agreement. Items 101-136 must be present and agreed upon prior to initializing a Heart Beacon Cycle (137). A Heart Beacon Cycle is comprised and supported by a nested set of self organizing structures that are complementary and mutually reinforcing: network, map, directory, and reports that are part of and complimentary, and contributive to a self organizing system of systems operating within a network of networks where individual entities form into groups that report to federated groups League data fusion center's statisticians, can access, orchestrate, manage or aggregate external services from other cloud service providers as a service on behalf of a subscriber/actor. League data fusion center statisticians as brokers include handling interoperability issues, acquiring external resources and are focused on providing service process integration, service catalogue lookups, subscription handling, single point federated identity management, actor management relations and communications, commodity and resource brokerage, and metering services Heart Beacon Cycle: an aggregate, cumulative, culminating approach using nested sets of self organizing structures i.e., network, map, directory, and reporting structures formed by procedural templates comprised of policies, processes, standard operating procedures as preconditions formed into systems of systems frameworks where collections of objects and resources are described within Virtual Clusters using Paul Revere, water drop in pond methods where events, activities and resource sharing schedules are synchronized in time—space by heartbeat macro/micro cycles within wide area, networked cloud computing, electrical smart grids, A Heart Beacon Cycle is a listing of pre-requisites as a procedural template yet does not mandate an exact structure of a procedural template given templates will vary from use case to use case. A template is a model that provides a general guide. Below is a procedural template cited as an example in the related arts section on the left compared with Heart Beacon Cycle uses on the right hand side separated by a // convention Stanford Linear Accelerator SLAC on left // Heart Beacon Cycle generic non-specific use case example on the right hand side of the // separator:

Table of Contents:

| | |
|---|---|
| 1. | Introduction 3 // Heart Beacon Cycle abstract/summary |
| 1.1 | Purpose 3 // Purpose of a Heart Beacon Cycle |
| 1.2 | Scope 3 // High level, skeletal framework describing items below: |
| 1.3 | Roles 3 // Main actor roles see items #101-109 main embodiment |
| 1.4 | Definitions and Acronyms 3 //Spells out military unique acronyms e.g., MERC |
| 1.5 | References 3 // Links to detailed treatises e.g., X.400, X.500, UML, Mapping tech |
| 1.5.1 | Traceability 3 // traceability matrix is a document usually in table form, that correlates |
| | base-lined documents that require many to many relationships i.e., in a system of systems |
| 1.5.2 | Policies 3 // Heart Beacon Cycle recommended policies such as OSD STRATML |
| 1.5.3 | Standards 4 // Heart Beacon Cycle recommended standards i.e., in embodiment 1 |
| 1.5.4 | Processes 4 // Directory, Broadcast, Map, Reporting, Search Services processes.. |
| 1.5.5 | Procedures 4 // Heart Beacon micro cycle, macro cycle, state meta data collection.. |
| 1.5.6 | Guidelines 4 // Includes reference text found in related art section as examples |
| 1.5.7 | Templates 4 // Unit Task Order UTO, Team Task Order, message templates |
| 1.5.8 | Checklists 4 // Do cards for runner include required fields e.g., timestamp/Org ID ? |
| 1.5.9 | Training 4 // Training modules to walk novice players through baseball conventions |
| 1.5.10 | Tools 4 // Unit Task Order UTO tool that opens drop down window menu team pick list |
| 1.6 | Profiles 4 // Biography of team members as actors i.e., coach, manager, umpire |
| 2. | Procedure (Steps) 5 // Heart Beacon Cycle as steps 101-136 culminating in 137 |
| 2.1 | Begin a list of steps beginning at the number one 5 // 101 in main embodiment |
| 2.2 | Begin a list of steps that restart at the number one 5 // Restart, Repeat 101-137 |
| 3. | Process/Procedure (Mapping)6 // process flow chart see FIG. 1 item 101-137 |
| 3.1 | Entry Criteria 6 // For example, actors are familiar with baseball, sign SOP to verify |
| 3.2 | Process/Procedure Map 6 // process flow chart see FIG. 1 item 101-137 |
| 3.3 | Inputs 6 // state meta data from participating individuals in groups i.e., ORG ID, URN |
| 3.4 | Activities 6 // See item 127 in main embodiment activity tag = use case specific |
| 3.5 | Outputs 7 // See output functions in main embodiment e.g., sum, reports, total |
| 3.6 | Verification and Validation 7 // State management process/checker used by statistician |
| 3.7 | Exit Criteria 7 // Heart Beacon Cycle process followed 101-137 = unit reorganization |
| 3.8 | Metrics 8 // threshold sync delta changes processed by state management checker |
| 3.9 | Records Control Table 8 // League/organization data fusion center item # 119 |
| 3.10 | Controlled Documents Table 8 // SOP Playbook #136 control form sign out sheet |

Appendix A - Dictionary of Terms 9 Heart Beacon Cycle cited MERC (DARPA term)
Appendix B - Acronyms 10 // Heart Beacon Cycle unique i.e., MERC (DARPA term)
Appendix C - Flowcharting Symbols11 // FIG. 2 Legend uses flow charts symbols in Word
Appendix D - Bibliography 12 // Heart Beacon Cycle list of related patents/documents
Appendix E - Document Change Control 13 // SOP sign in/sign out/change sheet

A Heart Beacon Cycle (137) is iterative referential to an act of repeating a process with the aim of approaching a desired goal or target or result. Each repetition of the template procedural process is called an “iteration,” and results of one iteration are used as the starting point for the next iteration. cycle-based execution iterative method applying process mining framework for software processes in adaptive procedural templates accounting for error corrections. This idea is based on the concept of Russian Matryoshka nesting dolls (Russian: MaTpëωκa): a set of wooden dolls of decreasing size placed one inside the other where the main or outer shell most often in view projects an appliqué overlay image. Adding shells (embodiments) to a doll describes variations as additions representing embodiments where added shells as appliqué images are complimentary yet add uniqueness and novelty to the original, main appliqué shell. A Matryoshka Doll/Heart Beacon Cycle embodiment) form is complete when it is agreed that shell layers are present in sufficient quantity, function, and design to meet group member expectations as a cumulative, aggregate, culminating method of multiple self organizing mutually reinforcing structures i.e., network, reporting, directory, map, and a system as a system of systems.

The Heart Beacon Cycle is a best effort use of best practices to achieve systemic change across n systems in a system of systems supported by n networks in a network of networks. Systemic refers to something that is spread throughout, system-wide, affecting a group or system such as a body, economy, market or society as a whole. Source: Wikipedia Systemic Wiki

### Detailed Graphics Description

FIG. 1: A Heart Beacon Cycle is a description of forming groups into a collaborative federation of players into teams, teams into leagues under a league commission organizing in time (heartbeat interval described) and space for example, playing fields to accomplish common goals and purposes e.g., conduct a little league baseball game tournament. FIG. 1 items 101-137 were discussed in detail in the above detailed description of an illustrative embodiment section using FIG. 2: Heart Beacon Cycle Legend describing components relating to FIG. 1

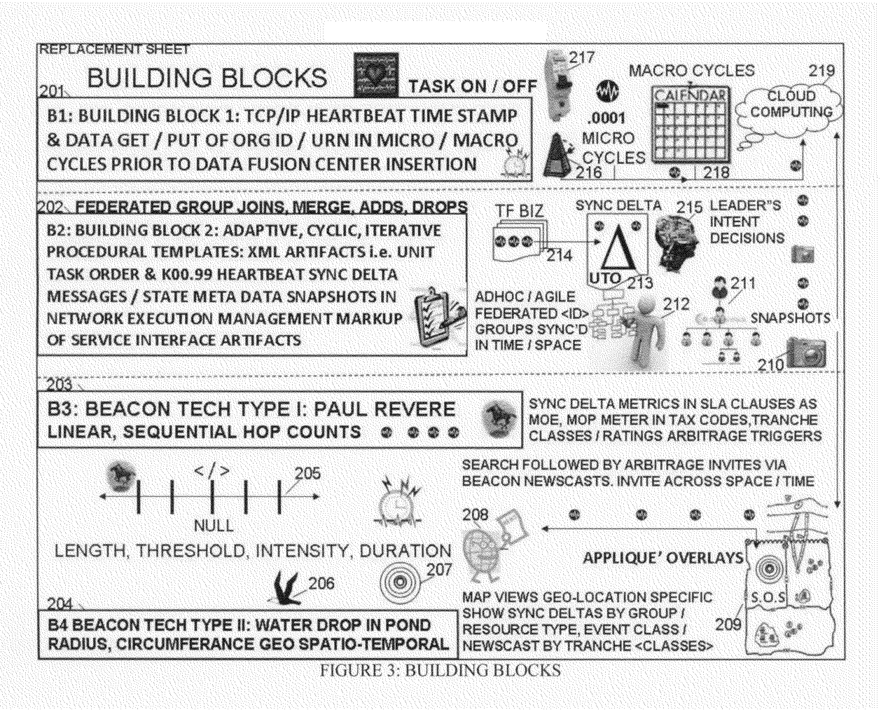

FIG. 3 is an updated graphic describing the four main building blocks. Building block I is the TCP/IP Heartbeat, building block two as a procedural template, building block 3 is the Paul Revere beacon technology meme, and building block 4 as the water drop in pond beacon technology meme. Number 201 in the upper left hand corner of the top most swim lane or upper most graphic section refers to the TCP/IP heartbeat sub-protocol as a computational opportunity in time to do/not do computational tasks—specifically, data gets or gathers and placement or puts into device memory during TCP/IP timing cycles in this case, prior to data center fusion insertion where the device, platform, computational device's organizational identifier or ORG ID and Uniform Resource Name URN is obtained. The TCP/IP cycle that is usually in micro-seconds or seconds or faster supports slower, longer duration macro-cycles that may be measured in minutes, days or long macro cycles depending on specific use cases. Number 217 is an on/off switch indicating that a heartbeat is the means on which all other processes and procedures to rely on in this context to place start/stop (pause, resume) commands to devices and computational platforms as the only possible universal means. Number 216 depicts a metronome representing shorter duration micro-cycles. Moving to the right, number 218 is a calendar graphic representing long macro-cycles in a Heart Beacon Cycle. Number 219 is a cloud graphic representing cloud computing environments where macro-cycles are used to rapidly and synchronously gather changes in state meta data (geo-location, organizational identifier ORG ID, Uniform Resource Names URN, status reports that are used to extrapolate the position, health, readiness of a tracked device, platform. Micro-cycle reports are summed and consolidated into macro reports called heartbeat messages or state meta data snapshots and SPOT/SITREP (size, position, organization, time), Size, Intelligence, Terrain, Readiness, Equipment, and Position) in military terms used by system administrators to update network, system configuration by sharing the reports during macro-cycles updating each other. Moving downward to the second building block 202, this swim lane refers to (adaptive, cyclic, iterative) procedural templates comprised of discrete and cumulative forms (XML artifacts), processes and procedures more fully described in FIG. 1 and FIG. 2. Number 214 represents heartbeat sync delta artifacts (messages) from discrete organizations/units aggregated at the lower level into higher level Unit Task Orders 213. The military's sync delta convention as described in previous continuation applications is the K00.99 heartbeat message. A commercial corollary to military heartbeat sync delta messages are cloud computing Network Execution Management of Service Interface Artifacts enabling network execution management. Number 212 is an organization chart where subordinate organizations report changes in heartbeat sync delta (214) update reports in micro cycles. Capturing/gathering user's change activities in groups is vital to establish agile, adhoc federated group activities where macro cycles in larger micro-cycles describe state changes during specific time intervals across defined space or geo-spatially. Number 211 is a similar graphic to 212 showing that leader's decisions affect the structure of organizations where a branch of an organization may be reassigned to support another partner organization or a parent organization at a different location necessitating gathering and propagation of network configuration information in snapshots (210). For example, a data storage snapshot is a set of reference markers, or pointers, to data stored on a disk drive, on a tape, or in a storage area network (SAN). A snapshot is like a detailed table of contents, but it is treated by the computer as a complete data backup. Snapshots streamline access to stored data and can speed up the process of data recovery. Moving downward to the third building block and third swim lane 203 showing the Paul Revere beacon broadcast/newscast linear, sequential protocol type used memeically to describe count and or state changes between reporting cycle 1, 2 to n cycles within macro-cycles checking each participating platform, device, user, account etc. moving from platform to platform in a similar fashion that Paul Revere historically road from town to town announcing his state change. As Paul Revere road from town to town in a linear, unidirectional manner, lamps in towers were lit corresponding to pre-arranged procedural conventions e.g, one if by land, two if by sea. Other towns lookouts upon seeing the lights/candles in towers would light their own lights/candles causing a more circular, radius type of alerting paradigm to occur 204 affecting areas within a certain radius that may be leveraged to group users, platforms, devices into clusters to take action in any number of alert, event, reporting, or arbitrage type of activities more fully discussed in the main embodiment. The Heart Beacon Cycle may involve use of area description (209) techniques intrinsic to beacon technology protocols—205, 206, 207, 208, as common, standard techniques in currency fluctuation techniques such as the candle system in currency arbitrage previously described in the related arts section. Candle system reports involve a short period and a longer period often described as a rectangle that equates to data refresh techniques employed by a Heart Beacon Cycle procedural template as micro/macro cycles. Various geo-spatial shapes and objects in candle cycle reports are rendered as more fully described in the main embodiment in the geo-temporal spatial discussion of time, space and mapping methods. Returning to describing this graphic, 209 is a representation of a appliqué geo-spatial temporal overlay, 208 is clipart denoting a newscast type of protocol. 207 is a graphic describing a water drop in pond radius, circumference circular type of protocol used in geo-spatial renderings. 206 is a water drop in pond type of protocol—specifically the Sea Gull Protocol described in this application and prior application's related arts section. 205 is a graphic representing a Paul Revere linear, sequential type of protocol used to meter and measure hop counts.

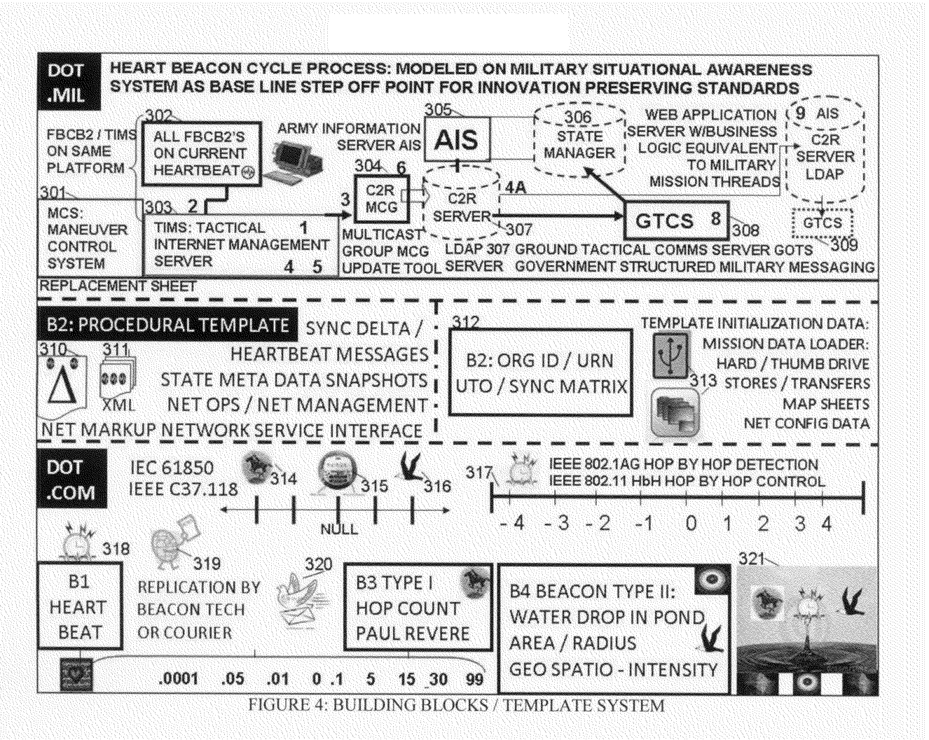

FIG. 4: Building Blocks/Template System: this figure cites the building blocks of the template system that prior continuations: Ser. No. 11,601,035 Method to enable the heartbeat beacon for homeland security and homeland defense interoperability filed Nov. 17, 2006 as a continuation to: Ser. No. 10/709,358 Method to enable Heartbeat e9-1-1 filed Apr. 29, 2004 as a continuation to: Ser. No. 10,708,000 shown on the top most swim lane of FIG. 4 (FIG. 4, numbers 301, 302, 303) compared with building blocks of a system agnostic, generic template used in the most recent of continuation applications and this application see FIG. 4, numbers 310-317. Returning to the top most swim lane anchored by number 301, this swim lane is taken from prior continuations representing a template system procedures and building blocks 301-309 used by the applicant as a departure or stepping off point on which to base the inventors improvements and functional extensions i.e., Paul Revere, Water Drop in Pond, data typing prior to data fusion center insertion. The applicant uses a little league, non-networked embodiment in this application to focus on mission-aware networking aspects discussed in the related art section. A non-networked approach is used to decouple this application from examiner's objections such as using XML tagged state meta data to synchronize satellite constellations that is out of this invention's scope. Number 310 anchors the swim lane and this application's claims based on and delineated into four building blocks were each building block describes an embodiment and anchors basis of claims in the claims section. 311 is a graphic describing the concept previously discussed in FIG. 3 number 214—namely, heartbeat sync delta 214 update artifacts used in micro to macro reporting cycles as part of mission—aware, network operations and network management as part of network markup in network service interface artifacts/documents/reports more fully described in the main embodiment previously. 313 denotes the inventions innovative use of gathering organizational identifiers ORG ID and Uniform Resource Names (descriptors) aggregated and represented in Unit Task Orders (Team Task Orders TTO in the main embodiment) along with the sync matrix that the military uses to map in a spreadsheet indicating which organizations will interact with which other organizations in a given mission or operation. Number 312 points to temporary storage options where data is temporarily stored prior to onward distribution by more sophisticated protocol options that will be more fully discussed in the following diagram number five as discussed as a detailed treatise in prior continuations Ser. Nos. 10/708,000, 10/709,358, and 12/856,715. Moving downward to the bottom swim lane starting with number 318 that is the TCP/IP heartbeat followed by 319 that represents news casting options more fully described in the main embodiment used to announce state changes as for example, opportunities to participate in federated group arbitrage activity as metrics and metered state changes shown by 314 Paul Revere Meme, 315 a meter graphic, 316 Sea Gull water drop in pond type meme, 317 the Paul Revere meme as a method and means to record and measure hop counts that are aggregated during micro reporting cycles and announced by newscast protocols (319) or couriered or hand delivered in the case of the main embodiment (320) that is a non-networked embodiment used to stress that while system and network synchronization is necessary, this invention does not make any claims in regards to system and network synchronization beyond citing synchronization of systems and networks as necessary pre-requisites as part of the overall Heart Beacon Cycle procedural template. This application will cite a method and means of stochastic network harmonization combining a firefly (insect) inspired stochastic network harmonization technique improved when the sum or aggregate firefly statistical algorithm outputs are combined with a closest Heart Beacon Cycle match as an method and means to harmonize a plurality or many systems and networks participating in a network of networks and a systems more fully described in the related art and main embodiments. This is not the same as using XML artifacts to synchronize a single satellite constellation. Number 321 is a graphic used to illustrate water drop in pond type protocols used in geo-spatial temporal areas useful in showing outputs of stochastic harmonization techniques in appliqué overlays. The Heart Beacon Cycle addresses stochastic harmonization of networks addressing synchronization issues where transactions must from a temporal time stamp standpoint, appear in a system (s) to occur at the same time and place for example to process, recalculate fungibles.

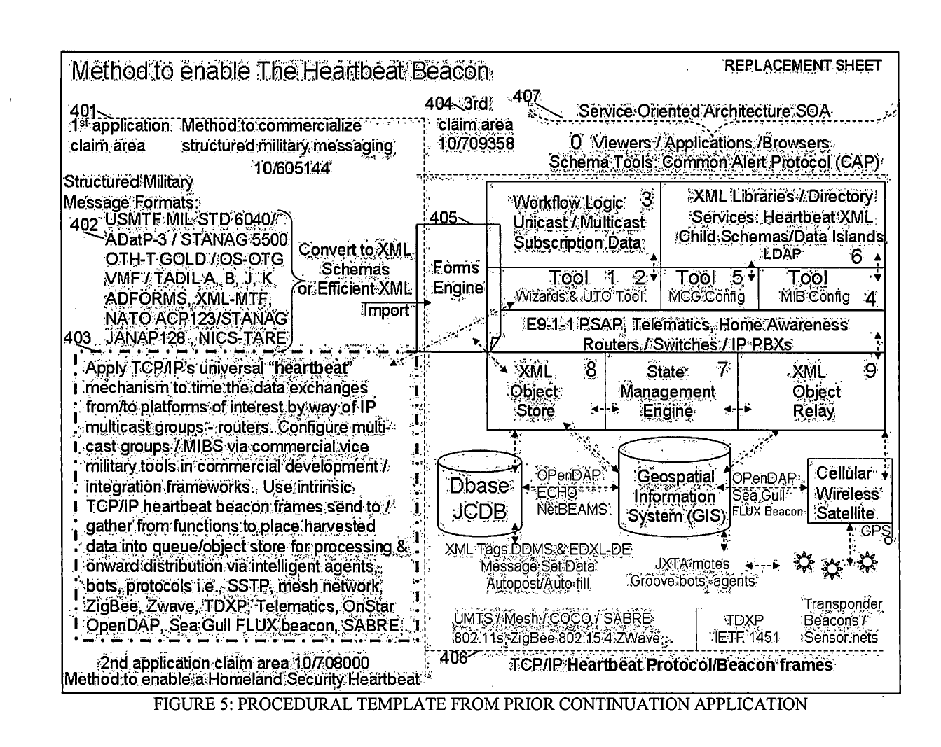

FIG. 5: Procedural Template from prior continuation application. FIG. 5 is a graphic brought forward from previous continuation applications showing that the applicant used the concept of a continuation on which to build on a common theme variation where the sum of the parts comprise the whole in a Russian nesting doll concept described in embodiment one. Ser. No. 10/605,144 Method to Commercialize Structured Military Messaging is upper left 402, Method to Enable a Homeland Security Heartbeat Ser. No. 10/708,000 is lower left, and Ser. No. 10/709,358 Method to enable Heartbeat e9-1-1 are shown integrating and complimenting each other. This application unifies all continuation applications based on common building blocks/procedures used previously. Number 401 refers to the utility of converting proprietary message types be they military heartbeat messages or stock market heartbeat messages into standard or at least common XML artifacts to facilitate apples to apples and oranges data exchanges across n systems and networks. Number 402 points to a representative sample of military structured military messages that as part of the Heart Beacon Cycle process would be converted to universal web standard XML artifacts conforming to XML parsing/processing as a pre-requisite to structured arbitrage. Heartbeat messages in the various world stock exchanges are also non-standard at the time of this writing. Number 403 cites the ubiquity of the TCP/IP heartbeat as the timing, synchronization standard computational opportunity in time upon which all other processes and procedures make calls to when moving and time stamping (state meta) data. The Heart Beacon Cycle concept is to call attention to this not universally understood fact to foster interoperability, common operational procedures among federated groups. Number 404 points to application Ser. No. 10/709,358 Method to enable Heartbeat e9-1-1 filed Apr. 29, 2004 that described the use of common building blocks and procedures in context with a first responder, e9-1-1 domain. Number 405 points to a forms engine that will parse/process common XML artifacts in the template system which was a main tenant of application Ser. No. 10/605,144 Method to Commercialize Structured Military messaging which involved common building blocks comparing one template system from a military environment with a counterpart commercial product showing the commonality of modules as building blocks advocating the re-use of military time tested procedures in a commercial domain to promote interoperability and operational continuity—which has been and still is the focus of the applicants application (s). Number 406 points upwards to a plurality or many protocol options that may be used by disparate groups to update changes in state meta data harvested in micro-cycles to be used to support leader's decision in macro-cycles. The type of protocol is arbitrary—as long as state meta data is harvested, time tagged and identified by Organizational Identifier and Uniform Resource Name URN prior to data center insertion—the applicant's tenant stated, restated in prior continuation applications. Number 407 points to the term Service Oriented Architecture that is a class of enterprise system bus type of product that was the buzz term prior to cloud computing cited by this more current application. In other words, this application is simply keeping pace with changes in jargon. The underlying invention convention of using procedural templates comprised of common building blocks remains the same and is even applicable in non-networked embodiments—the purpose of the main embodiment. The purpose of figure five is to show the consistency of concept over time by application by the applicant and the integrated, supportive nature of the applications.

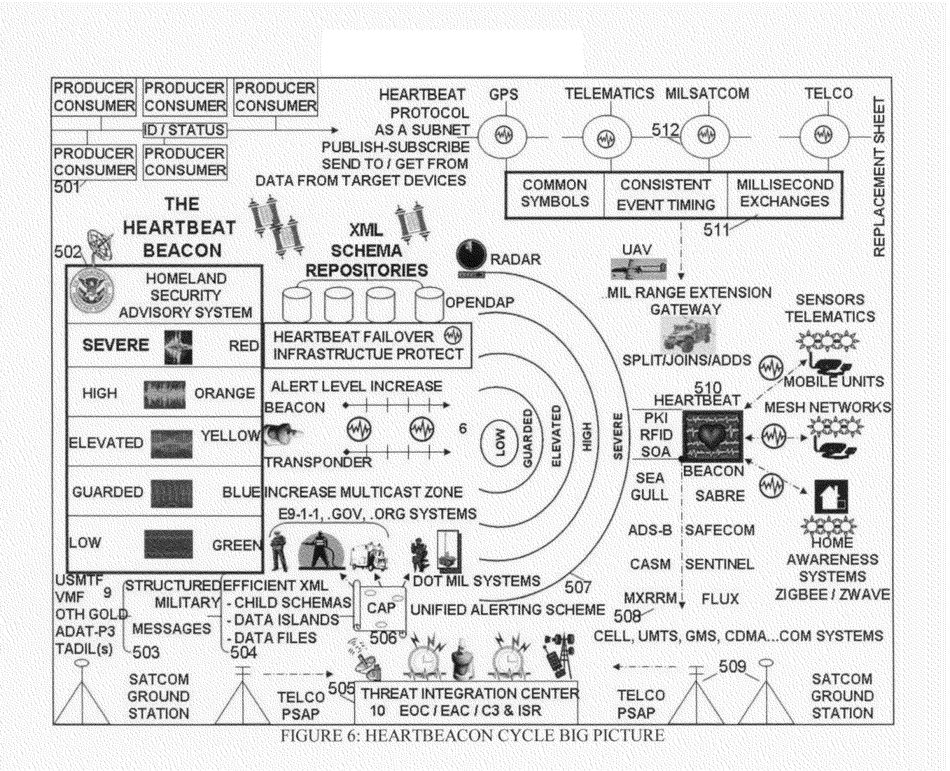

FIG. 6: Heart Beacon Cycle Big Picture. This figure was used in previous applications to show a sample environment for a sample, generic embodiment to describe the invention's functions. Number 501 points to a publish-subscribe process where changes to state meta data is collected then offered by subscribed systems participating in synchronized operations. The type of publish-subscribe mechanism or process is arbitrary. This application cites University of Southern California's Sea Gull protocol 508 described in detail in this application and prior application's related art section as one possible example out of many. Number 502 points to the Department of Homeland Security's previous Homeland Security Advisory system when it was five levels (now three levels: null, elevated, imminent) as an example of alert levels that would serve as a model to map data processing by precedence levels—in concert with most other national and world systems that generally conform to a five level scheme. The numbers of levels of the precedence scheme/model are arbitrary as long as they are consistent in the Heart Beacon Cycle procedural template. Number 503 describes the requirement to convert and import the many types of structured military message types into XML web standard equivalent structures (504) such as the international OASIS Common Alert Protocol CAP in the interest of interoperability and commonality between military (NATO) and commercial and non-governmental organizations NGOs. Number 505 indicates various types of operations centers that would benefit from standardizing structured data/messaging/XML artifact types as well as adhering to commonly agreed upon data refresh intervals in context with Heart Beacon Cycle macro/micro cycles by whatever naming convention outside this application—in other words, adopt common geo-spatial, temporal and data consistency conventions. Number 506 points to the OASIS Common Alert Protocol as the invention's alert XML artifact of choice. Number 507 shows graphically the utility of correlating event and alert level increases and decreases visually in appliqué overlays i.e., decision support computer screens. Number 508 points to water drop in pond type beacon broadcast, newscast options which all rely on the underlying heartbeat micro-cycle TCP/IP heartbeat for data gathering and distribution cited from the original applications until this application. Number 509 points to several infrastructure types with the intent of completely representing an environment that would benefit from Heart Beacon Cycle standard procedures and adhering to the use of common building blocks. As an example, the cellular Universal Mobile Telecommunications Standard UMTS relies on the TCP/IP heartbeat and heartbeat messages to “track user's activities” as does military situational awareness systems and stock market systems—with the proviso that standardizing of TCP/IP heartbeat cycles and heartbeat messages has yet to occur within and among stock exchanges, militaries and first responder systems—the reason for prior applications and this application namely, commonality. Number 510 refers to a graphic representation of the TCP/IP heartbeat as the central and common building block on which all other internetworking based on TCP/IP relies. Number 511 points to a prior patent application's building blocks as common symbols, consistent event timing, and millisecond exchanges. While this diagram cited these entries as main application common building blocks, this application relegates these building blocks to supporting pre-requisites rather than main building blocks as described in detail by FIG. 3. Stated a different way, synchronizing satellite constellations would be helpful in synchronizing data exchanges among many systems participating in a systems of systems and a network of networks but is not directly claimed by this application nor was claimed by prior applications. Rather, this application and prior applications focused on state meta data updates supporting operational decision making in (federated) groups with emphasis on time tagging prior to data center insert. Number 512 points to a representation of a military satellite communication symbol to help focus on the point that satellite and other system and network temporal synchronization is a necessary pre-requisite in timing state meta data refresh activities yet is not the primary focus of the idea.

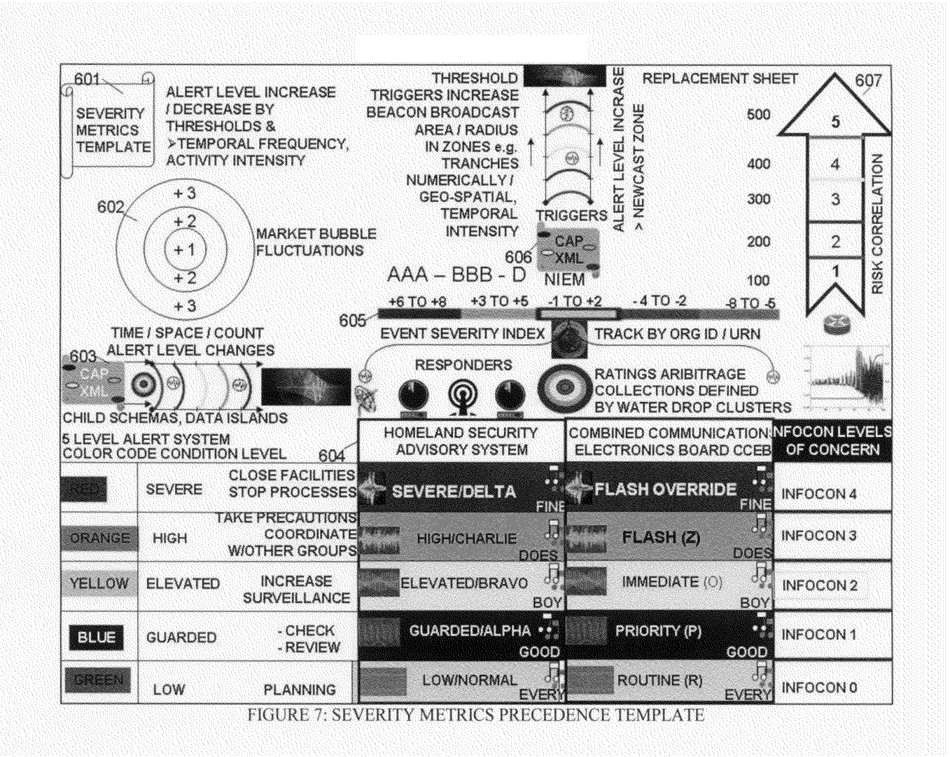

FIG. 7: Severity Metrics Precedence Template: is a graphic reused from prior continuation applications showing the concept of precedence in context with the innovative use of Paul Revere and Water Drop in Pond memes to represent threshold changes. Number 602 indicates a graphic representation of the water drop in pond protocol meme in this case labeled to show market bubble fluctuations for example, by stock market trade tranche classes. As numerical values increase or decrease from a given value in this case 1 as in plus 1 from null, risk of a bubble's collapse would increase as shown by rings indicating indentures and tranches as different “classes” of notes, each identified by letter (e.g. the Class A, Class B, Class C securities) with different bond credit ratings (ratings) in this case correlated with numerical values where <class A>=1, <class B>=2, <class C=3) making changes in risk structure as reported by threshold of outstanding loans defaulted are reported and aggregated across monitored systems in heartbeat sync delta messages. Tag conventions correlating to numerical values render the process machine readable and actionable in Service Level Agreements SLA's as conventions for performance and, or operational metrics. Number 603 refers to the Common Alert Protocol which is an example standard of an alert, reporting protocol in widespread, global use that uses an XML <tag> repository cross correlated to numeric precedence categories which is the over arching purpose of FIG. 7. Since a financial crisis may constitute a threat to homeland security, it is recommended that Department of Homeland Security's adopt a consistent mapping of levels between itself and adjacent agencies for example, a five level system or a three level system but not the current situation where military command and control systems are five levels and the United States Department of Homeland Security's adjusted system is a three level system (null, elevated, imminent). Five (levels) divided by three levels results in 1.666 which results in a machine based system parsing condition of inequity which procedurally causes messages to be shunted to an error or holding queue awaiting human intervention thus negating the advantages of machine to machine automatic processing/parsing to yield near real time transactions of state changes as state meta data which has been the focus of this invention since the original applicant's application Ser. No. 10/605,144 method to commercialize structured military messaging dated Sep. 11, 2003. Use of consistent tag schemes would enable systems to delineate between for example, <exercise> units and actual units from being confused on appliqué overlays especially if unit organizational identifiers are time stamped prior to the seventy two Department of Homeland Security data fusion centers which will enable screening and filtering of duplicative reports when attempting to arrive and the Single Integrated Operational Picture SIOP from a Family of Interoperable Common Pictures which was a claim from previous continuation applications. Number 604 points to the United States previous five level precedence scheme in context with offering either vibratory queues for the deaf or audible tone level adjustments for the blind using increasing and decreasing musical step tones. Vibrations are enabled using cell phone and smart phones vibration settings which would need to be adjustable based on the number of steps. Number 605 points to an example, arbitrary event severity index where values are user defined by consensus in Service Level Agreements which would vary from use case to use case by organization and type of resource being tracked as part of detailed treatises beyond the scope of this invention other than a procedural template is regarded as a listing pointing to detailed treatises. Number 606 points to an example National Information Exchange Model MEM as sponsored by the Department of Justice and Department of Homeland Security acting as a template repository of tags describing a procedural templates trigger events and alert conditions then displayed in appliqué overlays after beacon broadcast by area/radius in zones depicting for example, trading tranches in a collapsing economic key indicator e.g., commodities for example shown geo-spatially by temporal intensity fluctuations, Number 607 depicts a sample risk correlation indicator correlating numerical values (100, 200, 300, 400, 500) reduced to single integers (1, 2, 3, 4, 5) which for example could correlate to stock market point fluctuations in a call out type mode. As groups participating in federated group arbitrage agreements set thresholds relative to current market conditions, they may subscribe to change newscast broadcasts if heartbeat sync delta messages are indicating threshold breaches in given markets or zones described by organization identified ORG ID categories and/or Uniform Resource Name types URN delineated by time stamped data time stamped prior to data fusion center insertion thus enabling a more statistically, stochastically harmonized reporting method.

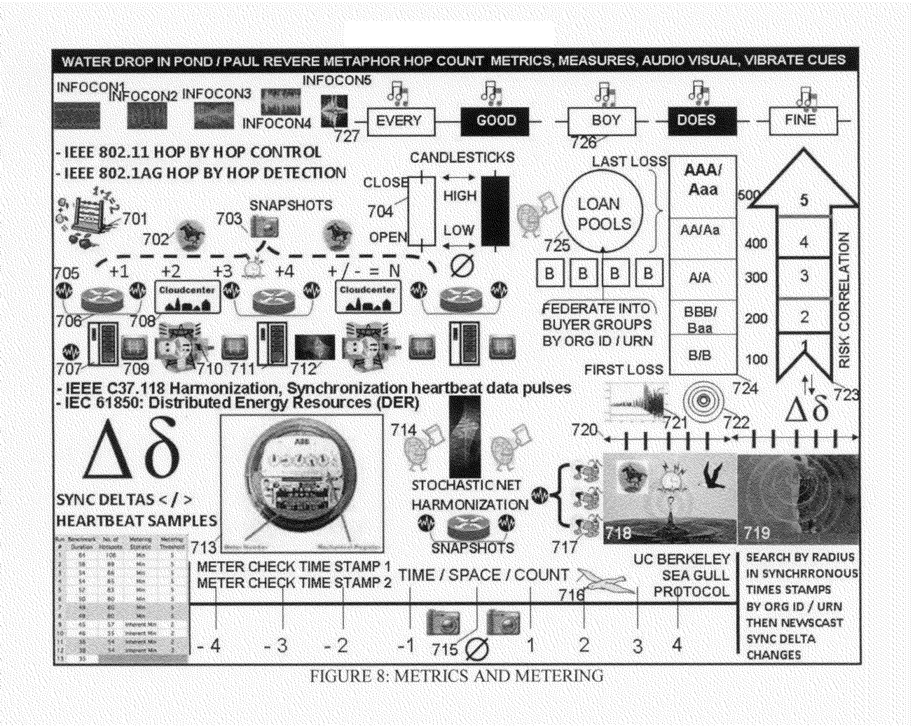

FIG. 8: Metrics and Metering. FIG. 8 shows a tools and concepts that meter and help form and describe metering and metrics using hop count techniques that are current standards in industry i.e., IEEE 801.1, IEEE C37.118 combined with the invention's innovative use of Paul Revere 702 and Water Drop in Pond 722 beacon broadcast, newscast memes depicting changes in Severity Metrics Templates as described in previous drawing figure seven (601) cited in prior method patent applications. Number 701 points to an abacus graphic intended to convey a concept of counting and summing increments/units of power, commodities, transportation, health, and information technology metrics such as hop counts from cloud computing center (708) where vendor A may have surplus units of commodity type X while vendor B might have surplus units of power units. The vendors agree to enter a trade arbitrage agreement trading “apples to oranges” using terms arrived at by mutual consensus. Since vendor A and B supply of commodity types vary by time e.g., seasonal for oranges, quantities of vendor's A and vendor B are monitored until conditions become favorable to engage in adhoc, agile trade arbitrage. Vendors with like commodities may find it advantageous to track exchange of units by thresholds where units tracked in micro-cycles are tallied at the end of a macro-cycle (i.e., monthly or yearly) and restitution is made for trade imbalances if imbalances have accrued. Number 702 represents a Paul Revere hop from grid node to node or supply point to supply point depending on the specific use case and type of commodity, technology being transacted. Number 703 represents state meta-data heartbeat snapshots—taken prior to data fusion center insertion. 704 points to stock market candlestick chart symbols that indicated stock exchange highs/lows, open and closes—the four main stock market indicators. Number 705 indicates a heart beat message upon which stock markets, emergency response, military situational understanding systems all rely. Number 706 points to a router symbol in this context indicating that hops from for example cloud center to cloud center and the time/space in between cloud centers may be used as a method and means to meter services from interexchange providers as hops traversed using a given vendor's infrastructure preferably metered by changes in thresholds rather than individual hops. Moves in financial terms are metered in terms of PIPS percentage in point. A percentage in point PIP represents the smallest value of measurement for currencies in the FOREX market. The smallest move that a PIP can have is 0.0001, which represents 1/100th or commonly referred to as 1 basis point. Stock markets rely on both the TCP/IP heartbeat and heartbeat messages representing an opportunity to establish common metrics and metering as well as a universal method and means to place stop, start, pause, resume instructions to master controllers that control for example, flash trade algorithms controlled by cloud computing center master controllers (708) organizational identified and resource type (i.e., mortgage backed securities, currency transactions for example). Number 709 indicates and energy unit tracked by organizational ID and Uniform Resource Name type (energy unit) moving between energy nodes belonging to organizationally identified smart grid nodes 710. 711 represents a server icon set to represent a master controller for a smart grid/cloud computing instantiation. Master controllers start, stop, pause, resume processes related to for example, machine readable Service Level Agreement monitoring processes by sending and receiving control messages 712. Number 713 points to a graphic representing a meter with a graphical representation of a summation of a metered process. Number 714 is a newscast type beacon used to announce changes in threshold resulting in potential arbitrage opportunities sent to subscribers of organizationally identified groups or changes in market position that may result in investment losses or gains. Number 715 is a tool that is used to measure changes from a null or group consensus arrived at starting condition used as a method and means to base synchronization delta metrics and measures. Number 716 represents a water drop in pond type of beacon protocol in this case the Sea Gull protocol described in this application's related arts section. Number 717 points to a firefly clipart that represents firefly inspired stochastic network harmonization technique described in the related arts section of this application. In brief, once a group of fireflies geo-spatially located n a given area described by geo-spatial temporal techniques discussed in the related arts and main embodiment summary reach a certain level of synchronization, that level is matched to a closest heartbeat micro-cycle to arrive at a consensus time synchronization pulse then propagated by a newscast type of protocol across a network of networks and systems of systems to help harmonize and statistically synchronize stochastic networks. Clustering techniques described in the main embodiment summary are used to group prospective firefly groups and heartbeat timed user groups who wish to participate in network harmonization and synchronization to better work towards goals identified in time-space meaningful geo-spatially and temporally to groups engaged in common goals in times so that groups, group members may pursue common goals. Number 718 is a graphic indicating natural disasters i.e, tsunami's, earthquakes 719 shown given natural disasters typically disrupt or increase the need for speed in responding to certain types of arbitrage opportunities for example, harvest commodity crops where alerts of the disaster contained within heartbeat sync delta messages will be propagated to impacted groups. Graphic eight uses time centric arbitrage techniques such as abacus 702) also called a counting frame as a calculating tool used for performing arithmetic processes described in this application's main embodiment (FIG. 1). Arithmetic processes performed as described in this application's main embodiment when described and correlated within geo-spatial temporal constructs 716-722 will represent a consistent and replicable method and means to correlate with the conventions of stock exchange candlestick charts 704, 726, a style of bar-chart used primarily to describe price movements of for example, a security, derivative, or currency over time. Candlestick chart symbol 704, 726 is used in combination of a line-chart 704 and a bar-chart 726, in that each bar represents the range of price movement over a given time interval. It is most often used in technical analysis of equity and currency price patterns shown in graphics 723, 724. An innovation of this application is collecting reports from many heretofore unconnected systems monitoring securities or currency fluctuations using an innovative combination of firefly inspired statistical stochastic harmonization techniques with heartbeat sampling during macro/micro cycles to arrive at a best effort statistical mean on which to synchronize and temporally filter reports being drawn from many systems that have agreed to adopt a common temporal synchronization pulse, common heartbeat message conventions and have their data time stamped and identified by organizational identifier as commonly agreed upon uniform resource types (commodities) prior to data fusion center 711, cloud center 708 insertion. This is currently not possible given that standardization of heartbeat messages 709 and time stamping of state meta data 705 from more than one, many (a plurality of) stock market, military, first response etc. given systems 710 has yet to be agreed to by any known means or standards committee—for example, the National Institute of Standards and Technology Cloud Computing forum in which the applicant contributes. Only by agreeing by consensus on common building blocks, procedures, and protocols for example IEEE's 802.1AG Hop by Hop Detection 701, IEEE 802.11 Hop by Hop Control, and IEEE C37.113 Harmonization, Synchronization heartbeat data pulses, and IEC 61850 for Distributed Energy Resources DER as standards or at the least common conventions among federated groups. Number 723 is brought forward from FIG. 6 number 607 and is a sample method to correlate point movements in for example stock exchange markets with corresponding numeric integer increases in this example by increments of 100 i.e., 0-100-200-300-400-500 in a five level system corresponding to most command and control situational understanding systems although the number of levels is arbitrary as long as they are consistent from system to system and network to network. Number 724 is a sample financial market tranche construct that also has five levels which will enable processing by event/alert sync delta change crenellated to message precedent systems as previously described in FIG. 6 and FIG. 7. Number 725 points to a circle indicating a clustered group of organizations participating in for example, a pool of mortgages in a mortgage backed security where fluctuations in risk will be set as triggers distributed as heartbeat message sync delta alerts 709 to federated ID groups participating in synchronized group arbitrage 701 Number 726 points to candle stick rectangular symbols denoted with musical tones to indicate a method and means and convention to send audible alerts to subscribers who may be sight impaired or driving a vehicle and wish not to be visually distracted. Number 727 points to symbols indicating increases/decreasing intensity levels for example, that would notify federated ID group arbitrage subscribers using a smart phone's set to vibrate feature that would increase or decrease with changes in sync delta reported threshold changes for the blind or users who wish to not be distracted by audible tones that may disrupt a meeting. Use of the Paul Revere and Water Drop in Pond memes will be useful in depicting risk graphically on appliqué overlay displays FIG. 3, 209 in risk arbitrage operations characterized by sudden shift in rates impacting expanding, increasing market bubbles 722 in terms of potential tranche zone impact on individual investors who have joined a federated group 725. Risk correlation will be improved by using Heart Beacon Cycle conventions of time tagging data by ORG ID/URN (FIG. 3, 202) prior to data fusion center insertion in micro/macro cycles corresponding to standard lots described by stock market PIPS Performance Index Paper—PIP′: a short-term paper on which the rate is denominated and paid in a base currency where the rate movement is based on the exchange rate with an alternate currency.

Needs or problems that the applicant is addressing by sharing heartbeat sync delta messages synchronized and harmonized using a unique combination of firefly inspired heartbeat protocol synchronization and heartbeat micro/macro cycle state meta data sampling is systemic risk prediction and mitigation improved by adding <filters>, <precedence> <priority> <Uniform Resource Type> e.g., for commodities and fungibles in XML tag processes which then may be used to recalculate metrics, meters by decision dashboard processes shown on appliqué overlays. In finance, systemic risk is the risk of collapse of an entire financial system. It can be defined as “financial system instability, potentially catastrophic, caused or exacerbated by idiosyncratic events or conditions in financial intermediaries”. It refers to the risks imposed by inter-linkages and interdependencies in a system or market, where the failure of a single entity or cluster of entities can cause a cascading failure, which could potentially bankrupt or bring down the entire system or market. Systemic risk has been compared to a bank run which has a cascading effect on other banks which are owed money by the first bank in trouble, causing a cascading failure. As depositors sense the ripple effects of default, and liquidity concerns cascade, a panic can spread with a sudden flight to quality, creating many sellers but few buyers for illiquid assets.

Flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks and/or flowchart illustration, can be implemented by special purpose systems that perform the specified functions or acts, or combinations of special purpose computer instructions. Source U.S. Pat. No. 8,442,891

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. U.S. Pat. No. 8,442,891 The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The main embodiment baseball meme was described to best explain the principles of the invention and practical applications to enable others of ordinary skill in the art to understand the invention for various embodiments with various modifications as are suited to the particular use cases contemplated. U.S. Pat. No. 8,442,891

### Embodiments

The main embodiment: described in FIGS. 1, 2 is a non-networked little league baseball game used as a meme to describe processes, procedures that comprise a procedural template in situations where manual non-networked procedures may be reverted to if TCP/IP networks are not available. The main embodiment describes in a baseball game meme the signaling of state meta-data changes where data is time tagged and identified by organization <ORG_ID> and resource type <URN> prior to data fusion center insertion. A baseball game meme is used to describe actor interactions, change dynamics intrinsic to network centric operations, mission aware networking change management operations. Operations are translated into baseball game instructions described in widely recognized baseball game terms. Players wear non-networked pedometers worn by actors referenced to note time and motion metrics i.e., time stamps 112, 113 for state meta-data, distance/hops traveled e.g. base runs in a given amount of time describing a given amount of space traversed. The main embodiment represents map, directory, network, systems of systems, network of networks reporting process iteration and interaction of essential, common building block components i.e., Paul Revere, Water Drop in Pond metric, meter memes describe metric measurement recalculation methods. Off site connectors drawn from workflow symbol libraries are used to describe processes e.g., recalculation, summation, aggregation between micro-cycle processes run within and signaled to macro-cycles which are then displayed to decision support appliqué overlay views such as Buckminster Fuller Dymaxion maps.

Embodiment 1 is represented by building block one B1 FIG. 1 block 201. Embodiment one adds as improvements use of the internet protocol TCP/IP and TCP/IP's “heartbeat” that is an opportunity in time to do/not do computational tasks such as time stamping of state meta-data get—puts, start, stop, pause, resume, set Time To Live TTL signaling described within heartbeat sync delta messages scheduled within micro reporting cycles given TCP/IP heartbeats are the only universal get/put for data that all computational procedures, processes such as scripts, bots, motes, agents, and algorithms rely. Heartbeats are used to synchronously gather state meta data within micro cycles (FIG. 3, 216) identified by organizational identifier and uniform resource name FIG. 3, 201 prior to data fusion center insertion FIG. 1, 119 where data fusion centers aggregate, recalculate, sum then relay, signal heartbeat sync delta messages FIG. 3, 213 over wide areas to affect internet, micro-grid, cloud computing environments systemically FIG. 6

Embodiment two adds as improvements, a procedural template comprised of processes, procedures, and building blocks as guides to treatises describing processes wherein individuals, single entities e.g., sensors are combined into grouped structures then described as (federated) groups to participate in activities, events i.e., join, merge, adds, drops, moves based on group leader's intent, plans, course of actions, decisions, changing situations, missions etc. which are then translated into network terms such as TCP/IP sub-network Domain Name System Service. Mission Aware Network, Network Centric Operations are described as a little league baseball game meme for wide recognition among anyone who may understand baseball's conventions.

Embodiment 2, as a technical extension to embodiment 1 adds as improvements a list of minimum required class types of XML markup <tags> used in forming template XML artifacts 405 i.e., state meta data/heartbeat snapshots/sync delta messages/heartbeat messages 312 using data time tagged 512 and identified 511 prior to data fusion center 119 insertion to update Network Service Interface NSI artifacts 311 implementing and committing network changes i.e., joins, splits, drops, moves 202. As a minimum, items (1) through 9) below are <tag> set requirements recognizing that groups may include custom tags of their own design:

1) IODEF—RID, StratML, NIEM, Big Data Markup Language BDML markup tags as meta-data tags used as class types <private>, <domain>, <shared>, <community>, <joint>, <global>
2) ORG ID, URN descriptions of <event>, <activity>, <resource>, <location>
3) Unit/Organizational Task Organization UTO: UTR (U=Unit, T=Task, R=reorganization) command, Effective Date/Time/Group (DTG) Block, command relationship (OPCON, attach), affiliations, Universal Resource Number URN (unique numeric identification number) entity values/attributes: current/active data; IP lease, location, Synchronization Delta Time Block
4) Precedent class tags where tags equate to numeric machine readable, executable priority processing i.e. null, 1, 2=<null>, <elevated>, <imminent> XML tag markup. Precedence <tags> correlated with resource <tags> will enable resources processed by priority by monitoring signaling tags i.e., SALUTE-R (Size, Activity, Location, Unit, Time, Equipment XML text <tags> where precedence types are correlated with machine to machine numeric processing.
5) XML markup <tags> describing entity, platform, vehicle, user, entity status collected during heartbeat intervals to fill sync delta message artifacts meta-data state management elements in template forms corresponding to who, what, where, when, how often, out of network range, turned off, inoperative for maintenance or duress condition indicating operational conditions (e.g., stale, straggler, duress, medical triage, SOS.) of geo-spatial/temporal location i.e., GPS/gyroscopic RFD chipped devices sensors, smart phones, Internet of Things IoT etc.
6) XML network markup tags in network service interface NSI templates for messaging, signaling of data element encoding templates corresponding with OASIS international standard Common Alert Protocol CAP schemas with NIEM payloads and/or data islands 504 in XML forms 506 processed by universal parsers in forms engine 405 parsers, state management engines 406 block number 7 to process XML artifacts without XML artifact gateways 506
7) Network Service Interface NSI XML template artifacts compliant with for example, OASIS Common Alert Protocol 603 National Information Exchange Model MEM schema/child schemas, used as a single, unified payload, logic trigger for unified event/alerts from a single authoritative source 606 in data signaling cascades across, over domains in a wide area 507
8) Use of sync delta heartbeat snapshots to form Network Service Interface NSI templates 214 populated by state meta data gathered during heartbeat get/put micro-cycle intervals 510 where data is tagged with XML <tags> 405 parsed, processed to signal 408 block 9 network 707, 709 dynamic ad hoc group joins, splits, adds, changes 211 enabling execution management of leader's intent 216 instructions, orders 213 event, activity, location, and activity described by <classes> by <precedence> supporting infrastructure router/switch/server sub-net changes 212 correlating to Federated ID groups organization changes signaled over a wide area FIG. 6
9) Network Service Interface change instructions are cross referenced to machine message precedence FIG. 7 emulating in networking terms leader's guidance/intent/plans/orders 215 adjusting to changing business and market conditions in federated ID virtual enterprises activity such as merger and acquisition alternatives, resource scheduling and pooling strategies. Embodiment two correlates with Building Block number 2 represented by number 202—B2

Embodiment three depicted by FIG. 3, building block B3 number 203—FIG. 4, 301, 302, 303, adds as improvements use of a Paul Revere metric, metering meme 607 as a method to improve counting, metering, measurement, signaling of linear sequential temporal hop counts as changes in state from null, from an established baseline. Sync delta meta-data gathered during micro-cycles 214 is recalculated then aggregated into reports 213 signaled to administrators/statisticians who use state change reports 214, leader's guidance 215 to make organizational changes responsive to operational activities translated into network sub-net changes in an iterative, micro-cycle to macro cycle process used across a wide area effects systemic change.

Embodiment three: hop count 126 based metrics and metering follow international standards:

(1) IEEE 1588 Precision Timing Protocol PTP heartbeat function precision timing
(2) IEEE 802.11 AG hop by hop detection and control for epoch assignment, hop by hop detection function used to determine hop by hop counts corresponding to machine readable and executable null/0 and steps from null representing hop counts e.g., +1, +2, +3, +4, −1, −2, −3, −4 Paul Revere linear, sequential meme indicating distance traveled i.e., Internet of Things IET
(3) IEEE 802.11 HbH hop by hop control supporting Paul Revere, rain drop in pond meme metrics of increases/decreases in thresholds and by intensity, duration and hop count sums
(4) IEEE C37.118 Harmonization and Synchronization for heartbeat data pulses and watchdog heartbeat functions in electrical power grid applications to base micro-grid arbitrage
(5) IEC 61850: IEC 61850 electric utility substation devices used in Distributed Energy Resources (DER). IEC 61850 includes XML-based Substation Configuration Language (SCL),
(6) Use of signaling intrinsic to heartbeat/heartbeat message methods in combination with firefly insect inspired stochastic synchronization algorithms where firefly protocol sample results are matched with closest heartbeat sync delta time stamp to arrive at statistical means

Embodiment four describes using a water drop in pond meme 124, 130 as a method to describe area, intensity, duration, threshold in beacon types as a method and means to improve derivation of metrics, metering. Results of this method of metering and metric recalculations displayed on appliqué type overlays using methods, techniques of increasing, decreasing alert, event level emulation 602, 722 by hop-count multicast radius using audible step tones 726 or light, visual intensity i.e., increasing/decreasing radius/threshold/intensity supporting disabled i.e., blind, deaf persons and general users 604 during light degraded conditions where audible step tones emulate device audible buzzers based on intensity and precedence settings. Embodiment 4 adds as improvements to appliqué map geo-spatial temporal overlays 209 in filtered situational understanding and awareness common operational picture display dashboard views 134 based on data time stamped 112, 113 identified with organizational identifiers and Uniform Resource Names 312 prior to data fusion center 119 insertion. Appliqué views (209) display events, alerts, measures, metrics derived from Heart Beacon Cycle (s) sync delta cyclical reports.

Embodiments 1-4 relate to four building blocks B1, B2, B3, B4 in FIGS. 1, 2 used in combination, synergistically, cooperatively, in concert to improve many use cases to effect network state changes systemically. Embodiments 1 through 4 as building blocks B1, B2, B3, B4 follow a method of constructing Russian Matryoshka Dolls shells as a meme to add, remove functions as users decide to revert back to a last known operational, working function points

Effectiveness of the invention. The Heart Beacon Cycle time-space meter/appliqué overlay is a best effort, best practice, improved though use of SCADA, SCADE, and Function Point FP methodologies. If, improvements cause failure or an impaired state, an option to return to the last working or efficient configuration function point will be available as a remedy or option.

Embodiments are germane in future embodiments/claims that this invention may describe

We claim:

1. A systemic, adaptive procedural template method used to improve synchronization in metrics, metering, using <ORG_ID>, <URN> XML data tags in signaling during heartbeat micro-cycles prior to data fusion center entry consisting of iterative, heartbeat cycle metrics, meters reporting where state meta data heartbeat snapshot recalculations are performed at off site connectors that are signaling relays, conversion, recalculation points processing during macro-cycle epochs dissimilar standards, formats, that are then reported, news-casted to appliqué overlays.

2. A systemic adaptive procedural template method used to improve signaling, synchronization using TCP/IP heartbeat time stamping occurring during micro-cycles of state meta data prior to data fusion center entry among metrics, metering processes comprised of TCP/IP heartbeats, heartbeat messages signaled during micro-cycles scheduling instructions, commands, processes, procedures, algorithms, telemetry instructions for example, to master-controller processes i.e., block, start, stop, pause, resume, set Time To live TTL i.e., stock market high frequency flash trade, currency, interest rates, tax rates, time banking, cloud computing commodity exchanges, big data, electrical micro-grid, fungible goods, real time bidding, many use cases.

3. A systemic adaptive procedural template method improving stochastic networks harmonization through use of timing, synchronization intrinsic to TCP/IP heartbeat/heartbeat message signaling using set, scheduled, epochs in micro-cycles in combination with firefly insect signaling stochastic harmonization algorithms where firefly protocol sample means are matched with closest heartbeat sync delta micro-cycle report values to recalculate statistical averages, means signaled through off site connector conversion, recalculation gateways that news-cast, beacon broadcast to subscribers monitoring macro-cycle reports that heretofore would not exist without following the Heart Beacon Cycle procedural template as guides for reporting thus improving temporal harmonization in metrics and metering of stochastic telecommunication mesh fabrics grid control planes over wide areas in cases involving issues in terms of consistency, reliability, traceability, positive organizational identification, temporal transaction fidelity, event, alert predictability, data analytics, network forensics real rime bidding, stock market exchange floor server co-location verses servers distantly located, fluctuations in interest rates, currency exchanges, double payment adjudication, fungible good trading stochastic harmonization, electrical power micro-grids, cloud computing, “big data” in many use cases.

4. A systemic adaptive procedural template method using time stamping and signaling intrinsic to TCP/IP heartbeat, heartbeat sync delta snapshot message signaling to improve dynamic, adaptive organization change management using XML <ORG_ID> network service interface NSI templates updating self organizing process templates i.e., directory service, reporting, map, network, system of systems effecting changes in directory structures database MIB i.e., network subnet joins, moves, splits drops, adds as alternatives to mergers, acquisitions effecting changes responsive to leader's actions, decisions i.e., mission-aware networking, network centric operations improving agile, ad hoc organizational business operations course of actions selection by organizations registered for more than one <ORG_ID) improving action/reaction to change.

5. A systemic adaptive procedural template method improving search engine methods using heartbeat, beacon signaling, <ORG_ID>, <URN>, class_types>, Paul Revere, water drop in pond meme metric recalculations occurring at off site connectors, conversion relay gateways where detection of trigger point function recalculations of state meta data set aggregations are used to detect threshold fluctuations by resource <class>, <type>, quantity, availability duration etc., further used to improve geo-spatial temporal descriptive mapping methods, changes in clusters of objects, entities, artifacts i.e., location, epoch time stamp geo-spatially, temporally, used to locate, search, then group into virtual collections using <data_tags> i.e., <rare> in spatial econometric, volumetric operations within network mesh fabrics triggering news-casting invitations to join equitably metered federated group arbitrage events, activities that are triggered by internet search operations improving collaboration, metrics and metering in for example, commodity, fungibles trading, resource pooling, crowd sourcing, contributory economics.

6. A systemic adaptive procedural template method used to improve handicapped/information alerts, events, methods reliant on heartbeat timing, signaling synchronization of state meta-data improved using Paul Revere, water drop in pond memes to create, calculate radius, intensity metrics viewed as geo-spatial, temporal intensity effects i.e., visual light bar tabs i.e., stock exchange candlestick charts, audible tone, vibration-tactile situational awareness alerts by correlating tone based messaging precedence XML <tag> where lower/higher precedence settings equate to lower/higher audible tones, tactile vibrations for deaf where fewer/greater number of light tabs lit correlates, corresponds to priority, precedence <tags> further used in alert triggers of threshold fluctuations displayed in appliqué overlay graphics as metrics, meters.

7. A systemic, adaptive procedural template method using heartbeat signaling, time stamp record keeping processes of state meta data by organizations, describing resources by Uniform Resource Name, further improved through use of Paul Revere, Water Drop in Pond memes to quantify, describe unused resources with unmet needs by performing recalculations of state meta-data snapshot artifacts occurring at off site connector conversion gateways where micro-cycle reports from local, micro-cycle activities are signaled, relayed to higher echelon organization interested in for example stock market “pools” where “output” is correlated and displayed onto appliqué views of aggregate sync delta changes in macro-micro economics recalculations of for example, stocks, commodities, currencies, interest rates, electric micro-grids, currency (Terra) exchanges, spatial econometrics, contributory economics.
